(19) United States
(12) Patent Application Publication
(10) Pub. No.: US 2026/0161675 A1
(43) Pub. Date: Jun. 11, 2026

(54) Generating an Output Document via an Interactive Machine-Learned Model

(71) Applicant: Google LLC, Mountain View, CA (US)

(72) Inventor: Raiza Martin, Fremont, CA (US)

(21) Appl. No.: 19/178,698

(22) Filed: Apr. 14, 2025

Related U.S. Application Data
(60) Provisional application No. 63/634,243, filed on Apr. 15, 2024.

(51) Int. Cl. G06F 16/332; G06F 16/3329

(52) U.S. Cl. CPC G06F 16/3326; G06F 16/33295

(57) ABSTRACT

A computing device for generating an output document includes one or more processors to execute instructions to perform operations, including: receiving a first input from a user providing information associated with a request to generate an output document; generating, via one or more machine-learned models, an outline based on the first input, the outline including a plurality of sections; generating, via the one or more machine-learned models, a plurality of questions for generating content for a first section among the plurality of sections, based on the first input; and generating, via the one or more machine-learned models, content for the first section, based on information responsive to a first question among the plurality of questions. The information responsive to the first question is obtained from the user or via the one or more machine-learned models according to whether the first question is associated with a first or second context.

### PRIORITY CLAIM

This application claims priority to U.S. Provisional Application No. 63/634,243 filed on Apr. 15, 2024 which is hereby incorporated by reference herein in its entirety for all purposes.

### FIELD

The disclosure relates generally to generating content via one or more machine-learned models based on an interactive exchange between a user and the one or more machine-learned models, based on information provided by a user relating to content that is to be generated. For example, the disclosure relates to methods and computing devices for generating the content via one or more machine-learned models with respect to an initial prompt identified by the user. The disclosure relates to generating content based on an outline having sections whose content is determined according to whether certain content should be provided by a user or by the one or more machine-learned models, thereby assisting the user in efficiently and accurately managing content, organizing content, creating content, etc.

### BACKGROUND

According to current computing systems, large language models (LLMs) are capable of interacting with textual content. For example, a user may copy and paste content from one document into a chat box to query the LLM about the content. The LLM may provide an output (e.g., a summary) regarding the content.

### SUMMARY

Aspects and advantages of embodiments of the disclosure will be set forth in part in the following description, or can be learned from the description, or can be learned through practice of the example embodiments.

In one or more example embodiments, a computing device for generating, organizing, managing, and creating content is provided. For example, the computing device includes: one or more memories configured to store instructions; and one or more processors configured to execute the instructions to perform operations, the operations comprising: receiving a first input from a user providing information associated with a request to generate an output document, generating, via one or more machine-learned models, an outline based on the first input, the outline including a plurality of sections, generating, via the one or more machine-learned models, a plurality of questions for generating content for a first section among the plurality of sections, based on the first input, determining, via the one or more machine-learned models, whether a first question among the plurality of questions is associated with a first context or a second context, when the first question is associated with the first context, automatically retrieving, via the one or more machine-learned models, information responsive to the first question, when the first question is associated with the second context, presenting the first question to the user and obtaining, from the user, the information responsive to the first question, and generating, via the one or more machine-learned models, the content for the first section, based on the information responsive to the first question.

In some implementations, the operations further comprise: receiving a second input from the user indicating a style to be applied by the one or more machine-learned models for generating the output document, and wherein generating, via the one or more machine-learned models, the outline is further based on the second input.

In some implementations, the operations further comprise: receiving a second input from the user indicating a style to be applied by the one or more machine-learned models for generating the output document, and wherein generating, via the one or more machine-learned models, the content for the first section is further based on the second input.

In some implementations, the operations further comprise: providing, for presentation to the user, the outline including the plurality of sections; and receiving a second input from the user indicating to modify one or more of the sections of the outline or to accept the outline.

In some implementations, the one or more machine-learned models generate the plurality of questions for generating the content for the first section among the plurality of sections, in response to the computing device receiving the second input from the user indicating to accept the outline.

In some implementations, generating, via the one or more machine-learned models, the plurality of questions is further based on a title of the first section.

In some implementations, the first context corresponds to a query which can be answered via the one or more machine-learned models based on information contained in one or more source documents, and the second context corresponds to a query relating to at least one of a purpose, scope, or target audience associated with the output document.

In some implementations, the operations further comprise receiving a selection, from the user, of the one or more source documents, for generating the output document.

In some implementations, the operations further comprise: providing, for presentation to the user, a plurality of question and answer pairs which includes the plurality of questions and corresponding answers including information responsive to the plurality of questions; receiving a second input from the user indicating to: remove one or more of the plurality of question and answer pairs, add one or more questions to generate one or more additional question and answer pairs, to add to the plurality of question and answer pairs, or accept the plurality of question and answer pairs; and in response to the second input indicating to accept the plurality of question and answer pairs, generating, via the one or more machine-learned models, the content for the first section, based on the information responsive to the plurality of questions.

In some implementations, the operations further comprise: providing, for presentation to the user, a plurality of question and answer pairs which includes the plurality of questions and corresponding answers including information responsive to the plurality of questions; receiving a second input from the user selecting one or more of the plurality of question and answer pairs; and generating, via the one or more machine-learned models, the content for the first section, is based on information responsive to questions from the one or more of the plurality of question and answer pairs selected via the second input.

In some implementations, the operations further comprise: applying one or more further machine-learned models to edit the first section, wherein the one or more further machine-learned models have a higher processing power than the one or more machine-learned models.

In some implementations, the operations further comprise: generating, via the one or more machine-learned models, a persona, based on the first input; and generating, via the one or more machine-learned models, the content for the first section, by utilizing the persona and based on the information responsive to the first question.

In one or more example embodiments, a computer-implemented method for organizing, managing, and creating content is provided. The computer-implemented method comprises receiving, by a computing system comprising one or more processors, a first input from a user providing information associated with a request to generate an output document; generating, via one or more machine-learned models of the computing system, an outline based on the first input, the outline including a plurality of sections; generating, via the one or more machine-learned models, a plurality of questions for generating content for a first section among the plurality of sections, based on the first input; determining, via the one or more machine-learned models, whether a first question among the plurality of questions is associated with a first context or a second context; when the first question is associated with the first context, automatically retrieving, via the one or more machine-learned models, information responsive to the first question; when the first question is associated with the second context, presenting the first question to the user and obtaining, from the user, the information responsive to the first question; and generating, via the one or more machine-learned models, the content for the first section, based on the information responsive to the first question.

In some implementations, the method further comprises receiving a second input from the user indicating a style to be applied by the one or more machine-learned models for generating the output document, and wherein generating, via the one or more machine-learned models, the outline is further based on the second input.

In some implementations, the method further comprises receiving a second input from the user indicating a style to be applied by the one or more machine-learned models for generating the output document, and wherein generating, via the one or more machine-learned models, the content for the first section is further based on the second input.

In some implementations, the method further comprises providing, for presentation to the user, the outline including the plurality of sections; receiving a second input from the user indicating to modify one or more of the sections of the outline or to accept the outline; and in response to the computing system receiving the second input from the user indicating to accept the outline, generating, via the one or more machine-learned models, the plurality of questions.

In some implementations of the method, the first context corresponds to a query which can be answered via the one or more machine-learned models based on information contained in one or more source documents, and the second context corresponds to a query relating to at least one of a purpose, scope, or target audience associated with the output document.

In some implementations the method further comprises receiving a selection, from the user, of the one or more source documents, for generating the content of the first section.

In some implementations, the method further comprises providing, for presentation to the user, a plurality of question and answer pairs which includes the plurality of questions and corresponding answers including information responsive to the plurality of questions; receiving a second input from the user indicating to: remove one or more of the plurality of question and answer pairs, add one or more questions to generate one or more additional question and answer pairs, to add to the plurality of question and answer pairs, or accept the plurality of question and answer pairs; and in response to the second input indicating to accept the plurality of question and answer pairs, generating, via the one or more machine-learned models, the content for the first section, based on the information responsive to the plurality of questions.

In one or more example embodiments, a computer-readable medium (e.g., a non-transitory computer-readable medium) which stores instructions that are executable by one or more processors of a computing system or computing device is provided. In some implementations the computer-readable medium stores instructions which may include instructions to cause the one or more processors to perform one or more operations, the operations comprising: receiving a first input from a user providing information associated with a request to generate an output document; generating, via one or more machine-learned models, an outline based on the first input, the outline including a plurality of sections; generating, via the one or more machine-learned models, a plurality of questions for generating content for a first section among the plurality of sections, based on the first input; determining, via the one or more machine-learned models, whether a first question among the plurality of questions is associated with a first context or a second context; when the first question is associated with the first context, automatically retrieving, via the one or more machine-learned models, information responsive to the first question; when the first question is associated with the second context, presenting the first question to the user and obtaining, from the user, the information responsive to the first question; and generating, via the one or more machine-learned models, the content for the first section, based on the information responsive to the first question.

The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIGS. 1A-1B depict example systems according to according to one or more example embodiments of the disclosure;

FIG. 2 illustrates a flow diagram of an example, non-limiting computer-implemented method, according to one or more example embodiments of the disclosure;

FIG. 3 depicts an example block diagram of a notebook application, according to one or more example embodiments of the disclosure;

FIGS. 4A-4H illustrate example user interface screens of a notebook application, according to one or more example embodiments of the disclosure;

FIGS. 5A-5B illustrate example user interface screens of a notebook application, according to one or more example embodiments of the disclosure;

FIGS. 6A-6B illustrate further example user interface screens of a notebook application, according to one or more example embodiments of the disclosure;

FIG. 7 illustrates example notebooks or projects which can be represented in a particular manner, according to one or more example embodiments of the disclosure;

FIGS. 8A-8B illustrate flow diagrams of example, non-limiting computer-implemented methods, according to one or more example embodiments of the disclosure;

FIG. 9 depicts an example block diagram of a document extractor application, according to one or more example embodiments of the disclosure;

FIGS. 10A-10E illustrate example actions associated with a document extractor application, according to one or more example embodiments of the disclosure;

FIG. 11 illustrates a flow diagram of example, non-limiting computer-implemented methods, according to one or more example embodiments of the disclosure;

FIG. 12 depicts an example block diagram of a persona generator application, according to one or more example embodiments of the disclosure;

FIGS. 13A-13C illustrate example actions associated with a persona generator application, according to one or more example embodiments of the disclosure;

FIGS. 14A-14B illustrate example actions associated with a persona generator application, according to one or more example embodiments of the disclosure;

FIG. 15 illustrates a flow diagram of example, non-limiting computer-implemented methods, according to one or more example embodiments of the disclosure;

FIG. 16 depicts an example block diagram of an interactive document generator application, according to one or more example embodiments of the disclosure;

FIGS. 17A-17E illustrate example actions associated with an interactive document generator application, according to one or more example embodiments of the disclosure;

FIG. 18A depicts a block diagram of an example computing system for organizing, managing, and creating content by implementing one or more machine-learned models with respect to input information, according to one or more example embodiments of the disclosure;

FIG. 18B depicts a block diagram of an example computing device for organizing, managing, and creating content by implementing one or more machine-learned models with respect to input information, according to one or more example embodiments of the disclosure;

FIG. 18C depicts a block diagram of an example computing device for organizing, managing, and creating content by implementing one or more machine-learned models with respect to input information, according to one or more example embodiments of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

According to current computing systems, large language models (LLMs) are capable of interacting with textual content. However, current computing systems require significant effort to create a specific prompt for a LLM to process. For example, a user may be required to copy and paste content from one document into a chat box to query the LLM about the content. This switching between multiple windows or applications results in significant amounts of wasted computational time and resources (e.g., processor cycles).

According to examples of the disclosure, a computing system (computing platform, computing device) is configured to create a new type of output (e.g., an outline, a report, a summary, etc.) via one or more machine-learned models, based on source content provided to the computing system (e.g., by the user). For example, the computing system may be configured to receive source content selected by a user and generate, via one or more machine-learned models, a summary of the source content including an identification of one or more topics related to the source content.

As an example, a user may identify and select a subset of documents (e.g., four documents) from a plurality of documents (a large corpus of documents) relating to a topic (e.g., modern American history in the 1990s) which are provided to the computing system. The computing system may include one or more machine-learned models configured to receive as an input the selected documents and to provide as an output a summary (or a report, a paper, an outline, etc.) relating to the selected documents and an identification of key topics (e.g., via a document guide).

In some implementations, the computing system is configured to implement a semantic retrieval method (e.g., clustering) and one or more machine-learned models (e.g., one or more LLMs) to generate a summary, key topics, and suggested queries (e.g., questions) to produce a document guide for content identified or indicated by the user (e.g., based on a body of text found in the content).

For example, in some implementations the computing system may be configured to receive source content from the user. For example, the user may upload source content (e.g., documents, imagery, sound files, websites, videos, presentations, PDFs, etc.). In some implementations, the computing system may be configured to, in response to the user uploading source content, automatically generate information including a summary of the source content, generate top themes found in the source content, generate suggested topics and questions to help the user explore the source content further, etc. The information may be presented via a user interface. The user interface may be configured to receive an input from the user (e.g., via a touch-input, mouse-click, etc.) on a user interface element corresponding to a theme, question, etc., In response to receiving the input from the user, the computing system may be configured to respond to the input, for example, by providing an answer via one or more machine-learned models to the question or theme query, based on the source content.

In some implementations, the computing system may be configured to, in response to the user uploading source content, automatically generate information including a report, an outline, or a rewrite of the original content, so as to generate new content based on the source content identified (selected) by the user. For example, the user may request that the computing system identify a specified number of themes from one or more documents, to summarize client interactions occurring over a specified duration of time (e.g., the least two weeks), to generate a specified number of ideas based on a source document, etc.

In some implementations, the source content that is relied upon or referenced by the LLMs may be selected (e.g., curated) by the user. For example, the user may consider or indicate that the selected source content is trustworthy (e.g., trusted source content, authoritative source content, etc.) or has a higher priority compared to other content which does not have such a designation. Therefore, the one or more machine-learned models are configured to generate summaries of content, or generate new content, based on trusted source content, improving the accuracy and reliability of information and data provided to the user. Further, the one or more machine-learned models are configured to answer questions about the source content based on the trusted source content, improving the accuracy and reliability of information and data provided as answers to questions posed by the user.

In some implementations, the computing system can be configured to discover, add, or remove source content. For example, the user may add or remove source content. For example, the user may provide an input requesting the computing system to discover source content (e.g., by conducting a search for scholarly articles regarding a certain topic) and the user may add the discovered source content as part of the selected source content which is deemed trustworthy by the user (and/or the computing system).

In some implementations, the computing system may be configured to receive an additional source content by the user creating a new note, by the user uploading the source content to the computing system, by adding the source content via a website, etc. The computing system may be configured to generate or receive metadata concerning the added source content. For example, the metadata may include one or more of a title, an author, a date of upload, a date associated with the creation of the source content, a uniform resource location (URL) associated with the source content, etc.

In some implementations, the computing system may be configured to delete or remove a source content by the user selecting the source content and providing an input requesting that the source content be deleted (e.g., from the notepad application). In some implementations, the source content may be deleted as a source relied upon for generating summaries, key topics, etc., in the notepad application, but an original copy of the source content may be maintained elsewhere.

In some implementations, the computing system can be configured to receive a user input via a text entry box (e.g., an open-ended text entry box). For example, the user input may be in the form of a question (e.g., “What did Nixon say in his speech about automobile use”). For example, the user input may be in the form of a theme or idea (e.g., “Nixon automobile crisis” or “What is this document about?”).

The computing system may be configured to, via one or more machine-learned models, provide a response to the user input based on the selected source content. In some implementations, the computing system is configured to indicate the number of sources (citations) that were relied upon for providing the response. In some implementations, the computing system is configured to provide for presentation a source (citation) which was relied upon for a particular passage in the response. In some implementations, the computing system is configured to provide additional context regarding the source (citation) which was relied upon for the particular passage in the response. For example, the computing system may indicate the passage (e.g., a sentence or paragraph) from the source for which a portion of the response was based on and may further indicate a preceding and/or subsequent passage from the source to provide further context concerning the particular passage.

In some implementations, the computing system may be configured to store one or more passages (e.g., snippets) from a generated response (answer) to a query (question) input by the user. For example, the one or more passages may be stored in a specified area of a notepad application. The specified area may be referred to as a scratchpad and each item of information stored in the scratchpad may be referred to as a note. The one or more passages may be selected by the user for storing as a first note in the scratchpad. In some implementations, citations can be stored in the scratchpad as a second note. In some implementations, the user can select (e.g., highlight) a particular passage from a citation (source content) for storing in the scratchpad as a third note. In some implementations, the user can store their own passage or comments as a written note (fourth note).

According to examples of the disclosure, the computing system may be configured to provide a notepad application which is configured to generate an output (e.g., an outline, a report, a summary, etc.) via one or more machine-learned models, based on source content provided to the notebook application (e.g., by the user). The notebook application may be configured to allow a user to create various projects to complete various tasks. Each project may be configured to act in a manner similar to a folder by which a user can store various information to each project. In some implementations, an individual scratchpad may correspond to or be dedicated to a particular project. In some implementations, the notebook application may be configured to receive the source content as specified by the user. The notebook application may be configured to add, delete, or modify projects according to an input received from a user. Each project may be provided a default name, a name provided by the user, or a name generated by the notebook application (e.g., via one or more machine-learned models) based on the information stored in the project (e.g., based on the source content).

In some implementations, in response to source content being provided to the notebook application, the notebook application may be configured to automatically generate (e.g., using one or more machine-learned models, one or more generative machine-learned models, etc.), a graphical image (e.g., an emoji, an icon, etc.) or graphical animation which corresponds to or represents the source content. In some implementations, the graphical image or graphical animation may be overlaid on a folder which is provided as a user interface element that, when selected, causes the folder to open and display the contents of the folder to the user. In addition, or alternatively, in some implementations, in response to the source content being provided to the notebook application, the notebook application may be configured to automatically generate (e.g., using one or more machine-learned models, one or more generative machine-learned models, etc.), a textual description (name) which corresponds to or represents the source content. The textual description may be overlaid on the folder which is provided as a user interface element that, when selected, causes the folder to open and display the contents of the folder to the user.

Large Language Models (LLMs) are capable of generating generic textual content. However, if a user wants to leverage an LLM to generate a specific type or style of content, the user either needs to experiment with a number of different prompting strategies, or retrain (finetune) the LLM on a number of training samples that demonstrate the specific type or style of content. Experimenting with different prompting strategies can result in unnecessary and redundant processing/content generation as the user will try a number of times to create the desired content before the appropriate style is achieved. Retraining the model is highly expensive in terms of computational usage. Therefore, both of these approaches result in wasted computational resources.

According to examples of the disclosure, a computing system is configured to automatically extract a type or style from one or more source documents (e.g., notes) and then apply the extracted type or style to generate a template for creating a new (output) document. For example, a computing system may be trained to learn a particular template based on a plurality of documents of a particular type. As an example, a user can upload a plurality of product requirements documents (PRDs) and the computing system may be configured to learn the document structure and style. Subsequently, the user (or another user) can upload a plurality of source documents (e.g., a plurality of user experience research (UXR) documents) and provide a request for a document to be generated having a particular format (e.g., a PRD format). The computing system may be configured to generate the PRD based on the plurality of source documents and based on the learned document structure and style.

In some implementations, the user can be provided with a graphical user interface to change or modify a style, format, and/or intent of the document template. For example, if the document template has a document format including a title section, description section, background section, and conclusion section which are provided in a particular order, the user may be provided with a graphical user interface which includes a plurality of user interface elements that can be selected to modify an order or arrangement of the sections. For example, if the document template has a particular style (e.g., opinionated), the user may be provided with a graphical user interface which includes a plurality of user interface elements that can be selected to change the style from the document template to another style (e.g., casual language).

In some implementations, the computing system can be configured to train one or more machine-learned models to learn attributes of a plurality of training documents to learn a document type and/or to learn an intent, a style, and a format of the plurality of training documents. The plurality of training documents may share one or more common features (e.g., a same or similar document type, a same or similar document structure, a same or similar style, etc.).

In some implementations, the computing system includes one or more databases configured to store a plurality of generative machine-learned models respectively associated with a plurality of different document types. The computing system may be configured to retrieve, from among the plurality of generative machine-learned models, at least one generative machine-learned model associated with a document type indicated by common content of the plurality of source documents. For example, the plurality of source documents may each contain content which is associated with a particular type of document (e.g., a resume, a PRD, a research paper, etc.).

According to examples of the disclosure, one or more first machine-learned models (e.g., one or more LLMs, one or more generative models, etc.) are configured to generate a persona based on one or more inputs received by the one or more first machine-learned models. The one or more first machine-learned models may be configured to generate the persona for use as an input to one or more second machine-learned models (e.g., one or more LLMs, one or more generative models, etc.) that can be implemented by the one or more second machine-learned models when generating an output (e.g., output content). In some implementations, the persona generated by the one or more first machine-learned models may be based on a document type, an audience, an intent, and/or other characteristics of the desired content. The one or more second machine-learned models can then be prompted with the created persona when it is used to generate the desired content.

As an example implementation, a user may want to generate a particular kind of document (e.g., a resume, a PRD, a competitive analysis, etc.). The one or more first machine-learned models may be configured to define a persona for the one or more second machine-learned models that can be used for generating the particular document. For example, the persona can be used by the one or more second machine-learned models to help a user determine what sections the particular document should include (e.g., a background section, a competitor section, a methodology section, etc., for a competitive analysis document). For example, the persona can be used by the one or more second machine-learned models to ask (query) the user questions about each section to ensure the output document has sufficient content and is effective and coherent (e.g., via a chat or dialogue exchange/operation). For example, the persona can be used by the one or more second machine-learned models to generate the output document (e.g., the competitive analysis document) with content for each of the sections, based on the information provided by the user and, in some implementations, based on information from other sources (e.g., source documents, external content, etc.).

In some implementations, the persona may take on characteristics of an expert in a particular topic associated with the output document, may take on characteristics of an expert with respect to drafting documents for a particular document type, etc. For example, the persona may have certain characteristics including particular hobbies, interests, have a similar expertise as a particular public figure, have a certain IQ range, have a certain Myers-Briggs type, etc. The one or more first machine-learned models may be configured to generate the persona based on or in response to the requirements of the document. In some implementations, the requirements of the document may be provided by the user or may be obtained (e.g., from external content, from a database, etc.) in response to the user indicating the particular document type to be output. The one or more first machine-learned models may be configured to identify or determine the particular persona (or personas) which are appropriate for the task.

As an example, the user may wish to generate a PRD type. The user may indicate an intent or goal (e.g., “I want to convince my executive leadership team to let me spend 30 days building a prototype for a to-do list app that I can then test with consumers”). The user may further indicate an audience (e.g., “My team leads, primarily execs. Maybe some teammates”).

In response to receiving the input information from the user, the one or more first machine-learned models may be configured to generate the persona. For example, based on the information received from the user, the one or more first machine-learned models may be configured to take on the persona (e.g., a persona of “Dr. Jane Smith”) having particular characteristics including one or more of a particular background, expertise, public stature, hobbies, interests, personality, cognitive traits, strengths that are suited for executing the task, which comport with the user's indicated intent or goal, which are appropriate given the indicated audience, etc. In particular, the user need not identify a particular persona or characteristics of the persona as the one or more first machine-learned models are configured to identify or determine the optimal or appropriate persona based on information such as document type, user intent or goals, and/or audience. Thus, the user need not ask the computing device to draft a document in a manner as written by “John Doe” or from the perspective of a particular role. Accordingly, the one or more first machine-learned models can achieve a technical effect in that reduced interactions and reduced inferences can be realized by the one or more first machine-learned models generating a persona which is appropriate for the document to be generated. Further, the persona can be generated with reduced interactions (e.g., with only a single interaction) which also conserves computing resources.

For example, the persona (e.g., Dr. Jane Smith) may have a particular background, including a particular degree, education, career experience, etc., that is appropriate for the task (e.g., a PhD in organizational psychology, consultant experience at a top-tier management consulting firm, professorship at a prestigious business school, etc.). For example, the persona (e.g., Dr. Jane Smith) may have a particular expertise appropriate for the task, including particular accomplishments, awards, recognitions, etc., that is appropriate for the task (e.g., recognized in the particular field as a thought leader and recognized as being effective at persuading C-suite executives, an author of papers for how employees can advocate for implementing innovative ideas, advising in product strategy and user experience, etc.). For example, the persona (e.g., Dr. Jane Smith) may have a particular public stature appropriate for the task (e.g., compared to other known public figures), including being compared to experts (e.g., a description as a blend of a first public figure having knowledge of organizational psychology and innovating thinking accomplishments and a second public figure known for insights into product design and management). For example, the persona (e.g., Dr. Jane Smith) may have particular hobbies and/or interests appropriate for the task (e.g., having hobbies and/or interests related to technology, being a member of a book club or organization related to business leadership, speaking at conferences related to innovation, etc.). For example, the persona (e.g., Dr. Jane Smith) may have particular personality and/or cognitive traits appropriate for the task (e.g., a particular Myers-Briggs type of INTJ being related to visionary, strategic, etc., a particular IQ range indicating superior intelligence, particular traits of being empathetic, intuitive, etc.). For example, the persona (e.g., Dr. Jane Smith) may have particular key strengths appropriate for the task (e.g., analytical skills, questioning techniques, articulate writing, etc.). For example, the persona (e.g., Dr. Jane Smith) may be defined according to a summary of the qualifications of the persona appropriate for the task (e.g., why the persona is “perfect” for the task, summarizing the persona's ability to understand the balance between innovation and corporate objectives, expertise, and ability to craft the document type relevant to the task).

In some implementations, the identity of the persona and/or the characteristics of the persona, may be hidden from the user.

For example, the persona can be generated via a single exchange between the user and the computing device (e.g., the user provides information relating to the persona via a single input). In some implementations, the minimum criteria for generating the persona may only include an identification of the document type (e.g., a resume, a competitive analysis, a PRD, etc.). In some implementations, the criteria for generating the persona may include at least an identification of the document type (e.g., a resume, a competitive analysis, a PRD, etc.) and one other criteria (e.g., a goal or intent of the document, an audience, etc.). For example, the persona can be generated without reference to a source document (e.g., a source document that is of the same document type and indicates an outline of the document type) or without the user providing a source document (e.g., a source document that is of the same document type and indicates an outline of the document type) which can be used by the one or more first machine-learned models for generating the persona.

After the persona is generated, the computing device may be configured to implement the one or more second machine-learned models to implement the persona to generate the output document (e.g., the PRD). For example, based on the persona, document type, goal, target audience, etc., the one or more second machine-learned models may be configured to generate the output document (e.g., the PRD). In some implementations, the one or more second machine-learned models may be configured to generate the output document by first generating an outline associated with the output document. For example, the one or more second machine-learned models may be configured to generate particular sections forming the outline.

For example, the computing device may be configured to exchange information with the user (e.g., via one or more chat or dialogue operations) to obtain content related to each of the sections of the outline. For example, the computing device may be configured to draft the output document according to the content obtained for the sections of the outline. In some implementations, the exchange of information may be in a question and answer format (e.g., in the form of an interview). In some implementations, if the user does not know the answer to a question provided by the computing device, the computing device may be configured to allow the user to skip the question. Thus, the outline and content provided therein for the sections may not necessarily be entirely complete. However, the computing device (e.g., the one or more second machine-learned models) may be configured to draft the output document even if all information is not supplied from the user in response to the questions posed to the user by the computing device.

In some implementations, the computing device may be configured to query the user sequentially, section by section. In some implementations, the computing device may be configured to query the user in an open-ended manner and fill in appropriate sections based on the content provided by the user. In some implementations, the computing device (e.g., the one or more second machine-learned models) may be configured to skip some sections, for example, according to the persona. In some implementations, whether a section is sufficiently covered by the user may be determined based on the judgment of the persona implemented by the one or more second machine-learned models. In some implementations, the computing device may be configured to allow the user to confirm the content that is provided to each section of the outline. In some implementations, the computing device may be configured to allow the user to supplement or correct the content that is provided to each section of the outline.

In some implementations, when the outline is complete and the one or more sections are filled out, the outline may be saved, for example as a note and/or as another document type. In some implementations, based on the content of the outline, the one or more second machine-learned models may be configured to generate the output document (e.g., the PRD). The output document can also be saved as a note and/or as another document type.

In some implementations, a persona generated by the computing device may also be implemented with respect to a first draft of a document already created by the user. For example, the user may request that the computing device rewrite or revise a first draft of the document by the one or more second machine-learned models implementing the persona, making the document cohesive. In some implementations, the request from the user may include information other than the first draft of the document (e.g., a source document). For example, the user may also indicate the document type, goal or intent, and/or audience which is associated with the request to revise the first draft of the document.

According to examples of the disclosure, a computing system is configured to generate an output document in an interactive manner. For example, a computing system may be configured to receive to a first input (e.g., a prompt which captures the intent of the user, such as a prompt to “write a report on the effect of generative AI on the American workforce”). In some implementations, the computing system may be configured, using one or more machine-learned models, to generate an outline having a plurality of sections, based on the first input. In some implementations, the user may provide one or more second inputs providing additional information for generating the output document, which can also be applied when generating the outline, as well as for content in sections in the outline. For example, the one or more second inputs may include or indicate a style to be applied to the output document, a target audience, a purpose, formatting attribute, a document length, etc. In some implementations, the user can indicate a particular viewpoint or perspective from which the output document should be drafted, for example, using a particular persona. In some implementations, the computing system may be configured to generate the persona based on the first input, or the first input and the one or more second inputs, and the persona can be utilized by the one or more machine-learned models to generate content for the output document and/or sections of the outline.

According to examples of the disclosure, the user can provide feedback regarding the generated outline and the generated sections. For example, the user can modify, add, or remove sections (e.g., through interaction with one or more user interface elements). The user can provide an input indicating that the generated outline is acceptable, and the computing system can be configured to begin a drafting process for generating content for each section for the outline, and for generating a final output document.

According to examples of the disclosure, the computing system can be configured to generate, via one or more machine-learned models, a plurality of questions for a particular section. For example, the questions may be generated based on a title of the section, the first input, the one or more second inputs, and source documents which are previously selected by the user as sources from which an output document is to be generated. In some implementations, the one or more machine-learned models may be configured to classify each question as being associated with a first context or a second context. For example, a question which is associated with the first context may correspond to a question that can be automatically answered via the one or more machine-learned models based on content included in the source documents (e.g., a “research” question). For example, a question which is associated with the second context may correspond to a question that the one or more machine-learned models has determined should be answered by the user (e.g., an “author” question). If the question is associated with the second context, the computing system may be configured to present a user interface by which the user can provide an answer to the question.

In some implementations, the computing system may be configured to provide a user interface which displays the question and answer pairs that can be used by the one or more machine-learned models for generating the content for the section. The user interface may also include one or more user interface elements which indicate the sources (citations) which were used to generate an answer for a corresponding question. In some implementations, the computing system may be configured to provide a user interface by which a user can remove a question and answer pair if the user does not want the one or more machine-learned models to rely on the question and answer pair for generating the content for the section. In some implementations, the user interface can interact with a user interface element to add a question and answer pair or regenerate the question and answer pairs. The user interface may be configured to include a user interface element to enable the user to accept the question and answer pairs. For example, the one or more machine-learned models may be configured to generate the content for the section in response to the user providing an input indicating acceptance of the question and answer pairs. The one or more machine-learned models may be configured to generate the content of the section based on the answers from the question and answer pairs, the source documents, the first input, the one or more second inputs, the title of the heading of the section, etc. A similar process may be repeated for each section until all sections are completed to complete the outline.

According to examples of the disclosure, the computing system can be configured to generate, via one or more machine-learned models, the output document based on the generated outline. For example, the one or more machine-learned models may be configured to generate the output document based on the outline including the content from each section, answers from the question and answer pairs, the source documents, the first input, the one or more second inputs, the title of the headings of the sections, etc.

In some implementations, the computing system may include a large machine-learned model configured to perform a document level analysis with respect to each section and/or with respect to the output document. For example, the computing system may be configured to provide a user interface by which the user can select a user interface element, that when selected, causes the large machine-learned model to be implemented to analyze (e.g., proofread) the section (or output document) to make revisions or edits as needed (e.g., to correct errors, to improve grammar, etc.). For example, the large machine-learned model may have a higher processing power (e.g., consume more computing resources) than other machine-learned models which are used to generate the outline or to generate the content of the sections in the outline, or to generate the output document.

In some implementations, the computing system may be configured to provide for presentation to the user the revised version of a section. For example, the computing system may be configured to provide for presentation to the user the original version of the section together with the revised version of the section so that the user can compare the versions, and the user can accept or reject the revised version of the section. In some implementations, the computing system may be configured to provide for presentation to the user the revised version of the output document. For example, the computing system may be configured to provide for presentation to the user the original version of the output document together with the revised version of the output document so that the user can compare the versions, and the user can accept or reject the revised version of the output document.

One or more technical benefits of the disclosure include generating content via one or more machine-learned models, based on particular items of content selected by a user. Current methods for a large language model (LLM) to generate an output require a user to copy and paste content from one document into a chat box to query the LLM about the content. Switching between multiple windows or applications results in significant amounts of wasted computational time and resources (e.g., processor cycles). In contrast to current methods, a summary regarding user-selected items of content (e.g., source content) can be automatically generated via a notebook application and one or more machine-learned models, in response to a user uploading the items of content. Therefore, a user need not switch between applications or windows, or provide a prompt.

Another technical benefit of the disclosure includes one or more machine-learned models providing suggested queries based on items of content selected by the user, suggested key topics based on items of content selected by the user, selectable chips based on an output of a response, and the like. A user can select a suggested query and the one or more machine-learned models may be configured to provide a response to the query based on the items of content selected by the user. Providing the suggested query automatically saves computing resources (e.g., networking resources including bandwidth, processor cycles, etc.) by not requiring the user to input the suggested query).

Another technical benefit of the disclosure includes one or more machine-learned models generating content based on items of content selected by the user and/or based on notes selected by the user. Generation of the content can save time and computing resources by not requiring a user to cut and paste content from multiple sources to generate new content (e.g., an outline, an essay, a report, etc.) which is based on a plurality of items of content.

Another technical benefit of the disclosure includes one or more machine-learned models generating a graphical image or animation to display in an overlaid manner on a folder to indicate content which is saved in the folder. The graphical image or animation can improve search capabilities and save computing resources that may otherwise be expended by a user opening and closing folders which do not contain content that the user is actually looking for.

Another technical benefit of the disclosure includes one or more machine-learned models providing suggested queries based on items of content selected by the user, suggested key topics based on items of content selected by the user, selectable chips based on an output of a response, and the like. A user can select a suggested query and the one or more machine-learned models may be configured to provide a response to the query based on the items of content selected by the user. Providing the suggested query automatically saves computing resources (e.g., networking resources including bandwidth, processor cycles, etc.) by not requiring the user to input the suggested query).

Another technical benefit of the disclosure includes one or more machine-learned models generating a document template based on training documents which can be provided by a user. For example, a user may not be familiar with the typical (accepted) or standard format for certain document types (e.g., a resume, a PRD, a legal opinion, etc.), and may not have the knowledge or expertise to provide an appropriate prompt to generate a document template having the proper format for a particular document type. Therefore, the document extractor application described herein can improve the efficiency of the one or more machine-learned models by generating a document template having the appropriate structure (e.g., style, intent, format, etc.) that can be used to generate an output document based on the proper document template. Accordingly, reduced interactions with the user for generating a document template can save or conserve bandwidth, network resources, computing processing power, etc. Further, reduced inferences for generating the document template by the one or more machine-learned models can also save or conserve bandwidth, network resources, computing processing power, etc.

Another technical benefit of the disclosure includes one or more machine-learned models generating an output document based on source documents which can be provided by a user and a document template that can be selected by the user or the computing device. For example, a user may not be familiar with the typical (accepted) or standard format for certain document types (e.g., a resume, a PRD, a legal opinion, etc.), and may not have the knowledge or expertise to provide an appropriate prompt to generate an output document having the proper format for a particular document type. Therefore, the document extractor application described herein can improve the efficiency of the one or more machine-learned models by generating an output document having the appropriate structure (e.g., style, intent, format, etc.) based on a document template that is appropriate for the document type. Accordingly, reduced interactions with the user for generating an output document based on a generated document template via one or more machine-learned models can save or conserve bandwidth, network resources, computing processing power, etc. Further, reduced inferences for generating the output document by the one or more machine-learned models can also save or conserve bandwidth, network resources, computing processing power, etc.

Another technical benefit of the disclosure includes one or more first machine-learned models generating a persona based on a document type indicated by a user, and in some implementations, based on additional information including one or more of a goal or intent of the user, a target audience, a topic of an output document to be generated, a source document, etc. For example, a user may not be familiar with a particular type of document and may not understand or know the sections of the document type. Further, the user may need to provide multiple prompts to define a persona, and the persona generated by the computing device may not be an optimal persona, which can cause an output document that is ultimately generated via the persona to be inaccurate, of poor quality, etc. Therefore, according to one or more examples of the disclosure interactions between the user and the computing device can be reduced by the one or more first machine-learned models generating a persona based on minimal information provided by the user (e.g., based on only a document type, based on only a document type and an intent of the user, based on only a document type and target audience, based on only a document type, an intent of the user, and target audience, etc.). Accordingly, computing resources can be conserved or be efficiently utilized.

Another technical benefit of the disclosure includes one or more second machine-learned models generating an output document utilizing the persona, and in some implementations based on additional information including one or more of a document type indicated by a user, a goal or intent of the user, a target audience, a topic of the output document to be generated, a source document, etc. For example, a user may not be familiar with a particular type of document and may not understand or know how to draft a particular document of the particular document type. Further, the user may need to provide multiple prompts to request the one or more second machine-learned models to generate the output document, and the output document generated by the computing device may be inaccurate, of poor quality, etc. Therefore, according to one or more examples of the disclosure interactions between the user and the computing device can be reduced by the one or more second machine-learned models generating an output document by utilizing the generated persona, and in some implementations, based on one or more of a document type, an intent of the user, target audience, topic of the output document, a source document (e.g., first draft of a document), additional input information received from a user via a chat operation, etc. Accordingly, computing resources can be conserved or be efficiently utilized.

Another technical benefit of the disclosure includes generating an outline and/or an output document utilizing one or more machine-learned models which generate an outline based on an initial prompt from a user and subsequently generate a plurality of questions in response to the user accepting the generated outline. Further, the one or more machine-learned models may be configured to distinguish or classify between questions associated with a first context and questions associated with a second context, where the one or more machine-learned models are configured to automatically retrieve answers for questions associated with the first context and obtain answers from a user for questions associated with the second context. For example, a user may not be familiar with a particular type of document and may not understand or know how to draft a particular document of the particular document type. Further, the user may need to provide multiple prompts to request the one or more machine-learned models to generate the output document, and the output document generated by the computing device may be inaccurate, of poor quality, etc. Therefore, according to one or more examples of the disclosure, interactions between the user and the computing device can be reduced by the one or more machine-learned models generating answers to questions associated with the first context. Further, an output having a higher quality may be achieved through a stepwise interaction with the user who can provide feedback at specific break points (e.g., after creation of an outline, after question and answer pairs are generated, after content for each section is generated). Further, although a larger number of inferences are performed, the inferences pertain to a smaller “chunk” of data requiring less computational resources (e.g., compared to an inference with respect to an entire output document). Accordingly, computing resources can be conserved or be efficiently utilized.

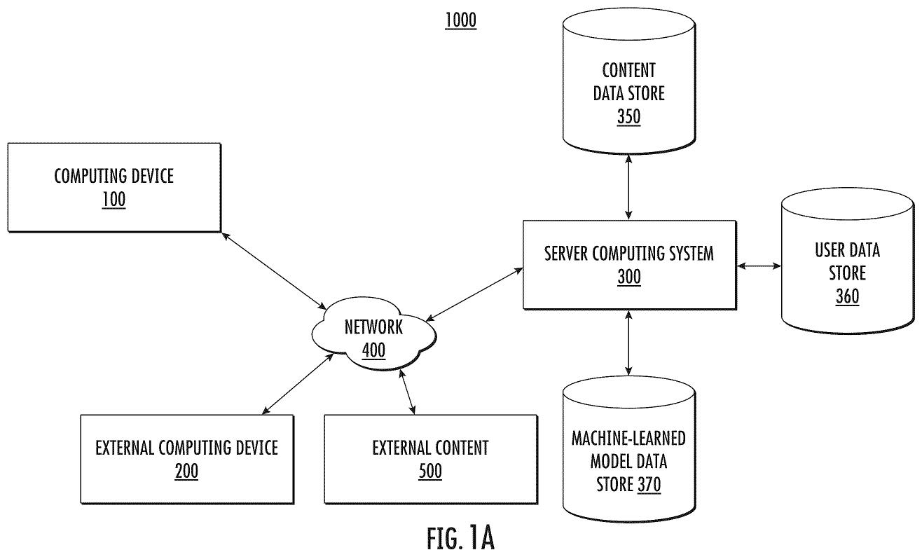

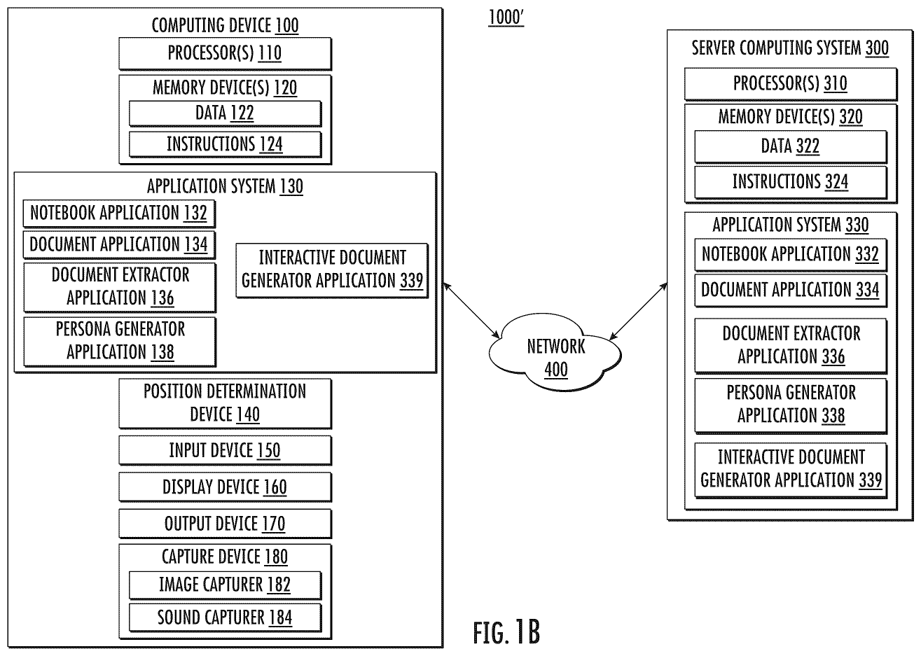

Referring now to the drawings, FIG. 1A is an example system according to one or more example embodiments of the disclosure. FIG. 1A illustrates an example of a system 1000 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a laptop, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of an application system which can provide a tool for users to create, manage, or organize information (e.g., documents, imagery, etc.), for example, via one or more machine-learned models.

In some example embodiments, the server computing system 300 may obtain data from one or more of a content data store 350, a user data store 360, and a machine-learned model data store 370, to implement various operations and aspects of the application system as disclosed herein. The content data store 350, user data store 360, and machine-learned model data store 370 may be integrally provided with the server computing system 300 (e.g., as part of the one or more memory devices 320 of the server computing system 300) or may be separately (e.g., remotely) provided. Further, content data store 350, user data store 360, and machine-learned model data store 370 can be combined as a single data store (database) or may include a plurality of respective data stores. Data stored in one data store (e.g., the content data store 350) may overlap with some data stored in another data store (e.g., the user data store 360). In some implementations, one data store (e.g., the machine-learned model data store 370) may reference data that is stored in another data store (e.g., the user data store 360).

In some examples, the content data store 350 can store any kind of information or content. For example, the content data store 350 can include books, product manuals, resumes, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, information may be stored in the content data store 350 by the user selecting certain documents, images, or other content to store in the content data store 350.

In some examples, the user data store 360 can include information regarding one or more user profiles, including a variety of user data such as user preference data, user demographic data, user calendar data, user social network data, user historical travel data, and the like. For example, the user data store 360 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, the data can be analyzed to determine preferences of the user with respect to generating, managing, and/or organizing content. In some implementations, the data can be used for automatically generating a summary of a document in a particular manner or style, for automatically providing customized features with respect to content, for automatically providing suggestions, recommendations, and/or questions relating to certain content identified by the user as source content, for automatically generating a document template, for automatically generating a document based on the document template, for automatically providing suggestions, recommendations, and/or questions relating to generating a persona via one or more machine-learned models which can be used to generate an outline and/or a document, for automatically providing suggestions, recommendations, and/or questions relating to content to be generated via a persona created via one or more machine-learned models, etc.

The user data store 360 is provided to illustrate potential data that could be analyzed, in some embodiments, by the computing device 100 and/or server computing system 300 to identify user preferences, to make recommendations, to generate, manage, and/or organize content, etc., However, such user data may not be collected, used, or analyzed unless the user has consented after being informed of what data is collected and how such data is used. Further, in some embodiments, the user can be provided with a tool (e.g., in an application system including a notebook application, document application, document extractor application, persona generator application, etc., or via a user account) to revoke or modify the scope of permissions. In addition, certain information or data can be treated in one or more ways before it is stored or used, so that personally identifiable information is removed or stored in an encrypted fashion. Thus, particular user information stored in the user data store 360 may or may not be accessible to the computing device 100 and/or server computing system 300 based on permissions given by the user, or such data may not be stored in the user data store 360 at all.

Machine-learned model data store 370 can store machine-learned models which can be retrieved and implemented by the server computing system 300 for generating distilled or fine-tuned machine-learned models (e.g., distilled or fine-tuned generative machine-learned models) that, in some implementations, can also be provided to the computing device 100. Machine-learned model data store 370 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 370 can include generative machine-learned models respectively associated with different types of content (e.g., different genres or subjects, different kinds of content including imagery, videos, and text, different types of content or documents (e.g., outlines, reports, spreadsheets, etc.), documents having different styles (e.g., casual, opinionated, expert, etc.), documents having different formats (e.g., an outline format, a PRD format, a resume format, etc.), documents having different intentions (e.g., to inform, to persuade, to compare, to contrast, etc.), personas having different characteristics or features, personas which are associated with particular document types, particular audiences, particular user goals or intents, etc. The machine-learned models may include large language models (e.g., the Bidirectional Encoder Representations from Transformers (BERT) large language model) and general, multimodal models (e.g., Gemini). The machine-learned models may include generative artificial intelligence (AI) models (e.g., Bard) which may implement generative adversarial networks (GANs), transformers, variational autoencoders (VAEs), neural radiance fields (NeRFs), and the like.

External content 500 can be any form of external content including news articles, webpages, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

Referring now to FIG. 1B, example block diagrams of a system 1000′ including a computing device 100 and server computing system 300 according to one or more example embodiments of the disclosure will now be described. Although computing device 100 is represented in FIG. 1B, features of the computing device 100 described herein are also applicable to the external computing device 200.

The computing device 100 may include one or more processors 110, one or more memory devices 120, an application system 130, a position determination device 140, an input device 150, a display device 160, an output device 170, and a capture device 180. The server computing system 300 may include one or more processors 310, one or more memory devices 320, and an application system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can also include data 122 and instructions 124 that can be retrieved, manipulated, created, or stored by the one or more processors 110. In some example embodiments, such data can be accessed and used as input to implement notebook application 132, and to execute the instructions to perform operations including: providing a user interface including a first portion and a second portion, wherein the first portion includes a textual summary generated via one or more machine-learned models based on a plurality of documents selected by a user and the second portion includes a plurality of user interface elements to perform an operation with respect to the textual summary, as described according to examples of the disclosure.

In some example embodiments, such data can be accessed and used as input to implement the document extractor application 136, and to execute the instructions to perform operations including: receiving a plurality of source documents, receiving an input associated with a request to generate the output document based on the plurality of source documents and a particular document template, and generating, via one or more machine-learned models, the output document having the particular document template, as described according to examples of the disclosure.

In some example embodiments, such data can be accessed and used as input to implement the persona generator application 138, and to execute the instructions to perform operations including: receiving an input from a user indicating a document type, generating, via one or more first machine-learned models, a persona based on the document type, and generating, via one or more second machine-learned models, an output document corresponding to the document type, by utilizing the persona to generate content for the output document, as described according to examples of the disclosure.

In some example embodiments, such data can be accessed and used as input to implement the interactive document generator application 139, and to execute the instructions to perform operations including: receiving an input from a user indicating a document type, generating, via one or more first machine-learned models, a persona based on the document type, and generating, via one or more second machine-learned models, an output document corresponding to the document type, by utilizing the persona to generate content for the output document, as described according to examples of the disclosure.

For example, the one or more memory devices 320 can also include data 322 and instructions 324 that can be retrieved, manipulated, created, or stored by the one or more processors 310. In some example embodiments, such data can be accessed and used as input to implement notebook application 332, and to execute the instructions to perform operations including: providing a user interface including a first portion and a second portion, wherein the first portion includes a textual summary generated via one or more machine-learned models based on a plurality of documents selected by a user and the second portion includes a plurality of user interface elements to perform an operation with respect to the textual summary, as described according to examples of the disclosure.

In some example embodiments, such data can be accessed and used as input to implement the document extractor application 336, and to execute the instructions to perform operations including: receiving a plurality of source documents, receiving an input associated with a request to generate the output document based on the plurality of source documents and a particular document template, and generating, via one or more machine-learned models, the output document having the particular document template, as described according to examples of the disclosure.

In some example embodiments, such data can be accessed and used as input to implement persona generator application 338, and to execute the instructions to perform operations including: receiving an input from a user indicating a document type, generating, via one or more first machine-learned models, a persona based on the document type, and generating, via one or more second machine-learned models, an output document corresponding to the document type, by utilizing the persona to generate content for the output document, as described according to examples of the disclosure.

In some example embodiments, such data can be accessed and used as input to implement the interactive document generator application 339, and to execute the instructions to perform operations including: receiving an input from a user indicating a document type, generating, via one or more first machine-learned models, a persona based on the document type, and generating, via one or more second machine-learned models, an output document corresponding to the document type, by utilizing the persona to generate content for the output document, as described according to examples of the disclosure.

In some example embodiments, the computing device 100 includes an application system 130. For example, the application system 130 may include the notebook application 132, a document application 134 (e.g., a word processing application, a spreadsheet application, a presentation application, an imagery application, etc.), a document extractor application 136, a persona generator application 138, and an interactive document generator application 139. The application system 130 can include various other applications including text messaging applications, email applications, dictation applications, virtual keyboard applications, browser applications, map applications, social media applications, navigation applications, etc.

According to examples of the disclosure, the notebook application 132 may be executed by the computing device 100 to provide a user of the computing device 100 a way to organize, manage, create, and interact with content, particularly with content that is curated or selected by the user. In some implementations, the notebook application 132 may be part of document application 134, or may be a standalone application. The notebook application 132 may be configured to be dynamically interactive according to various user inputs. Example implementations of the notebook application 132 are described herein, however the disclosure is not limited to these examples as various modifications may be made to the embodiments described herein.

In some examples, one or more aspects of the notebook application 132 may be implemented by the notebook application 332 of the server computing system 300 which may be remotely located, to organize, manage, create, and interact with content, in response to receiving an input from a user. In some examples, one or more aspects of the notebook application 332 may be implemented by the notebook application 132 of the computing device 100, to organize, manage, create, and interact with content, in response to receiving an input from a user.

According to examples of the disclosure, the document application 134 may be executed by the computing device 100 to provide a user of the computing device 100 a way to organize, manage, create, and interact with content, particularly with content that is curated or selected by the user. The document application 134 can be any kind of application that pertains to documents (e.g., in a textual or visual format), and can include word processing applications, spreadsheet applications, presentation applications, visual applications, portable document format file applications, etc. In some implementations, the notebook application 132, document application 134, document extractor application 136, persona generator application 138, and interactive document generator application 139 may interact with each other. For example, content from a document that is created via the document application 134 may be uploaded or stored for use with notebook application 132. In some implementations, the notebook application 132 may be configured to generate a document (e.g., a report, an outline, a presentation, a spreadsheet) which can be compatible with (opened by or exported to) the document application 134. In some implementations, the notebook application 132 may be configured to generate the document (e.g., a report, an outline, a presentation, a spreadsheet) such that the document has a particular style, format, and/or intent, based on a document template that is generated via the document extractor application 136.

In some examples, the document application 134 can be a dedicated application specifically designed to provide a particular service. In other examples, the document application 134 can be a general application (e.g., a web browser) and can provide access to a variety of different services via the network 400.

According to examples of the disclosure, the document extractor application 136 may be executed by the computing device 100 to provide a user of the computing device 100 a document template for organizing, managing, creating, and interacting with content, particularly with content that is curated or selected by the user. In some implementations, the document extractor application 136 may be part of document application 134 and/or notebook application 132, or may be a standalone application. The document extractor application 136 may be configured to be dynamically interactive according to various user inputs. Example implementations of the document extractor application 136 are described herein, however the disclosure is not limited to these examples as various modifications may be made to the embodiments described herein.

In some examples, one or more aspects of the document extractor application 136 may be implemented by the document extractor application 336 of the server computing system 300 which may be remotely located, to provide a document template for organizing, managing, creating, and interacting with content, in response to receiving an input from a user. In some examples, one or more aspects of the document extractor application 336 may be implemented by the document extractor application 136 of the computing device 100, to provide a document template for organizing, managing, creating, and interacting with content, in response to receiving an input from a user.

According to examples of the disclosure, the persona generator application 138 may be executed by the computing device 100 to provide a user of the computing device 100 with a persona for implementation by one or more machine-learned models to generate content (e.g., an outline, a document, etc.) which may have a particular document type, intent, and/or audience. In some implementations, the persona generator application 138 may be part of the interactive document generator application 139, the document application 134, the notebook application 132, and/or may be a standalone application. The persona generator application 138 may be configured to be dynamically interactive according to various user inputs. Example implementations of the persona generator application 138 are described herein, however the disclosure is not limited to these examples as various modifications may be made to the embodiments described herein.

In some examples, one or more aspects of the persona generator application 138 may be implemented by the persona generator application 338 of the server computing system 300 which may be remotely located, to provide a persona for organizing, managing, creating, and interacting with content, in response to receiving an input from a user. In some examples, one or more aspects of the persona generator application 338 may be implemented by the persona generator application 138 of the computing device 100, to provide a persona for organizing, managing, creating, and interacting with content, in response to receiving an input from a user.

According to examples of the disclosure, the interactive document generator application 139 may be executed by the computing device 100 to provide a user of the computing device 100 with a method for generating content via one or more machine-learned models to generate content (e.g., an outline, a document, etc.) which may have a particular document type, intent, and/or audience. In some implementations, the interactive document generator application 139 may be part of the document application 134, the notebook application 132, the persona generator application 138 and/or may be a standalone application. The interactive document generator application 139 may be configured to be dynamically interactive according to various user inputs. Example implementations of the interactive document generator application 139 are described herein, however the disclosure is not limited to these examples as various modifications may be made to the embodiments described herein.

In some examples, one or more aspects of the interactive document generator application 139 may be implemented by the interactive document generator application 339 of the server computing system 300 which may be remotely located, to provide a persona for organizing, managing, creating, and interacting with content, in response to receiving an input from a user. In some examples, one or more aspects of the interactive document generator application 339 may be implemented by the interactive document generator application 139 of the computing device 100, to provide a method for organizing, managing, creating, and interacting with content, in response to receiving one or more inputs from a user.

In some example embodiments, the computing device 100 includes a position determination device 140. The position determination device 140 can determine a current geographic location of the computing device 100 and communicate the geographic location to server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the computing device 100.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for selecting content that is to be organized or managed, for selecting queries or actions with respect to content that is curated or selected by the user, for uploading a plurality of training documents for generating a document template that can be applied with respect to a plurality of source documents, for selecting the plurality of source documents for generating an output document based on the document template, for providing one or more inputs related to creating a persona, for providing one or more inputs related to generating content by utilizing the persona, for providing one or more inputs related to providing feedback regarding generating a document, etc.

The computing device 100 may include a display device 160 which displays information viewable by the user (e.g., a user interface screen). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the computing device 100 to display information to a user relating to an input (e.g., information relating to a document, to a note, to a project, to a document template, to the creation of a persona, to an outline, to a user interface screen having user interface elements which are selectable by the user, etc.).

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like). For example, the capture device 180 can include a sound capturer 184 (e.g., a microphone) which is configured to capture sound or audio (e.g., an audio recording). The media content captured by the capture device 180 may be transmitted to one or more of the server computing system 300, content data store 350, user data store 360, and machine-learned model data store 370, for example, via network 400. For example, in some implementations, media content which is captured by the capture device 180 may be selected as source content by a user for use in creating a note with respect to a project. The media content can be provided as an input to one or more machine-learned models to generate a note, an outline, or other document, for example.

In accordance with example embodiments of the disclosure, the server computing system 300 can include one or more processors 310 and one or more memory devices 320 as described herein. The server computing system 300 may also include an application system 330 which is similar to the application system 130 described herein.

For example, the application system 330 may include a notebook application 332 which performs functions similar to those discussed herein with respect to notebook application 132, a document application 334 which includes applications similar to those discussed above with respect to document application 134, a document extractor application 336 which performs functions similar to those discussed herein with respect to document extractor application 136, a persona generator application 338 which performs functions similar to those discussed herein with respect to persona generator application 138, and an interactive document generator application 339 which performs functions similar to those discussed herein with respect to interactive document generator application 139. In some implementations, one or more machine-learned models (e.g., generative machine-learned models, large language models, etc.) associated with the application system 330 may be configured to organize, manage, create, and interact with content based on source content that is curated or selected by a user. For example, one or more machine-learned models (e.g., generative machine-learned models, large language models, etc.) associated with the application system 330 may be configured to perform a first action (e.g., generate a summary or document guide with respect to source content selected by a user), while the computing device 100 may be configured to perform a second action (e.g., generate suggested actions, generate an outline or study guide based on a plurality of notes saved to a scratchpad). For example, one or more machine-learned models (e.g., generative machine-learned models, large language models, etc.) associated with the application system 130 may be configured to perform a first action (e.g., upload source content selected by a user), while the server computing system 300 may be configured to perform a second action (e.g., generate a document template based on the uploaded source content). For example, one or more machine-learned models (e.g., generative machine-learned models, large language models, etc.) associated with the application system 130 may be configured to perform a first action (e.g., provide an input from a user indicating a document type, intent, and/or audience), while the server computing system 300 may be configured to perform a second action (e.g., generate a persona based on the input from the user). For example, a particular action to be performed by the application system 330 may vary according to a network status (e.g., an available bandwidth, a channel utilization status, a latency status, a throughput rate, etc.). In some implementations, one or more machine-learned models associated with the application system 330 may be configured to process a user input to generate information (e.g., semantic information) which can then be provided as an input to one or more other machine-learned models (e.g., generative machine-learned models, large language models, etc.) associated with the application system 330, to generate the content to be utilized with respect to a project for the notebook application 132 and/or notebook application 332.

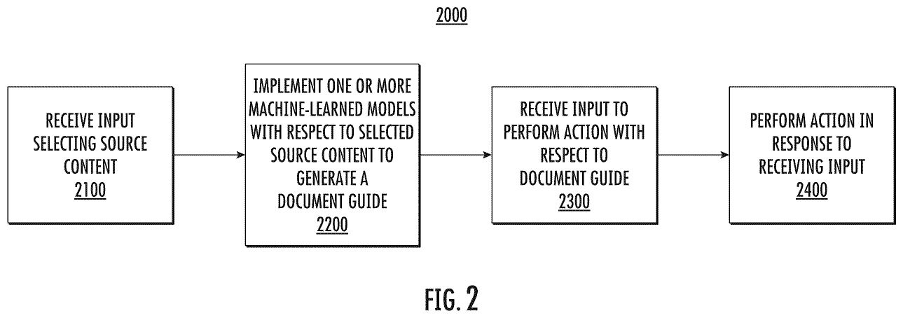

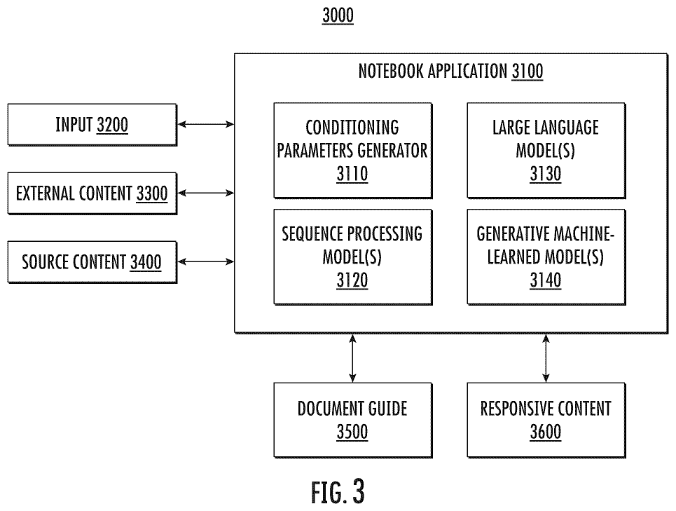

Examples of the disclosure are also directed to computer implemented methods for providing a user interface for organizing, managing, and creating content by implementing one or more machine-learned models with respect to source content selected by a user. FIG. 2 illustrates a flow diagram of an example, non-limiting computer-implemented method, according to one or more example embodiments of the disclosure. FIG. 3 illustrates a block diagram of a notebook application, according to one or more example embodiments of the disclosure.

The flow diagram of FIG. 2 illustrates a method 2000 for providing a user interface for organizing, managing, and creating content by implementing one or more machine-learned models with respect to source content selected by a user. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 2, at operation 2100 the method 2000 includes a computing device receiving an input from a user relating to the selection of source content. As described herein, the computing device may be embodied as computing device 100, server computing system 300, or combinations thereof. For example, the input may be provided by the user via input device 150. For example, the input may be provided by selecting particular files or documents which are uploaded to the computing device for use by the notebook application 132. In some implementations, the content can be uploaded from a local memory, from another application (e.g., a portable document file application), from copied text, or from a website. The selected files, text, documents, etc. may be referred to as source content. In some implementations, the source content may be a subset of a larger corpus of content. The input may be provided or input to notebook application 132 or notebook application 332, for example.

In some implementations, a response to the input selecting the source content may be processed at computing device 100 without involving the server computing system 300. In some implementations, the input selecting the source content may be transmitted from computing device 100 to server computing system 300 and at least part of the response to the input may be processed by the server computing system 300. For example, the input relating to the selection of the source content may be provided at the computing device 100 and the server computing system 300 may be configured to perform an operation in response to receiving an indication of the input.

At operation 2200, the computing device may be configured to implement one or more machine-learned models with respect to the selected source content to generate a document guide. In some implementations, the document guide (source guide) generated by the one or more machine-learned models may include a summary of the source content and key topics relating to the source content. In some implementations, the document guide may further include one or more suggested queries (e.g., questions) that may be provided in the form of a selectable user interface element.

For example, the computing device can obtain information indicating that the user has selected source content. The computing device can process the source content with one or more machine-learned models (e.g., one or more large language models) to obtain a language output. The computing device can then use the one or more machine-learned models (e.g., one or more large language models) to generate a summarization output. In particular, a machine-learned large language model can be trained to process a variety of outputs to generate a language output. For example, the machine-learned large language model can process an embedding generated by a machine-learned embedding generation model, portions of the source content identified using the embedding generation model, language outputs generated using the machine-learned large language model or some other model, etc.

At operation 2300, the computing device may be configured to receive an input to perform an action with respect to the document guide. At operation 2400 the computing device may be configured to perform the action in response to receiving the input. For example, the input may be the selection of a suggested query and the action may include providing an answer to the question by implementing the one or more machine-learned models with respect to the source content. For example, the input may be a text input asking a question and the action may include providing an answer to the question by implementing the one or more machine-learned models with respect to the source content. For example, the input may be a selection of a portion of the summary and the action may include providing an output indicating particular sources from among the source content which were relied upon for generating the text associated with the selection of the portion of the summary.

Referring to FIG. 3, notebook application 3100 (which may correspond to notebook application 132 and/or notebook application 332) may include a conditioning parameters generator 3110, one or more sequence processing models 3120, one or more large language models 3130, and one or more generative machine-learned models 3140. The notebook application 3100 may receive an input 3200 from a user as discussed above with respect to operation 2100 and operation 2300 of FIG. 2. Conditioning parameters generator 3110 may be configured to generate conditioning parameters based at least in part on the input, wherein the conditioning parameters provide values for one or more conditions associated with content to be generated which relates at least in part to the input 3200 and source content 3400 selected by the user.

For example, source content 3400 can include any kind of document (e.g., in digital form) and may include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, source content 3400 may be stored in the content data store 350 by the user selecting certain documents, images, or other content to store in the content data store 350. In some implementations, source content 3400 may be stored at the computing device 100 or server computing system 300.

To generate the conditioning parameters, the conditioning parameters generator 3110 may be configured to retrieve values for the one or more conditions associated with the input. For example, to generate the conditioning parameters, the conditioning parameters generator 3110 may be configured to extract the values for the one or more conditions from the input. The input may include information indicative of the user's intent or requirements. In some implementations, the conditioning parameters generator 3110 (or the one or more sequence processing models 3120 or the one or more large language models 3130) may be configured to extract information from the input 3200 to identify values for the one or more conditions, and the conditioning parameters generator 3110 may be configured to generate the conditioning parameters based on the extracted values. For example, the input itself may identify a color to be used for headings in a generated document (e.g., “blue font for the title”) or an attribute or feature (e.g., “circle bullet points”) that can be used to generate the conditioning parameters for generating a document related to the source content.

To generate the conditioning parameters, the conditioning parameters generator 3110 may be configured to infer the values for the one or more conditions from the input. The input may include information indicative of the user's intent or requirements. In some implementations, the conditioning parameters generator 3110 (or the one or more sequence processing models 3120 or the one or more large language models 3130) may be configured to infer information from the input 3200 to identify values for the one or more conditions, and the conditioning parameters generator 3110 may be configured to generate the conditioning parameters based on the inferred values. For example, the input may include a reference to a length (“short,” “long,” etc.) of the summary to be generated or of another document to be generated based on the source content, and the conditioning parameters generator 3110 (or the one or more sequence processing models 3120 or the one or more large language models 3130) may be configured to infer a value based on the input. For example, an input requesting the notebook application 3100 to generate a “short” essay may infer a value of about 500 words while a “long” essay may be associated with a value of about 2000 words. For example, the notebook application 3100 may be configured to ascertain an inferred value based on information via external content 3300.

In some implementations, the conditioning parameters generator 3110 may be configured to infer the values for the one or more conditions from the input by providing the input to one or more sequence processing models 3120, wherein the one or more sequence processing models 3120 are configured to output the values for the one or more conditions in response to or based on the query. The one or more sequence processing models 3120 may include one or more machine-learned models which are configured to process and analyze sequential data and to handle data that occurs in a specific order or sequence, including time series data, natural language text, or any other data with a temporal or sequential structure.

The one or more sequence processing models 3120 may receive an input including text and tokenize the input by breaking down the sequence of text into small units (tokens) to provide a structured representation of the input sequence. The one or more sequence processing models 3120 may represent the tokens as vectors in a continuous vector space by mapping each token to a high-dimensional vector, where the relationships between tokens (words) are reflected in the geometric relationships between their corresponding vector. For example, the one or more sequence processing models 3120 may receive an input including the text “How did the Cold War end?” and tokenize the input by breaking down the sequence of text into small units (tokens) (e.g., “How,” “Cold War,” and “end”), thereby providing a structured representation of the input sequence. In a word embedding, semantically similar words are closer together in the vector space. For example, the vectors for “war” and “battle” might be close to each other because of their semantic relationship, while the vectors for “war” and “peace” may be far apart compared to the vectors for “war” and “battle”.

The one or more large language models 3130 can be, or otherwise include, a model that has been trained on a large corpus of language training data in a manner that provides the one or more large language models 3130 with the capability to perform multiple language tasks. For example, the one or more large language models 3130 can be trained to perform summarization tasks, conversational tasks, simplification tasks, oppositional viewpoint tasks, etc. In particular, the one or more large language models 3130 can be trained to process a variety of outputs to generate a language output. For example, the one or more large language models 3130 can process an embedding generated by a machine-learned embedding generation model, portions of source content (e.g., document chunk(s)) identified using an embedding generation model, language outputs generated using the one or more large language models 3130 or some other model, etc.

The one or more generative machine-learned models 3140 may include a deep neural network or a generative adversarial network (GAN), variational autoencoders, stable diffusion machine-learned models, visual transformers, neural radiance fields (NeRFs), etc., to generate content (e.g., a summary, response to a query, etc.) with values for conditions associated with one or more features. For example, the computing device may include a database (e.g., machine-learned model data store 370) which is configured to store a plurality of generative machine-learned models respectively associated with a plurality of different types of content (e.g., different genres or subjects, different kinds of content including imagery, videos, and text, different styles of content including outlines, reports, spreadsheets, etc.). In some implementations, the computing device may be configured to retrieve, from among the one or more generative machine-learned models 3140, a generative machine-learned model associated with a particular type of content relating to the input.

In some implementations, the one or more generative machine-learned models 3140 may be trained on a large dataset of content (e.g., a large corpus of language training data) with corresponding information about the conditions associated with the content. During training, the one or more generative machine-learned models 3140 learn relationships between elements in an output (e.g., content) and conditions that influence them. This may involve the computing device adjusting each generative machine-learned model's internal parameters to generate realistic or accurate content (e.g., grammatically correct content, coherent content, etc.) based on the training data. The one or more generative machine-learned models 3140 may be trained on one or more training datasets including a plurality of reference images of the location. The one or more training datasets may include values for the one or more conditions.

In some implementations, the one or more generative machine-learned models 3140 are configured to generate the document guide 3500 in response to receiving the selection of source content 3400 and/or to generate responsive content 3600 which corresponds to content that is generated in response to the input to perform an action with respect to the document guide, etc., based on the conditioning parameters (and corresponding values for the one or more conditions) to make decisions for generating content.

In some implementations, the server computing system 300 may provide (transmit) content or a portion of the generated content to computing device 100 or the server computing system 300 may provide access to the generated content to the computing device 100. For example, the document guide 3500 may be generated at the server computing system 300 and stored at one or more computing devices (e.g., one or more of computing device 100, external computing device 200, server computing system 300, external content 500, content data store 350, user data store 360, etc.).

In some implementations, after a document guide is generated and/or after an action is performed with respect to the document guide, the user can provide feedback or a further input relating to the content which is generated based on the source content provided and/or a query provided via the user, and one or more of the operations 2100 through 2400 can be repeated.

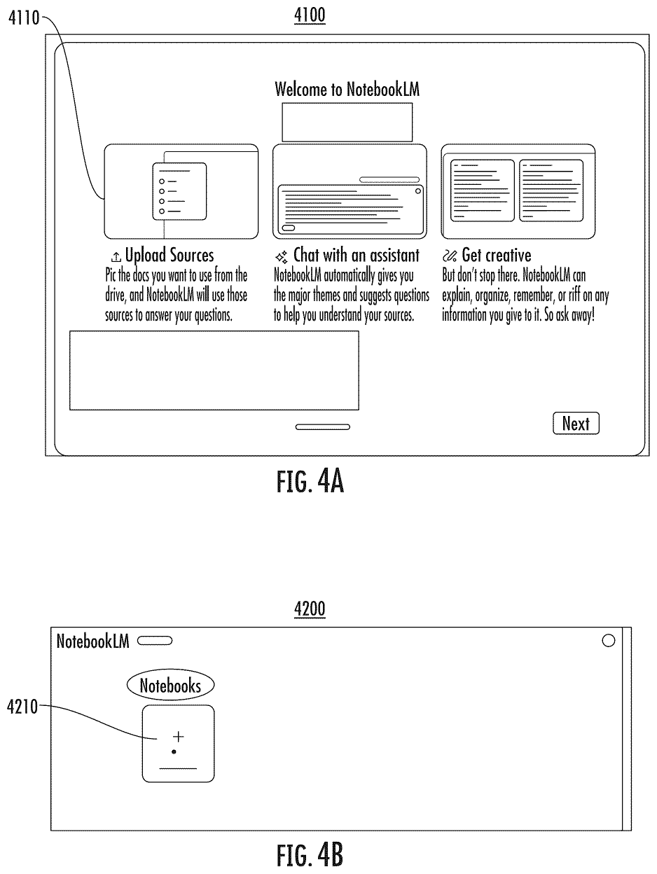

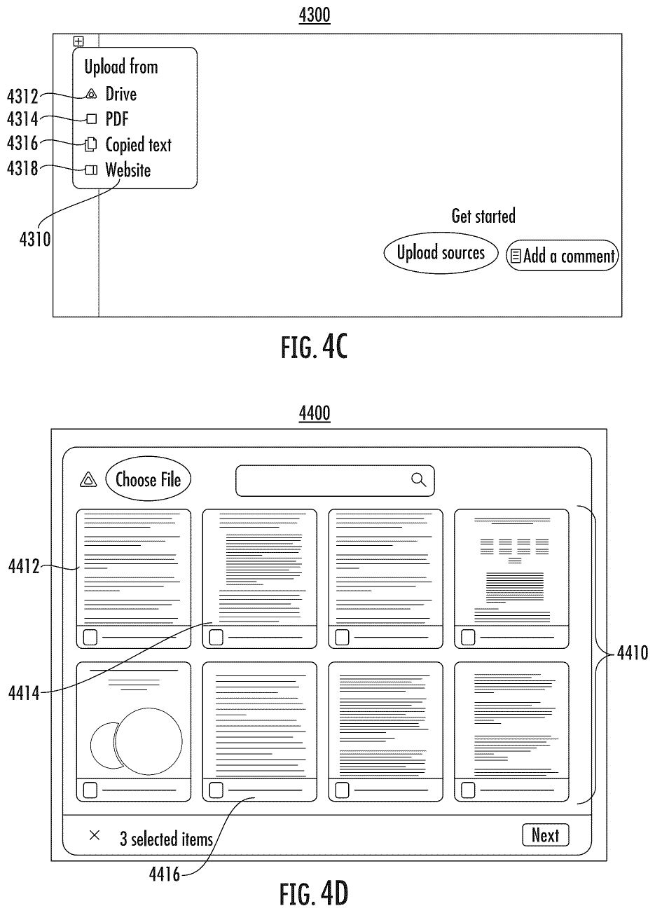

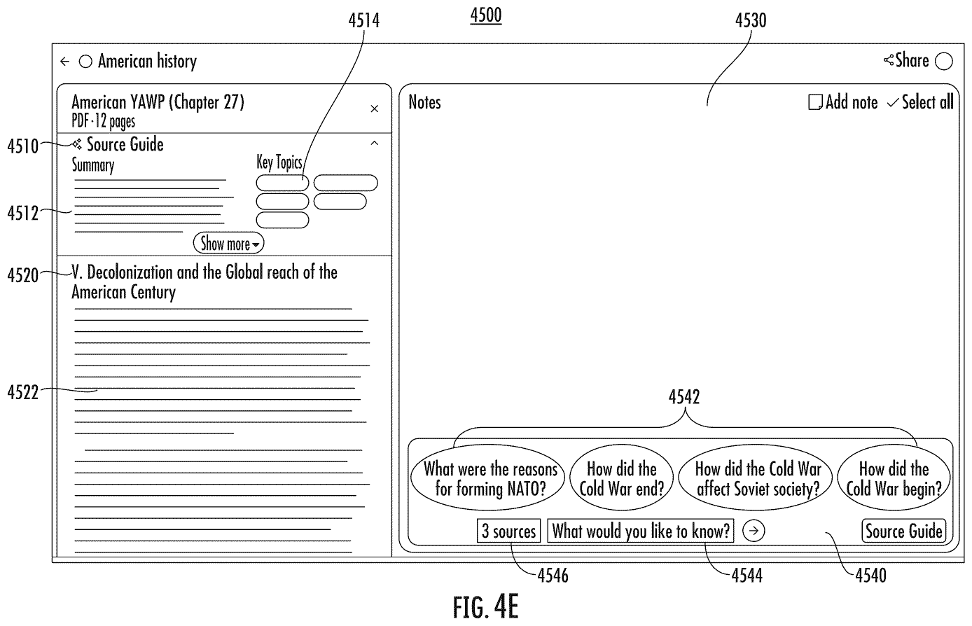

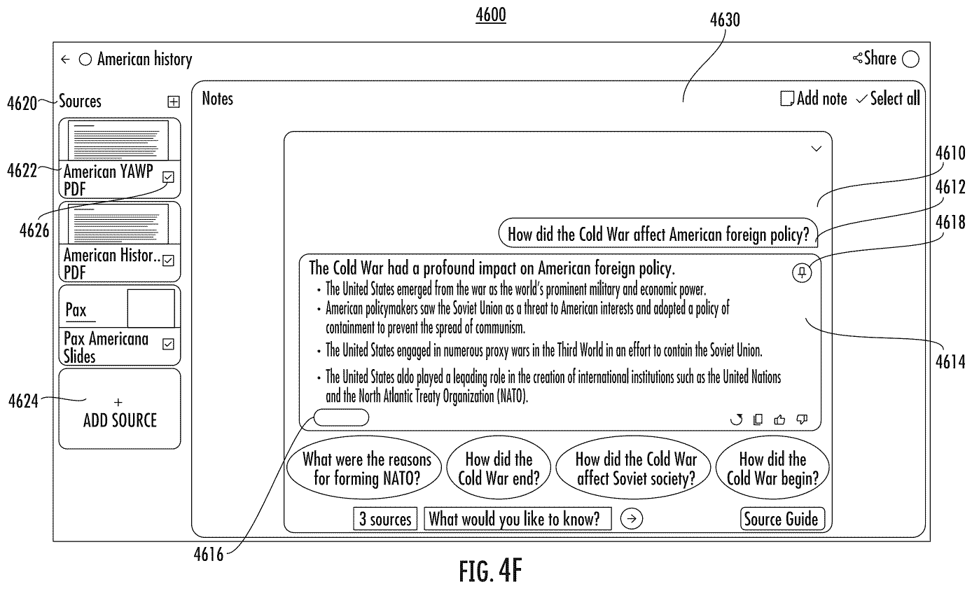

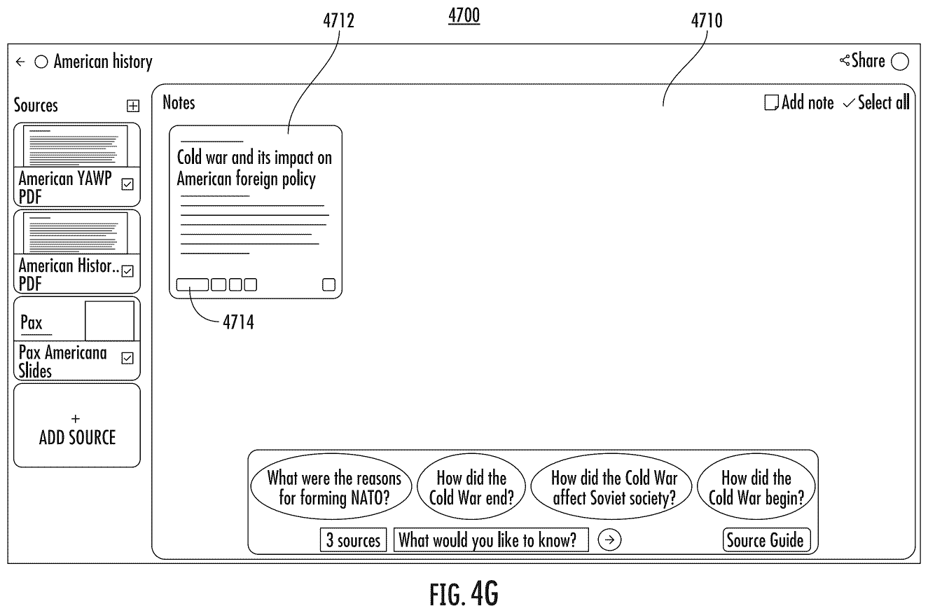

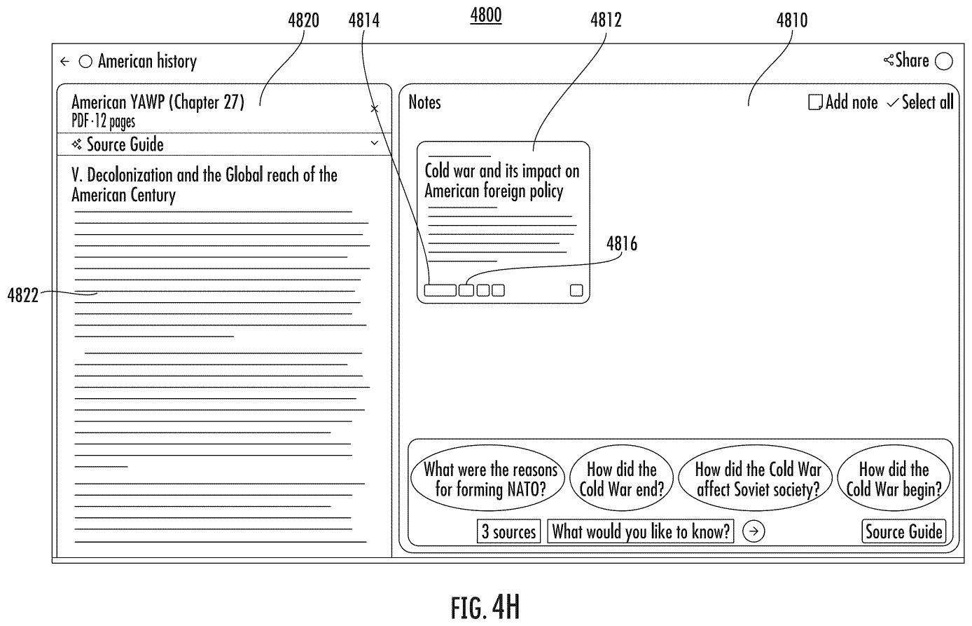

Examples of the disclosure are also directed to user-facing aspects by which a user can manage content, organize content, create content, etc., via a notebook application which is configured to implement one or more machine-learned models with respect to source content selected by the user. For example, FIGS. 4A through 4H illustrate examples of actions which can be implemented for a project in which a document guide is generated via one or more machine-learned models based on source content selected by a user, according to one or more example embodiments of the disclosure.

For example, FIG. 4A illustrates a first user interface screen (e.g., a startup user interface screen, a startup graphical user interface, etc.) of a notebook application, according to one or more example embodiments of the disclosure.

In FIG. 4A, first user interface screen 4100 depicts a user interface (e.g., a launch screen) which provides information about the notebook application 3100. In particular, notebook application 3100 is configured to present for display the first user interface screen 4100 which includes various information 4110 regarding features which are available in the notebook application 3100.

As illustrated in FIG. 4B, the notebook application 3100 is further configured to present for display a second user interface screen 4200 which includes a first user interface element 4210. For example, the first user interface element 4210 is associated with enabling a user to create a new notebook (a new project) by which a user can manage content, organize content, create content, etc., based on source content which the user can select or curate.

As illustrated in FIG. 4C, the notebook application 3100 is further configured to present for display a third user interface screen 4300 in response to a user providing an input to create a new notebook (e.g., via the selection of the first user interface element 4210). The third user interface screen 4300 includes a first portion 4310 having a plurality of selectable user interface elements that correspond to locations where the source content can be uploaded from. For example, first user interface element 4312 corresponds to a storage space which may be associated with a local computing device or a remote server system (e.g., a cloud server), or another storage device (e.g., a portable storage device). For example, second user interface element 4314 corresponds to a portable document format file, third user interface element 4316 corresponds to copied text, and fourth user interface element 4318 corresponds to content which can be uploaded from a particular website or URL.

As illustrated in FIG. 4D, the notebook application 3100 is further configured to present for display a fourth user interface screen 4400 in response to the selection of one of the plurality of selectable user interface elements that correspond to locations where the source content can be uploaded from, described with respect to FIG. 4C. The fourth user interface screen 4400 includes a first portion 4410 having a plurality of selectable items of source content (e.g., a plurality of documents, images, videos, etc.). For example, first user interface element 4412 corresponds to a first selected document, second user interface element 4414 corresponds to a second selected document (e.g., a portable document format file), and third user interface element 4416 corresponds to a third selected document. FIG. 4D illustrates that the user can curate or select particular items of source content which can be used for creating a notebook or project and which can be relied upon by one or more machine-learned models as input data for organizing content, managing content, creating content, etc.

As illustrated in FIG. 4E, the notebook application 3100 is further configured to present for display a fifth user interface screen 4500 in response to the selection of one or more items of content from the plurality of items of source content, described with respect to FIG. 4D. The fifth user interface screen 4500 includes a first portion 4510, a second portion 4520, a third portion 4530, and a fourth portion 4540. Each portion of the fifth user interface screen 4500 may correspond to a section or panel of the fourth user interface screen 4400 and can be associated with a different functionality.

For example, the first portion 4510 corresponds to a document guide (also referred to as a source guide) which includes a summary section 4512 and a key topics section 4514. The notebook application 3100 may be configured to generate the content (e.g., a textual description) associated with the summary section 4512 by implementing one or more machine-learned models as described herein with respect to FIG. 3, based on the selected source content (e.g., as described with respect to FIG. 4D). For example, the summary section 4512 may provide a brief summary associated with one or more of the items of content which comprise the selected source content. Likewise, the notebook application 3100 may be configured to generate the content (e.g., a textual description) associated with the key topics section 4514 by implementing one or more machine-learned models as described herein with respect to FIG. 3, based on the selected source content (e.g., as described with respect to FIG. 4D). For example, the key topics section 4514 may include one or more user interface elements which identify themes or important topics associated with one or more of the items of content which comprise the selected source content. Further, the notebook application 3100 may be configured to generate an output in response to a selection of one of the user interface elements in the key topics section 4514. The output may be a text summary or text explanation regarding the key topic corresponding to the selected user interface element, for example. The output may be provided in a separate user interface screen or provided in another portion of the fifth user interface screen which the notebook application 3100 is configured to generate in response to the selection of one of the user interface elements in the key topics section 4514.

For example, the second portion 4520 corresponds to a source content section (e.g., a context window) which includes information 4522 from at least a portion of an item of content from the source content. The notebook application 3100 may be configured to reproduce at least a portion of an item of content from the source content in the second portion 4520. In some implementations, the content in the source content section may correspond to a portion of an item of content which was relied upon for generating the summary section 4512.

For example, the third portion 4530 corresponds to a notes section (e.g., a scratchpad) which can include one or more notes that may be generated via various methods as described herein (e.g., automatically generated by the notebook application 3100, manually entered by a user, automatically generated by the notebook application 3100 in response to the selection of a user interface element which corresponds to an action to be performed, etc.).

For example, the fourth portion 4540 corresponds to a query section which can include one or more user interface elements for submitting or providing a query to the notebook application 3100 with respect to the source content. For example, the fourth portion 4540 includes a plurality of user interface elements 4542 which correspond to suggested questions or actions that are related to the source content. For example, the notebook application 3100 may be configured to generate the suggested questions or actions based on information included in the source content. For example, the notebook application 3100 may be configured to generate the suggested questions or actions based additionally on dialogue history (e.g., prior questions or queries), user data (e.g., preferences of the user, user attributes, etc.), and other contextual information. The fourth portion 4540 may further include a text entry box 4544 by which a user can provide an input (e.g., via a keyboard, via a voice input, etc.) to query the notebook application 3100. The fourth portion 4540 may further include a user interface element 4546 which indicates the number of items of content which comprise the source content. For example, in FIG. 4E, user interface element 4546 indicates three sources were relied upon by the notebook application 3100 to generate the summary section 4512.

Referring to FIG. 4F, an example user interface screen illustrates an input question and output response relating to the source content. For example, in FIG. 4F the notebook application 3100 is further configured to present for display a sixth user interface screen 4600 in response to receiving a query (e.g., a text query input via the text entry box 4544 of FIG. 4E). For example, sixth user interface screen 4600 includes a first portion 4610 which corresponds to a dialogue section, a second portion 4620 which corresponds to a sources section, and a third portion 430 which corresponds to a notes section (e.g., a scratchpad).

For example, the first portion 4610 includes a prompt area 4612 that corresponds to the text query and a response area 4614 that corresponds to the response to the text query. In some implementations, the notebook application 3100 is configured to generate the response by implementing one or more machine-learned models in response to receiving the text query as an input and with reference to the source content 3400. For example, if a user inputs a question (e.g., “How did the Cold War affect American foreign policy?) via the text entry box 4544 as described with respect to FIG. 4E, the notebook application 3100 may be configured to provide the sixth user interface screen 4600 and to generate a response as indicated in the response area 4614. As indicated in the response area 4614, the number of references (items of source content) relied upon by the one or more machine-learned models to generate the response may be indicated by a first user interface element 4616. In the example of FIG. 4F, three references were used to generate the response. The response area 4614 further includes a selectable second user interface element 4618 that, when selected, causes the response to be saved as a note to the third portion 4630 which corresponds to the notes section (e.g., a scratchpad) which can include one or more notes that may be generated via various methods as described herein (e.g., automatically generated by the notebook application 3100 in response to the selection of second user interface element 4618, etc.).

In some implementations, one or more portions of the response area may include information which is selectable that, when selected, can cause additional information to be displayed relating to the selected information. For example, in FIG. 4F the text “policy of containment” may be highlighted, bolded, underlined, or be displayed in some visually distinct manner to indicate that the text is selectable (e.g., a clickable chip) and additional information relating to the text is available. The notebook application 3100 may be configured to provide the additional information (e.g., by implementing one or more machine-learned models based on the selected source content) to provide additional information relating to the text, in response to the selection of the text.

The second portion 4620 may correspond to a source section and include the items of content 4622 which comprise the source content. In some implementations, the items of content 4622 may correspond to items of content which are relied upon by the one or more machine-learned models for generating the response. In some implementations, the notebook application 3100 may be configured to dynamically modify or re-generate a response in the response area 4614, in response to receiving an additional item of content to be added as source content via the user interface element 4624. In addition, or alternatively, in some implementations, the notebook application 3100 may be configured to dynamically modify or re-generate a response in the response area 4614, in response to receiving a deselection of an item of content from the list of items of content in the second portion 4620 via the user interface element 4626 (e.g., by unchecking the checkbox for one or more of the items of content in the second portion 4620).

Referring to FIG. 4G, an example user interface screen includes an example notes section (scratchpad) for a project, according to examples of the disclosure. For example, in FIG. 4G the notebook application 3100 is further configured to present for display a seventh user interface screen 4700 in response to receiving a selection of the second user interface element 4618 (e.g., as shown in FIG. 4F) that, when selected, causes the response to be saved as a note 4712 to the third portion 4710 which corresponds to the notes section (e.g., a scratchpad) which can include one or more notes that may be generated via various methods as described herein (e.g., automatically generated by the notebook application 3100 in response to the selection of second user interface element 4618, etc.). In FIG. 4G, user interface element 4714 indicates the number of items of content the one or more machine-learned models relied upon to generate the response for note 4712. Further, user interface element 4714 may be configured to be selectable such that in response to user interface element 4714 being selected, a list of the items of content (citations) from the source content used for generating the response can be provided for display.

Referring to FIG. 4H, an example user interface screen includes a notes section (scratchpad) for a project, according to examples of the disclosure. For example, in FIG. 4H the notebook application 3100 is further configured to present for display an eighth user interface screen 4800 in response to receiving a selection of an item 4816 of content from a list 4814 of items of content (citations) from the source content used by the one or more machine-learned models for generating the response saved in the note 4812 which is provided for display in the first portion 4810. The eighth user interface screen 4800 further includes a second portion 4820 which corresponds to a sources section. In FIG. 4H, the notebook application 3100 is configured to provide for display in the second portion 4820 information 4822 relating to the selected item 4816, in response to receiving the selection of the item 4816 of content from the list 4814 of items of content (citations) from the source content used by the one or more machine-learned models for generating the response saved in the note 4812.

In some implementations the information 4822 may include information from the item 4816 of content that was used to generate the response. For example, the notebook application 3100 may be configured to reference metadata associated with the response to refer back to the information 4822. The metadata may indicate a location of information from an item of content used to generate the response. Further, the information 4822 may correspond to or include a particular passage that was relied upon from the item of content for generating the response. For example, the notebook application 3100 may be configured to cause the particular passage to be displayed in the second portion 4820 in a visually distinctive manner (e.g., in a highlighted manner, a bold manner, an enlarged font size, an underlined manner, an italicized manner, etc.). For example, the notebook application 3100 may be configured to cause additional passages which appear before and/or after the particular passage to be displayed in the second portion 4820. This additional information may provide further context for the user regarding the information that was relied upon for generating the response. For example, the notebook application 3100 may be configured to mark particular items of content relied upon for generating the response in the note 4812 as well as mark particular passages from the particular items of content relied upon for generating the response in the note 4812. Therefore, a user can easily and visually discern where support for a response can be found in an item of content.

In some implementations, the information 4822 from the selected item 4816 of content that was used to generate the response may be truncated or shown in its entirety. For example, when the information 4822 is less than a threshold value, the entire text from the selected item 4816 of content can be shown in the second portion 4820 and can be used by the one or more machine-learned models for generating a response (e.g., to a text query). For example, when the information 4822 is more than the threshold value, the notebook application 3100 may be configured to implement a semantic retrieval method to determine particular passages from the entirety of the selected item 4816 of content which are relevant to a user query (e.g., a text query). In this example, the relevant passages (rather than the entirety of the information from the item of content) is relied upon by the one or more machine-learned models for generating a response to the user query (e.g., the text query).

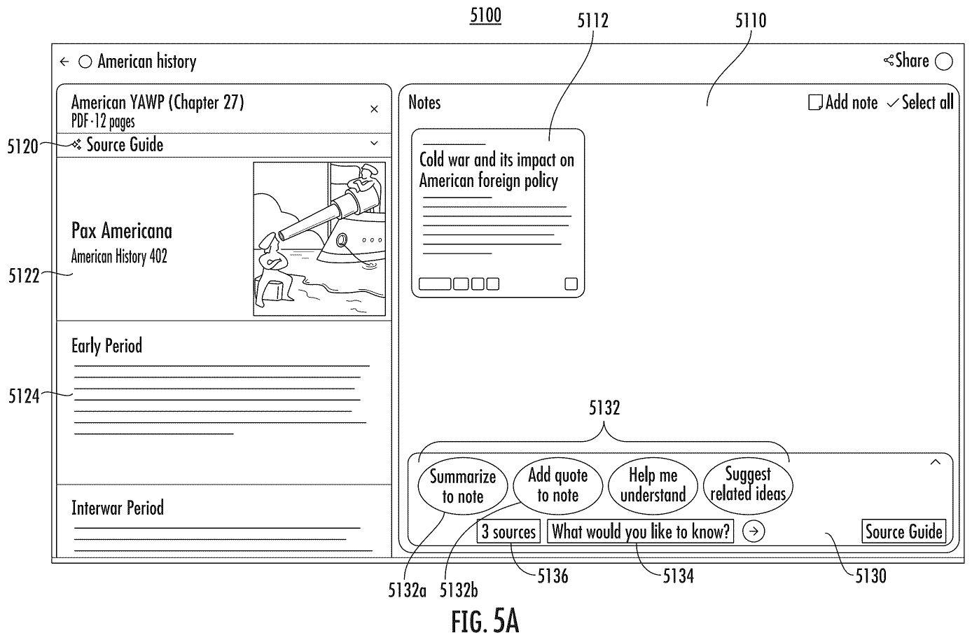

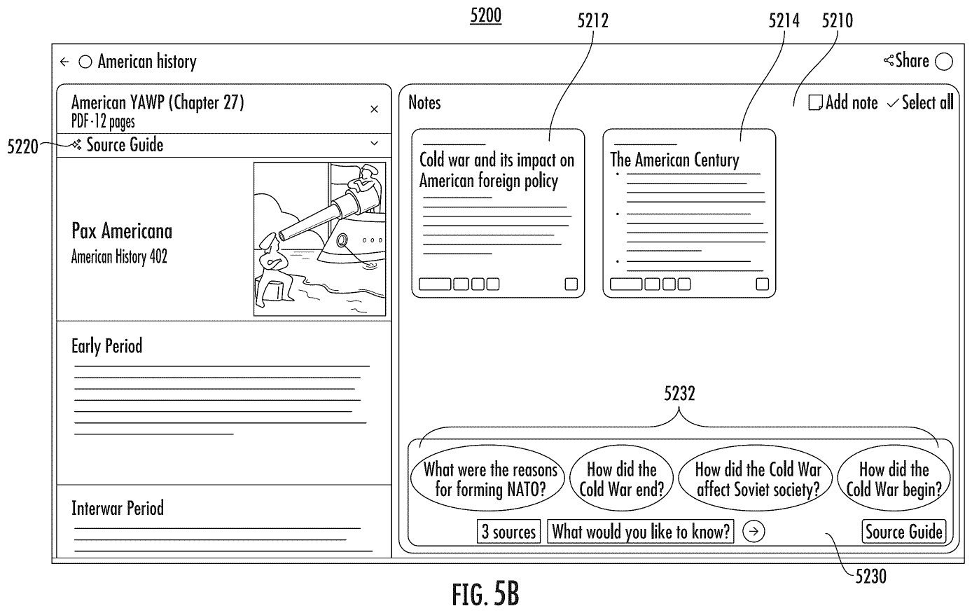

Examples of the disclosure are directed to further user-facing aspects by which a user can manage content, organize content, create content, etc., via a notebook application which is configured to implement one or more machine-learned models with respect to source content selected by the user. For example, FIGS. 5A through 5B illustrate examples of actions which can be implemented for a project in which a note is generated via one or more machine-learned models based on source content selected by a user, according to one or more example embodiments of the disclosure.

For example, FIG. 5A illustrates a first user interface screen of a notebook application, according to one or more example embodiments of the disclosure. For example, in FIG. 5A the first user interface screen 5100 includes a first portion 5110, a second portion 5120, and a third portion 5130. First portion 5110 corresponds to a notes section (e.g., a scratchpad) which can include one or more notes 5112 that may be generated via various methods as described herein (e.g., automatically generated by the notebook application 3100, manually entered by a user, automatically generated by the notebook application 3100 in response to the selection of a user interface element which corresponds to an action to be performed, etc.).

Second portion 5120 corresponds to a source content section (e.g., a source guide or context window) which can include one or more sources 5122 (e.g., items of content which comprises the source content 3400 relied upon by the one or more machine-learned models for generating the information included in the one or more notes 5112). In some implementations, the notebook application 3100 may be configured to generate a note which is saved to the first portion 5110 as a note based on a selection of at least a portion of the information from an item of content which is provided in the second portion 5120. For example, FIG. 5A illustrates selected text 5124 (e.g., highlighted text) that has been selected by a user.

For example, the third portion 5130 corresponds to a query section which can include one or more user interface elements for submitting or providing a query to the notebook application 3100 with respect to the source content. For example, the third portion 5130 includes a plurality of user interface elements 5132 which correspond to suggested questions or actions that are related to the source content. For example, the notebook application 3100 may be configured to generate the suggested questions or actions based on information included in the source content and/or based on the information displayed in the second portion 5120. The third portion 5130 may further include a text entry box 5134 by which a user can provide an input (e.g., via a keyboard, via a voice input, etc.) to query the notebook application 3100. The third portion 5130 may further include a user interface element 5136 which indicates the number of items of content which comprise the source content. For example, in FIG. 5A, user interface element 5136 indicates three sources were relied upon by the notebook application 3100 to generate the one or more notes 5112.

In some implementations, the plurality of user interface elements 5132 may be configured to dynamically change based on actions with respect to the first user interface screen 5100. For example, the notebook application 3100 may be configured to dynamically change, modify, delete, or add user interface elements in the third portion 5130 based on an action with respect to the source content (e.g., with respect to items of content provided for display in the second portion 5120). In FIG. 5A, the notebook application 3100 may be configured to dynamically change user interface elements in the third portion 5130 based on (in response to) the selection of text from one or more sources 5122 (e.g., the selected text 5124). For example, as indicated in FIG. 5A the actions may include summarizing the selected text to a note, adding a quote to a note, requesting additional information regarding the selected text 5124, or suggesting related ideas. For example, the notebook application 3100 may be configured to generate a note summarizing the selected text in response to receiving a selection of user interface element 5132a which corresponds to the action of summarizing the selected text to a note. For example, the notebook application 3100 may be configured to add content to an existing note corresponding to the selected text in response to receiving a selection of user interface element 5132b which corresponds to the action of adding a quote to a note.

For example, FIG. 5B illustrates a second user interface screen of a notebook application, according to one or more example embodiments of the disclosure. For example, in FIG. 5B second user interface screen 5200 includes a first portion 5210, a second portion 5220, and a third portion 5230, each of which may correspond to the first portion 5110, second portion 5120, and third portion 5130 of FIG. 5A.

As described with respect to FIG. 5A, the notebook application 3100 may be configured to generate a note summarizing the selected text in response to receiving a selection of user interface element 5132a which corresponds to the action of summarizing the selected text to a note. FIG. 5B illustrates the generated note 5214 which has been saved to the first portion 5210 which includes one or more notes 5212. Further, in some implementations after the generated note 5214 is saved to the first portion 5210, the plurality of user interface elements 5132 from FIG. 5A may be configured to dynamically change back to a previous state to the plurality of user interface elements 5232 shown in FIG. 5B.

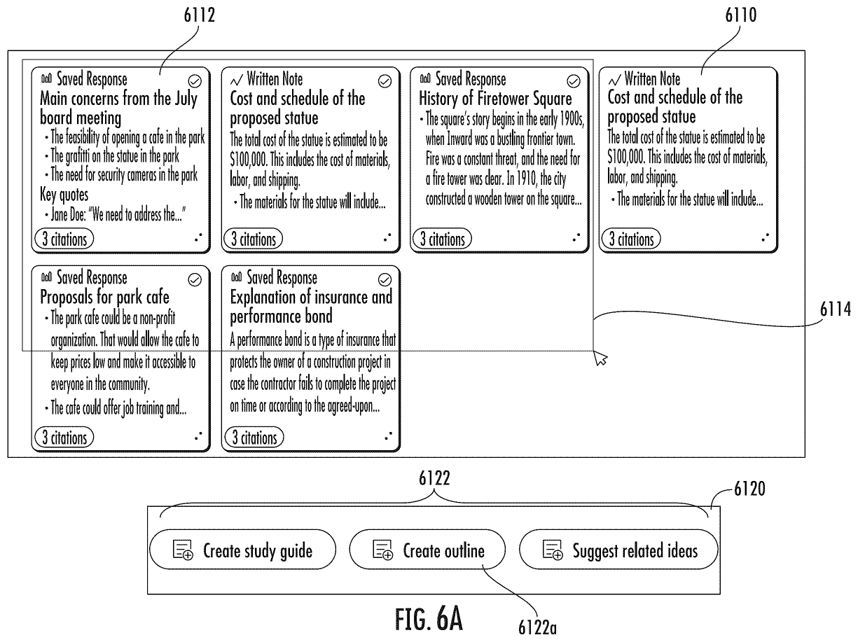

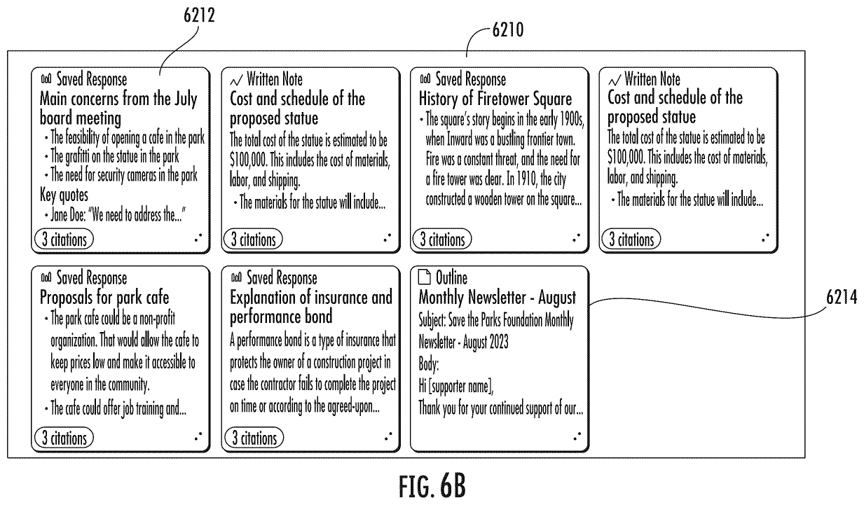

Examples of the disclosure are directed to further user-facing aspects by which a user can manage content, organize content, create content, etc., via a notebook application which is configured to implement one or more machine-learned models with respect to source content selected by the user. For example, FIGS. 6A through 6B illustrate examples of actions which can be implemented for a project in which a note is generated via one or more machine-learned models based on source content selected by a user, according to one or more example embodiments of the disclosure.

For example, FIG. 6A illustrates a portion of a first user interface screen of a notebook application, according to one or more example embodiments of the disclosure. For example, in FIG. 6A a first portion 6110 and a second portion 6120 of a user interface screen are shown. First portion 6110 corresponds to a notes section (e.g., a scratchpad) which can include a plurality of notes that may have been generated via various methods as described herein (e.g., automatically generated by the notebook application 3100, manually entered by a user, automatically generated by the notebook application 3100 in response to the selection of a user interface element which corresponds to an action to be performed, etc.). For example, the first portion 6110 may indicate how a particular note is created (e.g., as a saved response, as written note which is written by a user, as a document generated from other notes, etc.).

For example, the second portion 6120 corresponds to a query section which can include one or more user interface elements for submitting or providing a query to the notebook application 3100 with respect to the source content or with respect to the plurality of notes. For example, the second portion 6120 includes a plurality of user interface elements 6122 which correspond to suggested questions or actions that are related to the source content or plurality of notes. For example, the notebook application 3100 may be configured to generate the suggested questions or actions based on information included in the source content and/or based on the information displayed in the first portion 6110. The second portion 6120 may further include a text entry box by which a user can provide an input (e.g., via a keyboard, via a voice input, etc.) to query the notebook application 3100, a user interface element which indicates the number of items of content which comprise the source content, etc.

In the example of FIG. 6A, the notebook application 3100 may be configured to dynamically change user interface elements in the second portion 6120 based on (in response to) the selection of one or more notes 6112 from among the plurality of notes provided in the first portion 6110. For example, as indicated in FIG. 6A one or more notes may be selected via a user input (e.g., via a drag input, via selecting checkboxes, etc.) and in response to the selection of the one or more notes, the actions may include actions for creating content (e.g., creating a study guide, creating an outline, creating a spreadsheet, creating a presentation, etc.), suggesting related ideas, etc., based on the selected notes 6114. For example, the notebook application 3100 may be configured to generate a note which corresponds to an outline of the content from the selected notes 6114, in response to receiving a selection of user interface element 6122a which corresponds to the action of creating an outline and saving the outline to a note. For example, the notebook application 3100 may be configured to implement one or more machine-learned models to generate the note which corresponds to the selected notes 6114, in response to receiving a selection of a user interface element which corresponds to an action of creating content with respect to the selected one or more notes and saving the content as a note.

For example, FIG. 6B illustrates a portion of a second user interface screen of a notebook application, according to one or more example embodiments of the disclosure. For example, in FIG. 6B the first portion 6210 may correspond to the first portion 6110 of FIG. 6A.

As described with respect to FIG. 6A, the notebook application 3100 may be configured to generate a note based on one or more selected notes, by implementing one or more machine-learned models, where the selected notes may correspond to source content (e.g., source content selected by a user and used as an input for generating the note). For example, the generated note may summarize or outline the notes which have been selected as described with respect to FIG. 6A. The notebook application 3100 may be configured to generate the generated note 6214 based on the selected notes 6114, by implementing one or more machine-learned models, where the selected notes 6114 may correspond to source content (e.g., source content selected by a user and used as an input for generating the note), and in response to receiving a selection of a user interface element (e.g., user interface element 6122a) which corresponds to an action of summarizing the selected notes 6114 to the generated note 6214. FIG. 6B illustrates the generated note 6214 which has been saved to the first portion 6210 which includes one or more other notes 6212. Further, in some implementations after the generated note 6214 is saved to the first portion 6210, the plurality of user interface elements 6122 from FIG. 6A may be configured to dynamically change back to a previous state.

In some implementations, the notebook application 3100 may be configured to enable a generated note 6214 to be exported to other applications via selection of a user interface element to send the document to another application (e.g., a word processing application, a presentation application, a spreadsheet application, a social media application, etc.). In some implementations, the notebook application 3100 may be configured to enable a generated note 6214 and/or items of content (e.g., source content 3400) to be shared with other users via selection of a user interface element to share the document and/or source content with another user.

According to examples of the disclosure, the notebook application 3100 may be configured to generate an output (e.g., an outline, a report, a summary, etc.) via one or more machine-learned models, based on source content provided to the notebook application (e.g., by the user). The notebook application 3100 may be configured to allow a user to create various projects to complete various tasks. Each project may be configured to act in a manner similar to a folder by which a user can store various information to each project. In some implementations, an individual scratchpad may correspond to or be dedicated to a particular project. In some implementations, the notebook application 3100 may be configured to receive the source content as specified by the user. The notebook application 3100 may be configured to add, delete, or modify projects according to an input received from a user. Each project may be provided a default name, a name provided by the user, or a name generated by the notebook application 3100 (e.g., via one or more machine-learned models) based on the information stored in the project (e.g., based on the source content).

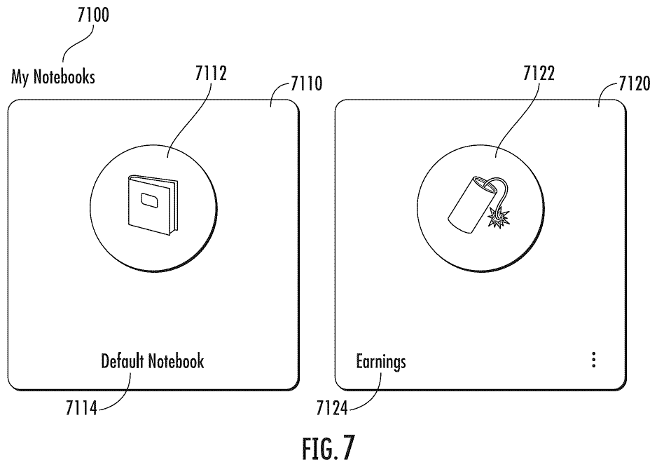

Examples of the disclosure are directed to further user-facing aspects by which a user can manage content, organize content, create content, etc., via a notebook application which is configured to implement one or more machine-learned models with respect to source content selected by the user. For example, FIG. 7 illustrates examples of notebooks or projects which can be represented in a particular manner so that a user can readily understand the contents contained within the notebook or project.

In some implementations, in response to source content being provided to the notebook application 3100, the notebook application 3100 may be configured to automatically generate (e.g., using one or more machine-learned models, one or more generative machine-learned models, semantic retrieval technologies, etc.), a graphical image (e.g., an emoji, an icon, etc.) or graphical animation which corresponds to or represents the source content. In some implementations, the graphical image or graphical animation may be overlaid on a folder which is provided as a user interface element that, when selected, causes the folder to open and display the contents of the folder to the user. In addition, or alternatively, in some implementations, in response to the source content being provided to the notebook application 3100, the notebook application 3100 may be configured to automatically generate (e.g., using one or more machine-learned models, one or more generative machine-learned models, semantic retrieval technologies, etc.), a textual description (name) which corresponds to or represents the source content. The textual description may be overlaid on the folder which is provided as a user interface element that, when selected, causes the folder to open and display the contents of the folder to the user.

Referring to FIG. 7, the notebook application 3100 may have a user-specific section 7100 which stores various projects in particular folders. For example, a first folder 7110 (e.g., default folder) may be represented by a default image 7112 and have a generic name 7114 (e.g., “Default Notebook”). For example, a second folder 7120 may be represented by a graphical image 7122 and have a textual description 7124 (e.g., “Earnings”) which is machine-learned generated and represents or corresponds to content included in the second folder 7120. For example, in response to source content being provided to the notebook application 3100, the notebook application 3100 may be configured to automatically generate (e.g., using one or more machine-learned models, one or more generative machine-learned models, semantic retrieval technologies, etc.), the graphical image 7122 which may correspond to an emoji, an icon, etc., which corresponds to or represents the source content. In some implementations, the graphical image 7122 may be overlaid on the second folder 7120 which is provided as a user interface element that, when selected, causes the second folder 7120 to open and display the contents of the second folder 7120 to the user. In addition, or alternatively, in some implementations, in response to the source content being provided to the notebook application 3100, the notebook application 3100 may be configured to automatically generate (e.g., using one or more machine-learned models, one or more generative machine-learned models, semantic retrieval technologies, etc.), the textual description 7124 (name) which corresponds to or represents the source content. The textual description 7124 may be overlaid on the second folder 7120 which is provided as a user interface element that, when selected, causes the second folder 7120 to open and display the contents of the second folder 7120 to the user.

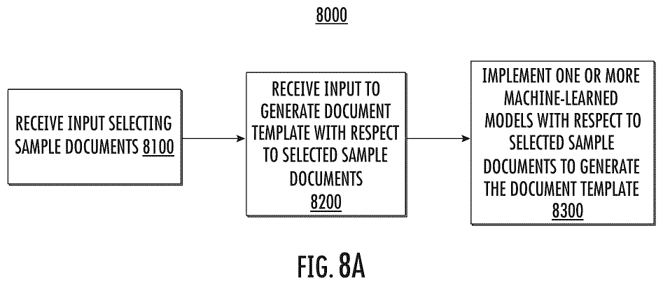

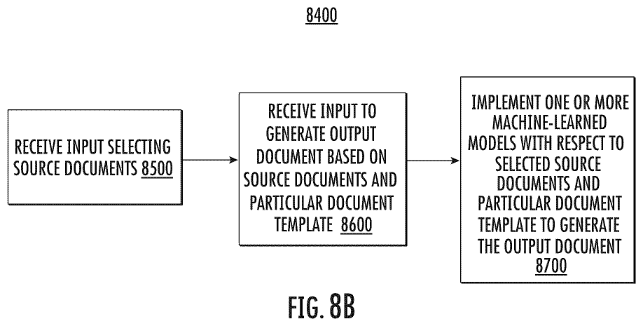

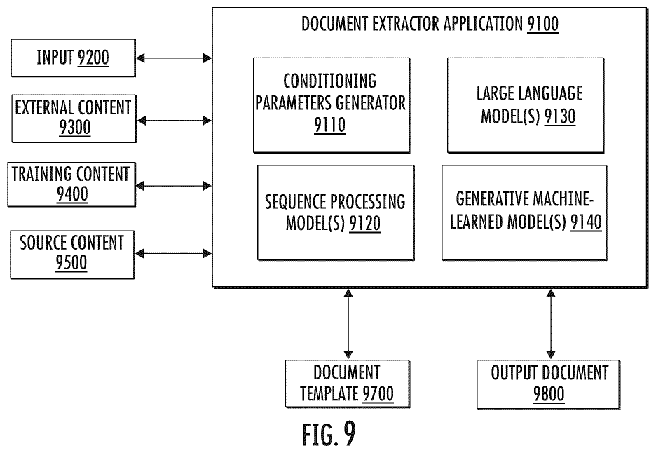

Examples of the disclosure are directed to computer implemented methods for generating a document template and for providing a user interface for organizing, managing, and creating content by implementing one or more machine-learned models with respect to source content selected by a user and the generated document template. FIG. 8A illustrates a flow diagram of an example, non-limiting computer-implemented method, according to one or more example embodiments of the disclosure. FIG. 8B illustrates another flow diagram of an example, non-limiting computer-implemented method, according to one or more example embodiments of the disclosure. FIG. 9 illustrates a block diagram of a document extractor application, according to one or more example embodiments of the disclosure.

The flow diagram of FIG. 8A illustrates a method 8000 for generating a document template that can be used for organizing, managing, and creating content by implementing one or more machine-learned models with respect to training content (e.g., sample documents, training documents, etc.) selected by a user. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 8A, at operation 8100 the method 8000 includes a computing device receiving an input from a user relating to the selection of sample documents (e.g., training content, training documents, etc.). As described herein, the computing device may be embodied as computing device 100, server computing system 300, or combinations thereof. For example, the input may be provided by the user via input device 150. For example, the input may be provided by selecting particular files or documents which are uploaded to the computing device for use by the document extractor application 136. In some implementations, the content can be uploaded from a local memory, from another application (e.g., a portable document file application), from copied text, or from a website. The selected files, text, documents, etc. may be referred to as training content, training documents, sample documents, etc. In some implementations, the training content may be a subset of a larger corpus of content. The input may be provided or input to document extractor application 136 or document extractor application 336, for example.

In some implementations, a response to the input selecting the source content may be processed at computing device 100 without involving the server computing system 300. In some implementations, the input selecting the training content may be transmitted from computing device 100 to server computing system 300 and at least part of the response to the input may be processed by the server computing system 300. For example, the input relating to the selection of the training content may be provided at the computing device 100 and the server computing system 300 may be configured to perform an operation in response to receiving an indication of the input.

At operation 8200 the method 8000 includes the computing device receiving an input from a user requesting that a document template be generated in relation to the selection of sample documents (e.g., training content, training documents, etc.). For example, the input may be provided by the user via input device 150. In some implementations, the computing device (e.g., document extractor application 136) may be configured to provide, for presentation on a display device, a graphical user interface by which a user can request the document template to be generated. For example, the input may be provided by selecting a user interface element that is associated with generating the document template. The input may be provided or input to document extractor application 136 or document extractor application 336, for example.

At operation 8300 the method 8000 includes the computing device implementing one or more machine-learned models with respect to the selected training content (sample documents, training documents, etc.) to generate a document template. In some implementations, the document template generated by the one or more machine-learned models may include a plurality of sections, a plurality of headings that indicate different sections of the document, etc. In some implementations, the document template may further be associated with a particular style, an intent, and/or a format that can be inferred or scraped from the content of the training content.

For example, the computing device can obtain information indicating that the user has selected the training content. The computing device can process the training content with one or more machine-learned models (e.g., one or more large language models) to obtain a language output. The computing device can then use the one or more machine-learned models (e.g., one or more large language models, one or more generative machine-learned models, etc.) to generate a summarization output. In particular, a machine-learned large language model can be trained to process a variety of outputs to generate a language output. For example, the machine-learned large language model can process an embedding generated by a machine-learned embedding generation model, portions of the training content identified using the embedding generation model, language outputs generated using the machine-learned large language model or some other model, etc.

In some implementations, the one or more machine-learned models may be configured to determine (learn) an intent, style, and/or format of the training content, for example, via various natural language processing operations. For example, the training content may be broken down into tokens (e.g., words, phrases, individual characters, etc.), and converted into an embedding (e.g., numerical vector representation) which can capture semantic information regarding the training content. In some implementations, each training document among the plurality of training documents may be classified as a particular type of document (e.g., a resume, PRD, outline, legal opinion, etc.). The training document can be classified based on an aggregation of token embeddings to create a representation for the entire training document (e.g., via an averaging of the embeddings, TF-IDF weighting, etc.). The one or more machine-learned models may be configured to analyze the vocabulary in the training documents (e.g., based on the frequency of certain words, the presence of specific terms, use of domain-specific jargon, etc.). The one or more machine-learned models may also be configured to determine a syntax of a training document (e.g., based on sentence structure, sentence length, use of grammatical constructs, etc.) which can provide information regarding a particular style and/or intent of the document. The one or more machine-learned models may be configured to analyze the training content to determine semantic information based on the meaning of the content (e.g., the meaning of particular sentences and paragraphs of a document), to identify a particular style and/or intent of the training document, etc. Further, the one or more machine-learned models may be configured to determine a context of each word in relation to the entire training document.

To determine (learn) a format of the training content, the one or more machine-learned models may be configured to analyze a sequential structure of the training content to identify recurring patterns (e.g., to recognize headers, subheadings, paragraphs, bullet points, numbered lists, and other common formatting elements). The one or more machine-learned models may also be configured to learn a document structure based on consistent patterns or layouts (e.g., tables, images, captions, etc.) to understand the spatial relationships between different elements. The one or more machine-learned models may also be configured to identify specific formatting conventions (e.g., the use of indentation, font styles, font sizes, etc.), to identify the document structure and perform pattern matching. The one or more machine-learned models may be configured to learn and recognize specific document formats such that when the user uploads a plurality of training documents a document template can be generated that conforms with the document structure of the training documents. In some implementations, the training content may share common features (e.g., a common format, a common style, a common intent, etc.).

In some implementations, the one or more machine-learned models may be configured to receive information from a user which identifies information about the training content (e.g., labeled data, such as an identification of the document type, the document style, the document intent, the document format, etc.). The one or more machine-learned models may be trained and/or refined based on the labeled data as well as by feedback provided via a user. The document template generated by the one or more machine-learned models (e.g., one or more large language models, one or more generative machine-learned models, etc.) at operation 8300 may be stored in the computing device and may be output for presentation on the display device 160 to the user.

The flow diagram of FIG. 8B illustrates a method 8400 for generating an output document based on the document template generated according to the flow diagram of FIG. 8A, by implementing one or more machine-learned models with respect to source content (e.g., source documents) selected by a user. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 8B, at operation 8500 the method 8400 includes a computing device receiving an input from a user relating to the selection of source documents (e.g., source documents). As described herein, the computing device may be embodied as computing device 100, server computing system 300, or combinations thereof. For example, the input may be provided by the user via input device 150. For example, the input may be provided by selecting particular files or documents which are uploaded to the computing device for use by the document extractor application 136. In some implementations, the content can be uploaded from a local memory, from another application (e.g., a portable document file application), from copied text, or from a website. The selected files, text, documents, etc. may be referred to as source content, source documents, etc. In some implementations, the source content may be a subset of a larger corpus of content. The input may be provided or input to document extractor application 136 or document extractor application 336, for example.

In some implementations, a response to the input selecting the source content may be processed at computing device 100 without involving the server computing system 300. In some implementations, the input selecting the source content may be transmitted from computing device 100 to server computing system 300 and at least part of the response to the input may be processed by the server computing system 300. For example, the input relating to the selection of the source content may be provided at the computing device 100 and the server computing system 300 may be configured to perform an operation in response to receiving an indication of the input (e.g., the generation of the output document).

At operation 8600 the method 8400 includes the computing device receiving an input from a user requesting that an output document be generated in relation to the selection of the source documents (e.g., source content) and a particular document template that can also be selected via a user input. For example, the inputs may be provided by the user via input device 150. In some implementations, the computing device (e.g., document extractor application 136) may be configured to provide, for presentation on a display device, a graphical user interface by which a user can request the output document be generated in association with a particular document template that can also be selected via a user input. For example, the inputs may be provided by selecting user interface elements that are associated with selecting a desired document template and generating the output document. In some implementations, an input may be provided to generate the output document and the document extractor application 136 or document extractor application 336 may be configured to determine an applicable document template that can be applied to the source documents for generating the output document. The inputs may be provided or input to document extractor application 136 or document extractor application 336, for example.

At operation 8700 the method 8400 includes the computing device implementing one or more machine-learned models (e.g., one or more large language models, one or more generative machine-learned models, etc.) with respect to the selected source documents (source content) and an identified document template, to generate the output document. In some implementations, the output document generated by the one or more machine-learned models may include a plurality of sections, a plurality of headings that indicate different sections of the document, etc., which are in conformance with the identified or selected document template. In some implementations, the output document may further be associated with a particular style, an intent, and/or a format that is based on the style, intent, and/or format of the document template.

For example, the computing device can obtain information indicating that the user has selected the source documents. The computing device can process the source documents with one or more machine-learned models (e.g., one or more large language models) to obtain a language output. The computing device can then use the one or more machine-learned models (e.g., one or more large language models, one or more generative machine-learned models, etc.) to generate a summarization output. In particular, a machine-learned large language model can be trained to process a variety of outputs to generate a language output. For example, the machine-learned large language model can process an embedding generated by a machine-learned embedding generation model, portions of the source documents identified using the embedding generation model, language outputs generated using the machine-learned large language model or some other model, etc.

In some implementations, the one or more machine-learned models may be configured to determine (learn) an intent, style, and/or format of the source documents, for example, via various natural language processing operations. For example, the source documents may be broken down into tokens (e.g., words, phrases, individual characters, etc.), and converted into an embedding (e.g., numerical vector representation) which can capture semantic information regarding the source documents. In some implementations, each source document among the plurality of source documents may be classified as a particular type of document (e.g., a resume, PRD, outline, legal opinion, etc.). The source document can be classified based on an aggregation of token embeddings to create a representation for the entire training document (e.g., via an averaging of the embeddings, TF-IDF weighting, etc.). The one or more machine-learned models may be configured to analyze the vocabulary in the source documents (e.g., based on the frequency of certain words, the presence of specific terms, use of domain-specific jargon, etc.). The one or more machine-learned models may also be configured to determine a syntax of a source document (e.g., based on sentence structure, sentence length, use of grammatical constructs, etc.) which can provide information regarding a particular style and/or intent of the source document. The one or more machine-learned models may be configured to analyze the source documents to determine semantic information based on the meaning of the content (e.g., the meaning of particular sentences and paragraphs of a document), to identify a particular style and/or intent of the source document, etc. Further, the one or more machine-learned models may be configured to determine a context of each word in relation to the entire source document.

The one or more machine-learned models (e.g., one or more large language models, one or more generative machine-learned models, etc.) may be configured to apply the document template to the plurality of source documents to generate the output document. For example, the one or more machine-learned models may be configured to extract first content (e.g., background information, title information, body information, conclusion information, etc.) from the plurality of source documents and associate the first content with a first section of the output document (e.g., a background section, a title section, a body section, a conclusion section, etc.). Likewise, the one or more machine-learned models may be configured to extract second content from the plurality of source documents and associate the second content with a second section of the output document, and so on. The one or more machine-learned models (e.g., one or more large language models, one or more generative machine-learned models, etc.) may be configured to associate content from the source documents with a particular section of the output document based on the determined semantic information, context information, intent information, etc., that is associated with that content. For example, if the one or more machine-learned models determines (e.g., based on a confidence level) that a certain portion of a source document is associated with background information regarding a certain topic or subject, the one or more machine-learned models may be configured to implement some or all of the certain portion in a background section of the output document.

For example, the one or more machine-learned models may be configured to apply the style, intent, and/or format of the document template to the content which is extracted from the plurality of source documents. For example, if the document template is associated with a persuasive intent and opinionated style, the one or more machine-learned models may be configured to generate the output document with such features based on the content from the plurality of source documents, where the output document may have a document structure that is defined by or associated with the document template.

As another example, the one or more machine-learned models may be configured to identify a document type associated with the plurality of source documents based on the content of each of the plurality of source documents. The one or more machine-learned models may be configured to apply the style, intent, and/or format of a document template which is associated with the identified document type. For example, if the one or more machine-learned models determines the document type associated with the source documents is a PRD, the one or more machine-learned models may be configured to apply the style, intent, and/or format of a document template which is associated with the PRD type to the content from the plurality of source documents.

In some implementations, the one or more machine-learned models may be configured to receive information from a user which identifies information about the output document and/or the source documents (e.g., labeled data, such as an identification of the document type, the document style, the document intent, the document format, etc.). The one or more machine-learned models for generating the output document may be trained and/or refined based on the labeled data as well as by feedback provided via a user. For example, the output document generated at operation 8700 may be stored in the computing device and may be output for presentation on the display device 160 to the user.

Referring to FIG. 9, the document extractor application 9100 (which may correspond to document extractor application 136 and/or document extractor application 336) may include a conditioning parameters generator 9110, one or more sequence processing models 9120, one or more large language models 9130, and one or more generative machine-learned models 9140. The document extractor application 9100 may receive an input 9200 from a user as discussed above with respect to operations 8100, 8200, 8500, 8600 of FIGS. 8A and 8B. Conditioning parameters generator 9110 may be configured to generate conditioning parameters based at least in part on the input, wherein the conditioning parameters provide values for one or more conditions associated with content to be generated which relates at least in part to the input 9200 and training content 9400 and/or source content 9500 selected by the user.

For example, the training content 9400 and source content 9500 can include any kind of document (e.g., in digital form) and may include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, the training content 9400 and source content 9500 may be stored in the content data store 350 by the user selecting certain documents, images, or other content to store in the content data store 350. In some implementations, the training content 9400 and source content 9500 may be stored at the computing device 100 and/or server computing system 300.

To generate the conditioning parameters, the conditioning parameters generator 9110 may be configured to retrieve values for the one or more conditions associated with the input. For example, to generate the conditioning parameters, the conditioning parameters generator 9110 may be configured to extract the values for the one or more conditions from the input. The input may include information indicative of the user's intent or requirements. In some implementations, the conditioning parameters generator 9110 (or the one or more sequence processing models 9120 or the one or more large language models 9130) may be configured to extract information from the input 9200 to identify values for the one or more conditions, and the conditioning parameters generator 9110 may be configured to generate the conditioning parameters based on the extracted values. For example, the input itself may identify a color to be used for headings in a generated document (e.g., “blue font for the title”) or an attribute or feature (e.g., “circle bullet points”) that can be used to generate the conditioning parameters for generating a document template related to the training content 9400 or for generating an output document related to the source content 9500.

To generate the conditioning parameters, the conditioning parameters generator 9110 may be configured to infer the values for the one or more conditions from the input. The input may include information indicative of the user's intent or requirements. In some implementations, the conditioning parameters generator 9110 (or the one or more sequence processing models 9120 or the one or more large language models 9130) may be configured to infer information from the input 9200 to identify values for the one or more conditions, and the conditioning parameters generator 9110 may be configured to generate the conditioning parameters based on the inferred values. For example, the input may include a reference to a length (“short,” “long,” etc.) of the output document to be generated based on the source content 9500, and the conditioning parameters generator 9110 (or the one or more sequence processing models 9120 or the one or more large language models 9130) may be configured to infer a value based on the input. For example, an input requesting the document extractor application 9100 to generate a “standard” resume may infer a value of about 1 page while a “long” resume may be associated with a value of about 2 to 3 pages. For example, the document extractor application 9100 may be configured to ascertain an inferred value based on information via external content 9300 (e.g., a website which describes lengths of resumes).

In some implementations, the conditioning parameters generator 9110 may be configured to infer the values for the one or more conditions from the input by providing the input to one or more sequence processing models 9120, wherein the one or more sequence processing models 9120 are configured to output the values for the one or more conditions in response to or based on the query. The one or more sequence processing models 9120 may include one or more machine-learned models which are configured to process and analyze sequential data and to handle data that occurs in a specific order or sequence, including time series data, natural language text, or any other data with a temporal or sequential structure.

The one or more sequence processing models 9120 may receive an input including text and tokenize the input by breaking down the sequence of text into small units (tokens) to provide a structured representation of the input sequence. The one or more sequence processing models 9120 may represent the tokens as vectors in a continuous vector space by mapping each token to a high-dimensional vector, where the relationships between tokens (words) are reflected in the geometric relationships between their corresponding vector. For example, the one or more sequence processing models 9120 may receive an input extracted from the training content 9400 and/or source content 9500 including the text “the bustling marketplace” and tokenize the input by breaking down the sequence of text into small units (tokens) (e.g., “the,” “bustling,” and “marketplace”), thereby providing a structured representation of the input sequence. In a word embedding, semantically similar words are closer together in the vector space. For example, the vectors for “bustling” and “busy” might be close to each other because of their semantic relationship, while the vectors for “bustling” and “stagnant” may be far apart compared to the vectors for “bustling” and “stagnant”.

The one or more large language models 9130 can be, or otherwise include, a model that has been trained on a large corpus of language training data in a manner that provides the one or more large language models 9130 with the capability to perform multiple language tasks. For example, the one or more large language models 9130 can be trained to perform summarization tasks, conversational tasks, simplification tasks, oppositional viewpoint tasks, etc. In particular, the one or more large language models 9130 can be trained to process a variety of outputs to generate a language output. For example, the one or more large language models 9130 can process an embedding generated by a machine-learned embedding generation model, portions of source content or training content (e.g., document chunk(s)) identified using an embedding generation model, language outputs generated using the one or more large language models 9130 or some other model, etc.

The one or more generative machine-learned models 9140 may include a deep neural network or a generative adversarial network (GAN), variational autoencoders, stable diffusion machine-learned models, visual transformers, neural radiance fields (NeRFs), etc., to generate content (e.g., a resume, an outline, a PRD, etc.) with values for conditions associated with one or more features. For example, the computing device may include a database (e.g., machine-learned model data store 370) which is configured to store a plurality of generative machine-learned models respectively associated with a plurality of different types of content or a plurality of different types of documents (e.g., different genres or subjects, different kinds of content including imagery, videos, and text, different types of content including outlines, reports, spreadsheets, resumes, PRDs, etc.).

In some implementations, the computing device may be configured to retrieve, from among the one or more generative machine-learned models 9140, a generative machine-learned model associated with a particular type of content (document) and/or document template, for generating the output document, relating to the input. In some implementations, the computing device may be configured to retrieve, from among the one or more generative machine-learned models 9140, a generative machine-learned model associated with a particular type of content (document) for generating a particular type of document template, relating to the input.

In some implementations, the one or more generative machine-learned models 9140 may be trained on a large dataset of content (e.g., a large corpus of language training data) with corresponding information about the conditions associated with the content. During training, the one or more generative machine-learned models 9140 may be configured to learn relationships between elements in an output (e.g., content) and conditions that influence them. This may involve the computing device adjusting each generative machine-learned model's internal parameters to generate realistic or accurate content (e.g., grammatically correct content, coherent content, etc.) based on the training data. The one or more generative machine-learned models 9140 may be trained on one or more training datasets including a plurality of reference document templates. The one or more generative machine-learned models 9140 may be trained on one or more training datasets including a plurality of reference output documents that are associated with one or more document templates. The one or more training datasets may include values for the one or more conditions.

In some implementations, the one or more generative machine-learned models 9140 are configured to generate the document template 9700 in response to receiving the selection of the training content 9400. For example, the document template 9700 may be generated based on the conditioning parameters (and corresponding values for the one or more conditions) to make decisions for generating the content of the document template 9700. In some implementations, the one or more generative machine-learned models 9140 are configured to generate the output document 9800 in response to receiving the selection of the source content 9500 and based on a particular document template 9700 which may be selected by the user or may be automatically determined based on the source content 9500. For example, the output document 9800 may be generated based on the conditioning parameters (and corresponding values for the one or more conditions) to make decisions for generating the content of the output document 9800.

In some implementations, the server computing system 300 may provide (transmit) content or a portion of the generated content to computing device 100 or the server computing system 300 may provide access to the generated content to the computing device 100. For example, the document template 9700 and/or the output document 9800 may be generated at the server computing system 300 and stored at one or more computing devices (e.g., one or more of computing device 100, external computing device 200, server computing system 300, external content 500, content data store 350, user data store 360, etc.).

In some implementations, after the document template 9700 is generated, the user can provide feedback or a further input relating to the document template 9700 which is generated based on the training content 9400 provided (and/or based on a query provided via the user), and one or more of the operations 8100 through 8300 can be repeated. In some implementations, after the output document 9800 is generated, the user can provide feedback or a further input relating to the output document 9800 which is generated based on the source content 9500 provided (and/or based on a query provided via the user), and one or more of the operations 8500 through 8700 can be repeated.

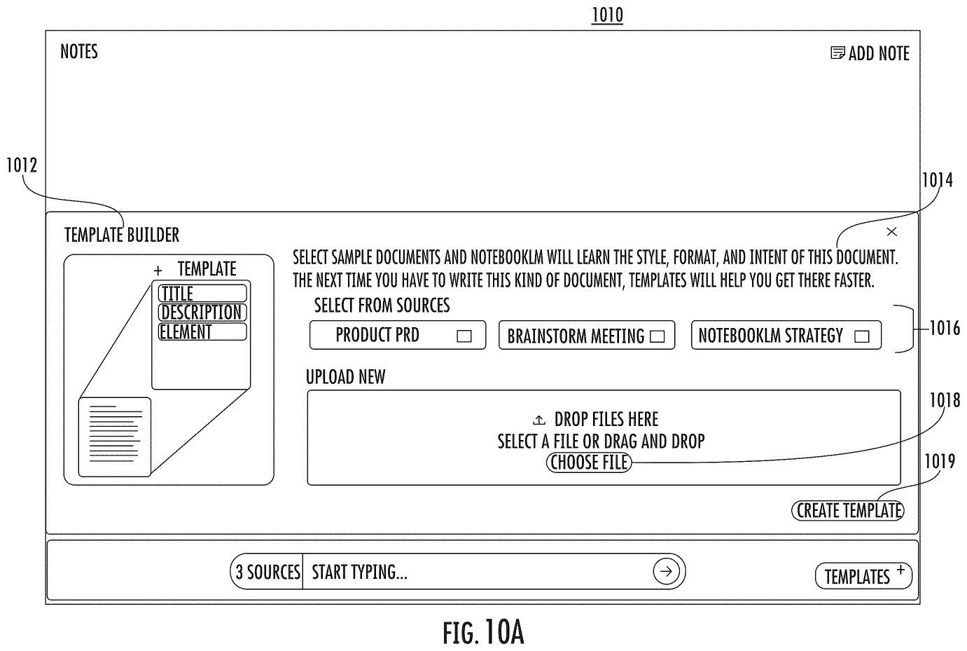

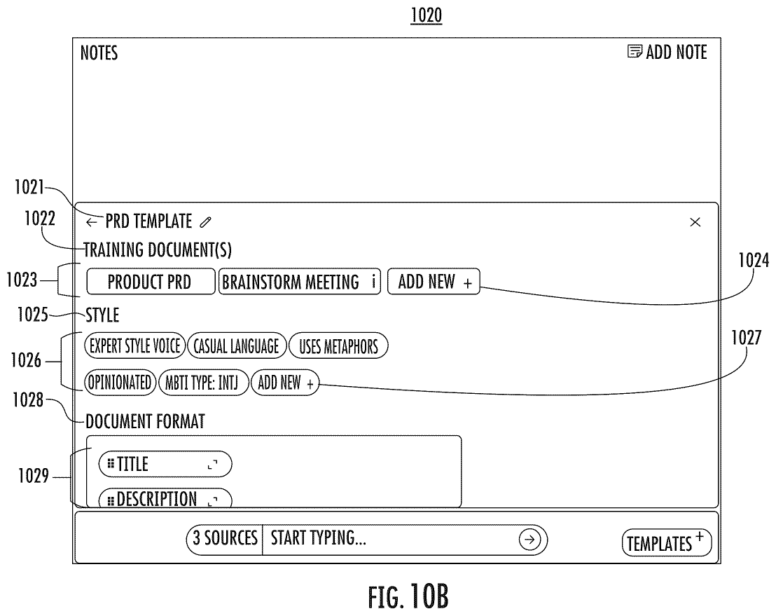

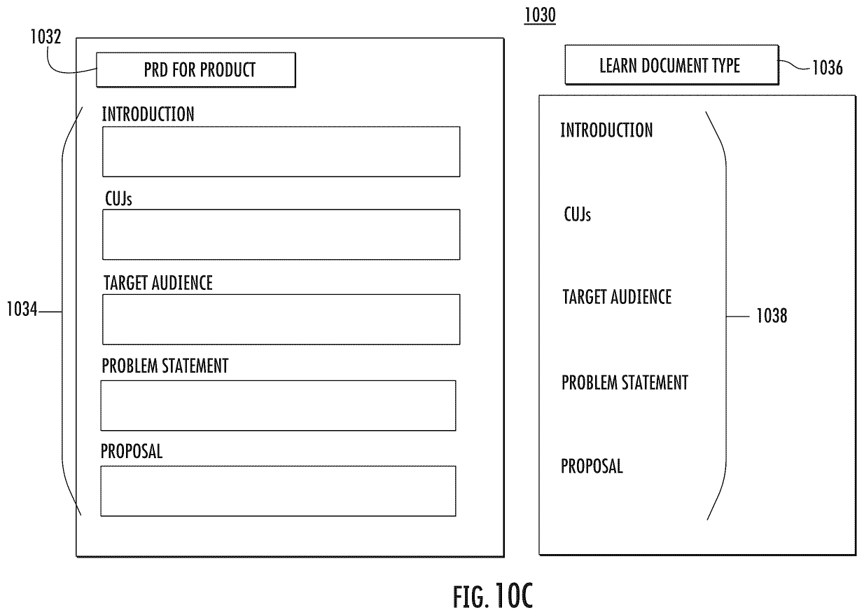

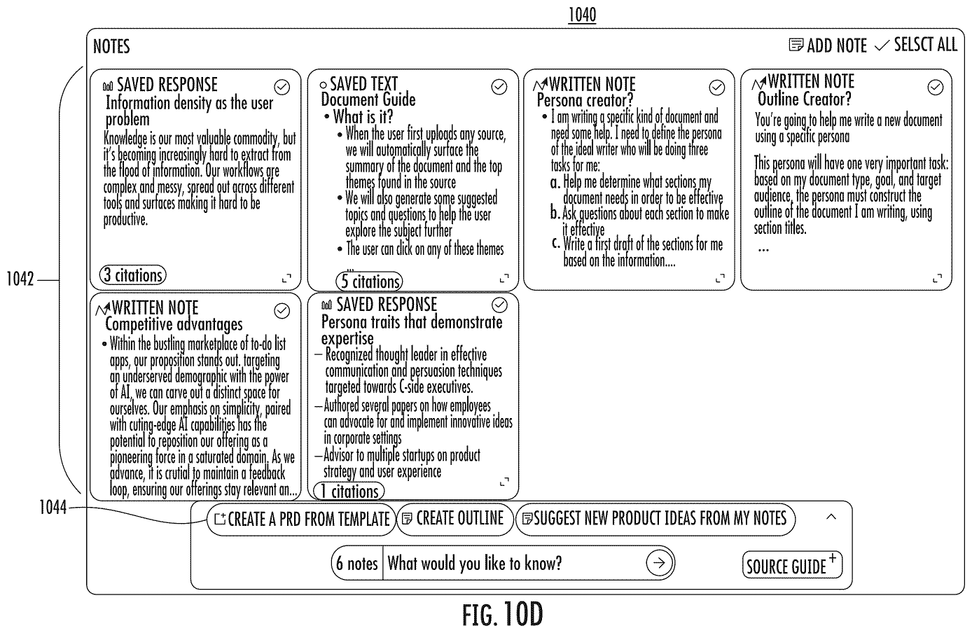

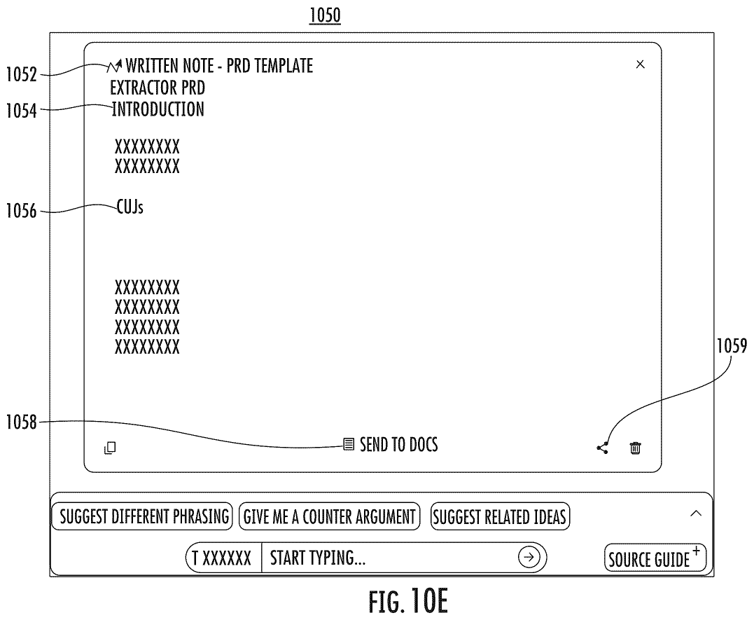

Examples of the disclosure are also directed to user-facing aspects by which a user can manage content, organize content, create content, etc., via a notebook application and/or document extractor application which are each configured to implement one or more machine-learned models with respect to content selected by the user. For example, FIGS. 10A through 10F illustrate examples of actions which can be implemented for a project in which a document template is generated via one or more machine-learned models based on training content selected by a user, and in which an output document is generated via one or more machine-learned models based on source content selected by the user, according to one or more example embodiments of the disclosure.

For example, FIG. 10A illustrates a first user interface screen (e.g., a template builder user interface screen) of a document extractor application (which may be incorporated as part of a notebook application), according to one or more example embodiments of the disclosure.

In FIG. 10A, the first user interface screen 1010 depicts a user interface (e.g., a template builder user interface screen) which provides information about the document extractor application 9100. In particular, document extractor application 9100 is configured to present for display the first user interface screen 1010 which includes a visual depiction 1012 regarding how a document template can be created and structured based on training content and information 1014 regarding features about the document extractor application 9100.

As illustrated in FIG. 10A, the first user interface screen 1010 further includes a plurality of user interface elements which are selectable (or can be interacted with) by the user for generating a document template. For example, a first portion of the first user interface screen 1010 includes a plurality of first user interface elements 1016 are configured to be selectable as training content for creating a document template. In FIG. 10A, the training content which can be selected by the user for generating a document template includes a PRD file (“Product PRD”), notes from a meeting (“Brainstorm meeting”), and a note regarding strategy (“Notebook LLM Strategy”).

For example, a second portion of the first user interface screen 1010 includes a second user interface element 1018 which is configured to enable a user to upload one or more training documents for generating a document template. As illustrated in FIG. 10A, a third user interface element 1019 is configured to receive an input associated with creating (generating) a document template, based on the training content (e.g., training documents) identified (selected) by the user via the first user interface screen 1010. For example, the document extractor application 9100 may be configured to generate the document template according to the examples described herein based on the training content selected by the user and in response to the user input (e.g., selecting the third user interface element 1019).

FIG. 10B illustrates a second user interface screen (e.g., a document template customization user interface screen) of a document extractor application (which may be incorporated as part of a notebook application), according to one or more example embodiments of the disclosure.

In FIG. 10B, the second user interface screen 1020 depicts a user interface (e.g., a template builder user interface screen) which is associated with enabling a user to customize one or more features associated with the document template generated by the document extractor application 9100. In particular, document extractor application 9100 is configured to present for display the second user interface screen 1020 which includes various portions and user interface elements by which the user can modify or customize a document template generated by the document extractor application 9100.

For example, the second user interface screen 1020 includes a first portion 1021 which identifies the name of the generated document template (“PRD template”).

For example, the second user interface screen 1020 includes a second portion 1022 which is associated with the training documents that were selected for generating the document template. For example, training documents 1023 include the “Product PRD” training document and the “Brainstorm meeting” document. A first user interface element 1024 may be configured to enable a user to add training documents so that the document template can be re-generated based on the added training documents.

For example, the second user interface screen 1020 includes a third portion 1025 which is associated with a style of the generated document template. For example, the third portion 1025 of the second user interface screen 1020 includes a plurality of first user interface elements 1026 which are associated with different possible styles that can be selected for generating (or re-generating) the document template. In FIG. 10B, example styles which can be selected include an “Expert style voice”, “Casual language”, “Uses metaphors”, “Opinionated”, and “MBT Type: INTJ”. A second user interface element 1027 may be configured to enable a user to add a new style so that the document template can be re-generated based on the added style(s).

For example, the second user interface screen 1020 includes a fourth portion 1028 which is associated with a document format of the generated document template. For example, the fourth portion 1028 of the second user interface screen 1020 includes a plurality of second user interface elements 1029 which are associated with different sections of a document structure that can be selected and modified for generating (or re-generating) the document template. In FIG. 10B, example document sections which are visible in the drawing and which can be selected include a “Title” section and a “Description” section. Other document sections may include a “Background” section and a “Conclusion” section, for example. Each of the plurality of second user interface elements 1029 may be configured to be manipulated by a user such that the different sections can be rearranged according to a user input, so that the document template can be re-generated based on the rearranged document structure (format).

Though not shown in FIG. 10B, the second user interface screen 1020 can also include a further portion which is associated with an intent of the generated document template. For example, the further portion of the second user interface screen 1020 can include a plurality of user interface elements which are associated with different possible intents that can be selected for generating (or re-generating) the document template. Example intent which can be selected include a “Persuasive” intent, an “Informative” intent, an “Entertain” intent, an “Inspire” intent, and the like.

FIG. 10C illustrates a visual depiction of how the document extractor application (which may be incorporated as part of a notebook application) can learn a format, style, and/or intent of a training document, according to one or more example embodiments of the disclosure. As illustrated in FIG. 10C, a training document 1032 (“PRD for Product”) includes a plurality of sections 1034 for a PRD, including an introduction section, critical user journey (CUJ) section, target audience section, problem statement section, and a proposal section. The document extractor application 9100 may be configured to learn the document type of the training document 10323 via selection of a user interface element 1036. As shown in FIG. 10C, the learned document sections 1038 for a PRD include the same sections as the training document 1032. The document extractor application 9100 may be configured to generate a PRD in response to a user uploading source documents, where the generated PRD may have the format shown in FIG. 10C or a similar format, based on the learned document type information which is obtained from the training document 1032.

For example, FIG. 10D illustrates a fourth user interface screen (e.g., an output document generation user interface screen) of a document extractor application (which may be incorporated as part of a notebook application), according to one or more example embodiments of the disclosure.

In FIG. 10D, the fourth user interface screen 1040 depicts a user interface (e.g., an output document generation user interface screen) which enables a user to create (generate) an output document based on one or more source documents which can be selected by a user, according to a document template that can also be selected or provided to the user, for example, based on the content of the source documents. For example, in FIG. 10D, the user has selected a plurality of source documents 1042 (which may correspond to notes that are added to the scratchpad or notes section in the notebook application 3100).

In some implementations, the user may identify or select a particular document template and provide an input that causes the document extractor application 9100 to generate an output document based on the selected source documents and the selected document template. In some implementations, the document extractor application 9100 may be configured to analyze the content of the selected source documents and determine or suggest one or more document templates which may be appropriate or applicable to the source documents.

For example, in FIG. 10D, the fourth user interface screen 1040 includes a first user interface element 1044 which is configured to, when selected, create or generate a PRD based on the document template that is previously generated and associated with PRDs.

For example, FIG. 10E illustrates a fifth user interface screen (e.g., an output document user interface screen) of a document extractor application (which may be incorporated as part of a notebook application), according to one or more example embodiments of the disclosure.

In FIG. 10E, the fifth user interface screen 1050 depicts a user interface (e.g., an output document user interface screen) which includes the output document generated by the document extractor application 9100 according to the selected source documents and the document template (e.g., the PRD template). For example, the output document may correspond to a note 1052 for the notebook application 3100. As illustrated in FIG. 10E, the output document may have a document structure or format that is consistent with a format of a PRD, and may include similar sections such as an introduction section 1054 and a CUJs section 1056. The document extractor application 9100 may be configured to generate content for each section based on the content of the source documents, via one or more machine-learned models, as described according to the examples provided herein. For example, the output document may be stored in the computing device, may be transmitted to another computing device, may be saved as a particular document file type in another document application (e.g., via first user interface element 1058), may be shared with another user (e.g., via second user interface element 1059), etc.

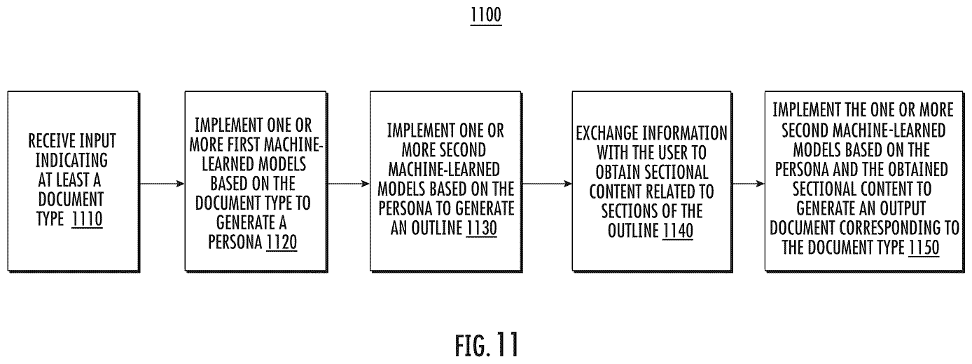

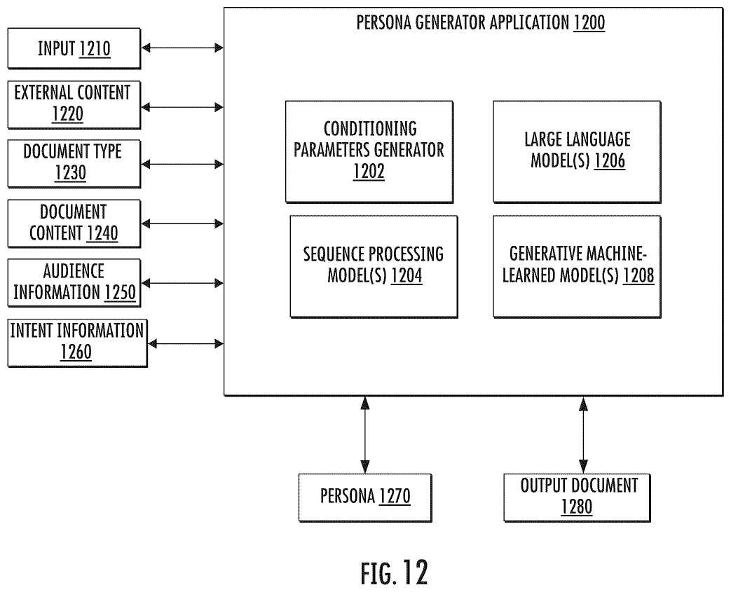

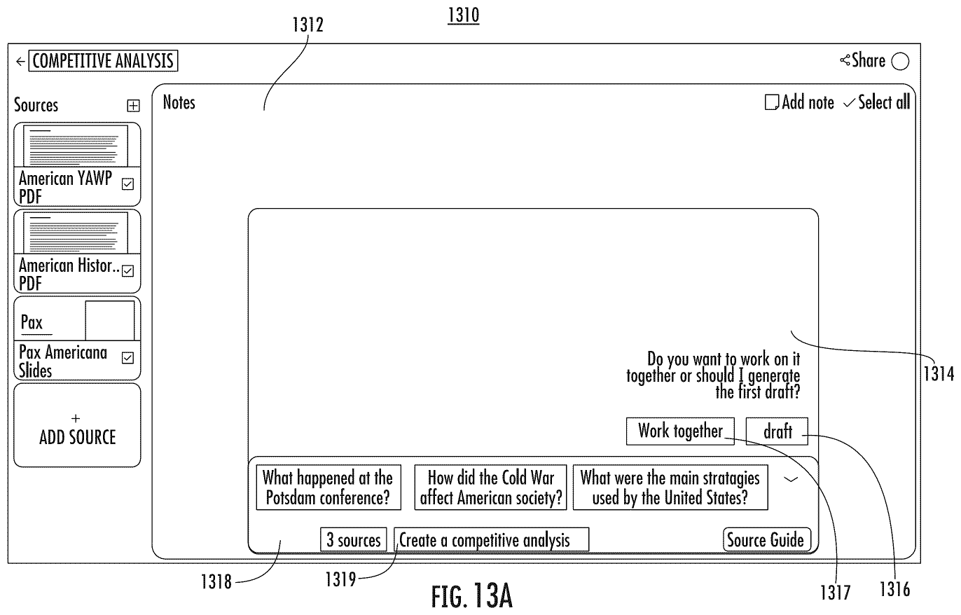

Examples of the disclosure are directed to computer implemented methods for generating a persona template and for providing a user interface for organizing, managing, and creating content by implementing one or more machine-learned models with respect to the generated persona. FIG. 11 illustrates a flow diagram of an example, non-limiting computer-implemented method, according to one or more example embodiments of the disclosure. FIG. 12 illustrates a block diagram of a persona generator application, according to one or more example embodiments of the disclosure.

The flow diagram of FIG. 11 illustrates a method 1100 for generating a persona and for generating an output document utilizing the persona that can be used for organizing, managing, and creating content by implementing one or more machine-learned models. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 11, at operation 1110 the method 1100 includes a computing device receiving an input from a user indicating at least a document type. As described herein, the computing device may be embodied as computing device 100, server computing system 300, or combinations thereof. For example, the input may be provided by the user via input device 150. For example, the input may be provided by the user indicating a particular document type (e.g., via a voice input, the selection of a user interface element, etc.). For example, the input may be provided by the user indicating a particular document type (e.g., via a voice input, the selection of a user interface element, etc.). For example, the input may indicate the user wants to generate a resume, a PRD, a competitive analysis, etc. In some implementations, the input may also indicate additional information. For example, the input may further indicate an intent or goal with respect to the document, a target audience with respect to the document, a topic of the document, etc. For example, the user may indicate an intent or goal (e.g., “I want to convince my executive leadership team to let me spend 30 days building a prototype for a to-do list app that I can then test with consumers”). For example, the user may indicate an audience (e.g., “My team leads, primarily execs. Maybe some teammates”). For example, the user may indicate a topic of the document (e.g., “building a prototype for a to-do list app that I can test with consumers”).

At operation 1120 the method 1100 includes a computing device implementing one or more first machine-learned models based on the document type to generate a persona. The one or more first machine-learned models (e.g., one or more LLMs, one or more generative models, etc.) may be configured to generate the persona based on the one or more inputs received at operation 1110 which can be provided to the one or more first machine-learned models. The one or more first machine-learned models may be configured to generate the persona for use as an input at operation 1130 to one or more second machine-learned models (e.g., one or more LLMs, one or more generative models, etc.) that can be implemented by the one or more second machine-learned models when generating an output at operation 1150 (e.g., output content, output document, etc.). For example, the persona generated by the one or more first machine-learned models may be based on a document type, a target audience, an intent or goal of the user, a topic of the document, and/or other characteristics of the desired content.

For example, based on the information received from the user, the one or more first machine-learned models may be configured to take on the persona (e.g., a persona of “Dr. Jane Smith”) having particular characteristics including one or more of a particular background, expertise, public stature, hobbies, interests, personality, cognitive traits, strengths that are suited for executing the task associated with generating an output document, which comport with the information provided by the user (e.g., the user's indicated intent or goal, which are appropriate given the indicated audience, etc.). In particular, the user need not identify a particular persona or characteristics of the persona as the one or more first machine-learned models are configured to identify or determine the optimal or appropriate persona based on information such as a document type, user intent or goals, target audience, etc. Thus, the user need not ask the computing device to draft a document in a manner as written by “John Doe” or from the perspective of a particular role. That is, the user does not request a particular persona via the input, but merely requests a desire to generate an output document based on other information. Accordingly, the one or more first machine-learned models can achieve a technical effect in that reduced interactions and reduced inferences can be realized by the one or more first machine-learned models generating a persona which is appropriate for the document to be generated. Further, the persona can be generated with reduced interactions (e.g., with only a single interaction) which also conserves computing resources. Further, in some implementations, the identity of the persona and/or the characteristics of the persona, may be hidden from the user.

At operation 1130, the method 1100 may include a computing device implementing one or more second machine-learned models based on the persona to generate an output document (e.g., an outline). For example, the computing device may be configured to implement the one or more second machine-learned models to generate the outline associated with an output document (e.g., a PRD, a resume, a competitive analysis, etc.). For example, the one or more second machine-learned models may be configured to generate particular sections forming the outline. For example, the form of the outline and/or particular sections may be based on the document type, goal, target audience, etc.

At operation 1140 the method 1100 may include the computing device implementing one or more second machine-learned models to exchange information with the user (e.g., via one or more chat or dialogue operations) to obtain sectional content related to each of the sections of the outline. For example, the computing device may be configured to draft the output document according to the content obtained from the user for the sections of the outline. In some implementations, the exchange of information may be in a question and answer format (e.g., in the form of an interview). In some implementations, if the user does not know the answer to a question provided by the computing device, the computing device may be configured to allow the user to skip the question. Thus, the outline and content provided therein for the sections may not necessarily be entirely complete. However, the computing device (e.g., the one or more second machine-learned models) may be configured to draft the output document utilizing the persona even if all information is not supplied from the user in response to the questions posed to the user by the computing device.

In some implementations, the computing device may be configured to query the user sequentially, section by section. In some implementations, the computing device may be configured to query the user in an open-ended manner and fill in appropriate sections based on the content provided by the user. In some implementations, the computing device (e.g., the one or more second machine-learned models) may be configured to skip some sections, for example, according to the persona. In some implementations, whether a section is sufficiently covered by the user may be determined based on the judgment of the persona implemented by the one or more second machine-learned models. In some implementations, the computing device may be configured to allow the user to confirm the accuracy of the content that is provided to each section of the outline. In some implementations, the computing device may be configured to allow the user to supplement or correct the content that is provided to each section of the outline. In some implementations, when the outline is complete (or when the one or more second machine-learned models determine to conclude the information exchange with the user) and the one or more sections are filled out (e.g., when the information is provided by the user relating to the one or more sections), the computing device may be configured to store the outline, for example as a note and/or as another document type.

At operation 1150 the method 1100 includes the computing device implementing the one or more second machine-learned models to generate an output document based on (utilizing) the persona and based on the obtained sectional content. In some implementations, based on the content of the outline, the one or more second machine-learned models may be configured to generate the output document (e.g., the PRD). The computing device may be configured to store the output document, for example as a note and/or as another document type.

As another example implementation, the input received at operation 1110 may include a source document. For example, the source document may correspond to a first draft of a document. At operation 1120, the one or more first machine-learned models may be configured to generate the persona based on the source document (e.g., based on the content of the source document). In this example implementation, the method 1100 may omit operations 1130 and 1140 to generate the output document at operation 1150 (e.g., a second draft of the document) utilizing the persona and based on the source document. In some implementations, the method 1100 may include operations 1130 and 1140 to generate the outline based on the persona and source document, and to obtain further information relating to sections of the outline, before generating the output document at operation 1150 (e.g., the second draft of the document) utilizing the persona and based on the source document and the further information obtained at operation 1140.

In some implementations, a response to the input at operation 1110 may be processed at computing device 100 without involving the server computing system 300. In some implementations, the input may be transmitted from computing device 100 to server computing system 300 and at least part of the response to the input may be processed by the server computing system 300. For example, the input relating to the document type may be provided at the computing device 100 and the server computing system 300 may be configured to perform an operation (e.g., generating the persona) in response to receiving the input.

In some implementations, the computing device may be configured to provide, for presentation on a display device, a graphical user interface by which a user can request the output document to be generated. For example, the input may be provided by selecting a user interface element that is associated with generating the output document. The input may be provided or input to the persona generator application 138, or notebook application 132, for example.

For example, the computing device can process the input data (e.g., the indicated document type, intent or goal, topic, target audience, source document, etc.) with the one or more first machine-learned models to obtain a language output. The computing device can then use the one or more first machine-learned models to generate a summarization output. In particular, a machine-learned large language model can be trained to process a variety of outputs to generate a language output. For example, the machine-learned large language model can process an embedding generated by a machine-learned embedding generation model, portions of the input data identified using the embedding generation model, language outputs generated using the machine-learned large language model or some other model, etc.

In some implementations, the one or more first machine-learned models may be configured to determine (learn) an intent, style, and/or format of the input data, for example, via various natural language processing operations, which can be utilized for generating the persona. For example, the input data may be broken down into tokens (e.g., words, phrases, individual characters, etc.), and converted into an embedding (e.g., numerical vector representation) which can capture semantic information regarding the input data. In some implementations, a source document may be classified as a particular type of document (e.g., a resume, PRD, competitive analysis, legal opinion, etc.). The source document can be classified based on an aggregation of token embeddings to create a representation for the entire source document (e.g., via an averaging of the embeddings, TF-IDF weighting, etc.). The one or more first machine-learned models may be configured to analyze the vocabulary in the source document (e.g., based on the frequency of certain words, the presence of specific terms, use of domain-specific jargon, etc.). The one or more first machine-learned models may also be configured to determine a syntax of a source document (e.g., based on sentence structure, sentence length, use of grammatical constructs, etc.) which can provide information regarding a particular style and/or intent of the source document. The one or more first machine-learned models may be configured to analyze the input data to determine semantic information based on the meaning of the content (e.g., the meaning of particular sentences and paragraphs of an input), to identify a particular style and/or intent associated with the input. Further, the one or more first machine-learned models may be configured to determine a context of each word in relation to the entire input.

In some implementations, the one or more first machine-learned models may be configured to receive information from a user which identifies information about the source document (e.g., labeled data, such as an identification of the document type, the document style, the document intent, the document format, etc.), which can be utilized for generating the persona. The one or more first machine-learned models may be trained and/or refined based on the labeled data as well as by feedback provided via a user.

The one or more second machine-learned models may also be configured to determine (learn) an intent, style, and/or format of the input data, for example, via various natural language processing operations, which can be utilized for generating the output document while utilizing the persona. For example, the one or more second machine-learned models may be configured to apply the persona to the generated outline and sectional content, as well as any other information provided by the user (e.g., a document type, style, intent, topic, target audience, source document, etc.). For example, if the one or more machine-learned models determines the document type is a PRD based on the input, the one or more first machine-learned models may be configured to generate the persona, and the one or more second machine-learned models may be configured to apply the persona (as well as any additional information) to generate the PRD output document. For example, the output document generated at operation 1150 may be stored in the computing device and may be output for presentation on the display device 160 to the user.

Referring to FIG. 12, the persona generator application 1200 (which may correspond to persona generator application 138 and/or persona generator application 338) may include a conditioning parameters generator 1202, one or more sequence processing models 1204, one or more large language models 1206, and one or more generative machine-learned models 1208. The persona generator application 1200 may receive an input 1210 from a user as discussed above with respect to operations 1110 and 1140 of FIG. 11. Conditioning parameters generator 1202 may be configured to generate conditioning parameters based at least in part on the input, wherein the conditioning parameters provide values for one or more conditions associated with content to be generated which relates at least in part to the input 1210. In some implementations, the persona generator application 1200 may receive information including one or more of a document type 1230, audience information 1250, intent information 1260, etc. The document type 1230, audience information 1250, and intent information 1260 may be part of the input 1210. In some implementations, the persona generator application 1200 may receive document content 1240 which is part of a source document (e.g., a first draft of the document), that can be used to generate a persona and/or an output document.

For example, the document content 1240 can include any kind of document (e.g., in digital form) and may include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, the document content 1240 may be stored in the content data store 350 by the user selecting certain documents, images, or other content to store in the content data store 350. In some implementations, the document content 1240 may be stored at the computing device 100 and/or server computing system 300.

To generate the conditioning parameters, the conditioning parameters generator 1202 may be configured to retrieve values for the one or more conditions associated with the input. For example, to generate the conditioning parameters, the conditioning parameters generator 1202 may be configured to extract the values for the one or more conditions from the input. The input may include information indicative of the user's intent or requirements. In some implementations, the conditioning parameters generator 1202 (or the one or more sequence processing models 1204 or the one or more large language models 1206) may be configured to extract information from the input 1210 to identify values for the one or more conditions, and the conditioning parameters generator 1202 may be configured to generate the conditioning parameters based on the extracted values. For example, the input itself may identify a document type to be used for generating a persona (e.g., “a competitive analysis”) or an attribute or feature for generating the persona (e.g., “convince my executive leadership team”) that can be used to generate the conditioning parameters for generating the persona 1270 related to the input information or for generating an output document 1280 related to the input information while utilizing the generated persona 1270.

To generate the conditioning parameters, the conditioning parameters generator 1202 may be configured to infer the values for the one or more conditions from the input. The input may include information indicative of the user's intent or requirements. In some implementations, the conditioning parameters generator 1202 (or the one or more sequence processing models 1204 or the one or more large language models 1206) may be configured to infer information from the input 1210 to identify values for the one or more conditions, and the conditioning parameters generator 1202 may be configured to generate the conditioning parameters based on the inferred values. For example, the input may include a reference to a document type characteristic (“PRD”, etc.) of the output document to be generated based on the document type 1230, and the conditioning parameters generator 1202 (or the one or more sequence processing models 1204 or the one or more large language models 1206) may be configured to infer a value based on the input. For example, an input requesting the persona generator application 1200 to generate an output document may infer that the input “PRD” corresponds to a product requirements document. For example, the persona generator application 1200 may be configured to ascertain an inferred value based on information via external content 1220 (e.g., a website which describes values for acronyms).

In some implementations, the conditioning parameters generator 1202 may be configured to infer the values for the one or more conditions from the input by providing the input to one or more sequence processing models 1204, wherein the one or more sequence processing models 1204 are configured to output the values for the one or more conditions in response to or based on the query. The one or more sequence processing models 1204 may include one or more machine-learned models which are configured to process and analyze sequential data and to handle data that occurs in a specific order or sequence, including time series data, natural language text, or any other data with a temporal or sequential structure.

The one or more sequence processing models 1204 may receive an input including text and tokenize the input by breaking down the sequence of text into small units (tokens) to provide a structured representation of the input sequence. The one or more sequence processing models 1204 may represent the tokens as vectors in a continuous vector space by mapping each token to a high-dimensional vector, where the relationships between tokens (words) are reflected in the geometric relationships between their corresponding vector. For example, the one or more sequence processing models 1204 may receive an input extracted from the input information including text (e.g., “convince my executive leadership team” and tokenize the input by breaking down the sequence of text into small units (tokens) (e.g., “convince,” “my,” “executive,” “leadership,” and “team”), thereby providing a structured representation of the input sequence. In a word embedding, semantically similar words are closer together in the vector space. For example, the vectors for “executive” and “C-suite” might be close to each other because of their semantic relationship, while the vectors for “executive” and “assistant” may be far apart compared to the vectors for “executive” and “C-suite”.

The one or more large language models 1206 can be, or otherwise include, a model that has been trained on a large corpus of language training data in a manner that provides the one or more large language models 1206 with the capability to perform multiple language tasks. For example, the one or more large language models 1206 can be trained to perform summarization tasks, conversational tasks, simplification tasks, oppositional viewpoint tasks, etc. In particular, the one or more large language models 1206 can be trained to process a variety of outputs to generate a language output. For example, the one or more large language models 1206 can process an embedding generated by a machine-learned embedding generation model, portions of content (e.g., document chunk(s)) identified using an embedding generation model, language outputs generated using the one or more large language models 1206 or some other model, etc.

The one or more generative machine-learned models 1208 may include a deep neural network or a generative adversarial network (GAN), variational autoencoders, stable diffusion machine-learned models, visual transformers, neural radiance fields (NeRFs), etc., to generate a persona (e.g., an expert for generating the output document) and to generate content (e.g., an output document including a resume, an outline, a PRD, etc.) utilizing the generated persona with values for conditions associated with one or more features. For example, the computing device may include a database (e.g., machine-learned model data store 370) which is configured to store a plurality of generative machine-learned models respectively associated with a plurality of different types of content or a plurality of different types of documents (e.g., different genres or subjects, different kinds of content including imagery, videos, and text, different types of content including outlines, reports, spreadsheets, resumes, PRDs, etc.).

In some implementations, the computing device may be configured to retrieve, from among the one or more generative machine-learned models 1208, a generative machine-learned model associated with a particular type of content (document) for generating the persona, relating to the input. In some implementations, the computing device may be configured to retrieve, from among the one or more generative machine-learned models 1208, a generative machine-learned model associated with a particular type of persona and/or a particular type of content (document) for generating the output document, relating to the input.

In some implementations, the one or more generative machine-learned models 1208 may be trained on a large dataset of content (e.g., a large corpus of language training data) with corresponding information about the conditions associated with the content. During training, the one or more generative machine-learned models 1208 may be configured to learn relationships between elements in an output (e.g., a persona) and conditions that influence them. This may involve the computing device adjusting each generative machine-learned model's internal parameters to generate a realistic or accurate persona (e.g., with appropriate characteristics for generating the output document) based on the training data. The one or more generative machine-learned models 1208 may be trained on one or more training datasets including a plurality of reference personas. The one or more generative machine-learned models 1208 may be trained on one or more training datasets including a plurality of reference personas that are associated with one or more document types. The one or more training datasets may include values for the one or more conditions.

In some implementations, the one or more generative machine-learned models 1208 may be trained on a large dataset of content (e.g., a large corpus of language training data) with corresponding information about the conditions associated with the content. During training, the one or more generative machine-learned models 1208 may be configured to learn relationships between elements for output content (e.g., an output document, an outline, section of an outline, etc.) and conditions that influence them. This may involve the computing device adjusting each generative machine-learned model's internal parameters to generate realistic or accurate output content (e.g., grammatically correct content, coherent content, etc.) based on the training data. The one or more generative machine-learned models 1208 may be trained on one or more training datasets including a plurality of reference documents. The one or more generative machine-learned models 1208 may be trained on one or more training datasets including a plurality of reference documents that are associated with one or more document types. The one or more training datasets may include values for the one or more conditions.

In some implementations, the one or more generative machine-learned models 1208 are configured to generate the persona in response to receiving the input information (e.g., input 1210, document type 1230, document content 1240, audience information 1250, intent information 1260, topic information, etc.). For example, the persona 1270 may be generated based on the conditioning parameters (and corresponding values for the one or more conditions) to make decisions for generating features or characteristics of the persona 1270.

For example, the persona can be generated via a single exchange between the user and the computing device (e.g., the user provides information relating to the persona via a single input). In some implementations, the minimum criteria for generating the persona may only include an identification of the document type (e.g., a resume, a competitive analysis, a PRD, etc.). In some implementations, the criteria or input information for generating the persona may include at least an identification of the document type (e.g., a resume, a competitive analysis, a PRD, etc.) and one other criteria (e.g., a goal or intent of the document, a target audience, etc.). For example, the persona can be generated without reference to a source document (e.g., a source document that is of the same document type and indicates an outline of the document type) or without the user providing a source document (e.g., a source document that is of the same document type and indicates an outline of the document type) which can be used by the one or more first machine-learned models for generating the persona.

In some implementations, the one or more generative machine-learned models 1208 are configured to generate the output document 1280 in response to receiving the input information and the generated persona 1270. For example, the output document 1280 may be generated based on the conditioning parameters (and corresponding values for the one or more conditions) to make decisions for generating the content of the output document 1280.

In some implementations, the one or more generative machine-learned models 1208 are configured to generate an outline and/or sections of the outline in response to receiving the input information and the generated persona 1270. For example, the outline and/or sections of the outline may be generated based on the conditioning parameters (and corresponding values for the one or more conditions) to make decisions for generating the content of the outline and/or sections of the outline. As described herein, at operation 1140 additional information relating to the sections may be obtained from the user and the one or more generative machine-learned models 1208 may be configured to generate the output document 1280 in response to receiving the input information, the additional information relating to the sections, and the generated persona 1270.

In some implementations, the server computing system 300 may provide (transmit) content or a portion of the generated content to computing device 100 or the server computing system 300 may provide access to the generated content to the computing device 100. For example, the persona 1270 and/or the output document 1280 may be generated at the server computing system 300 and stored at one or more computing devices (e.g., one or more of computing device 100, external computing device 200, server computing system 300, external content 500, content data store 350, user data store 360, etc.).

In some implementations, after the outline, sections of the outline, or output document 1280 is generated, the user can provide feedback or a further input relating to the outline, sections of the output, or output document, and one or more of the operations 1110 through 1150 can be repeated.

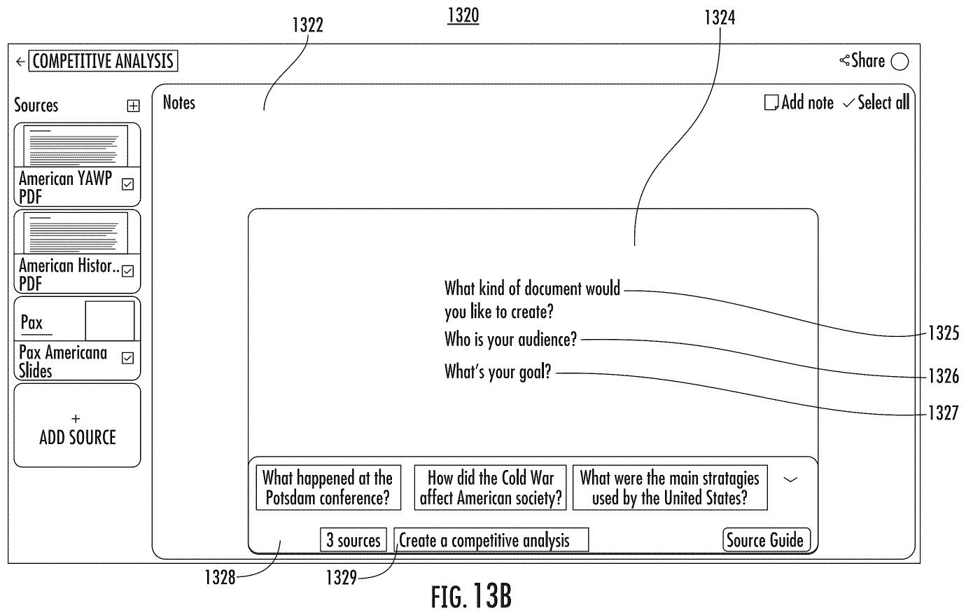

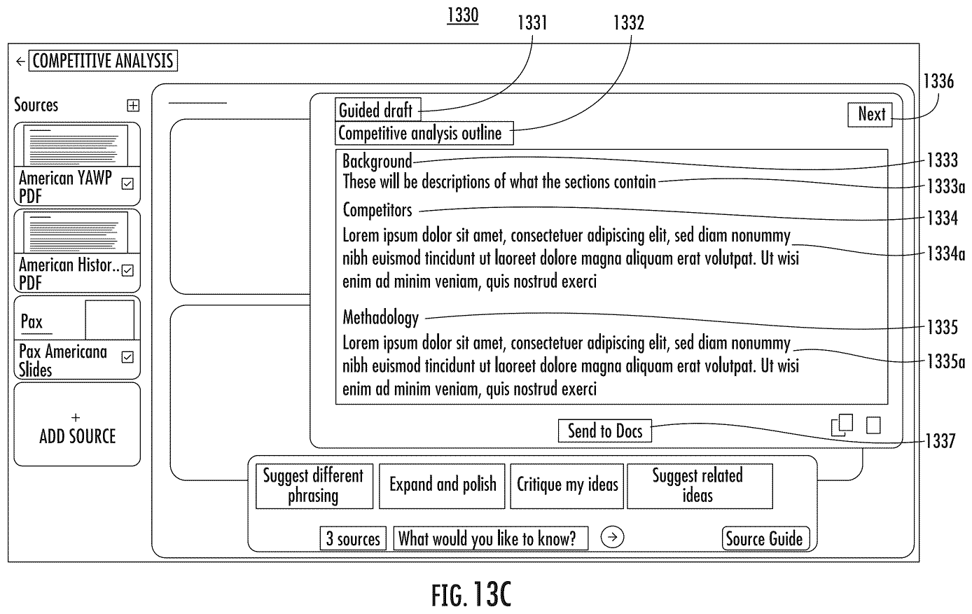

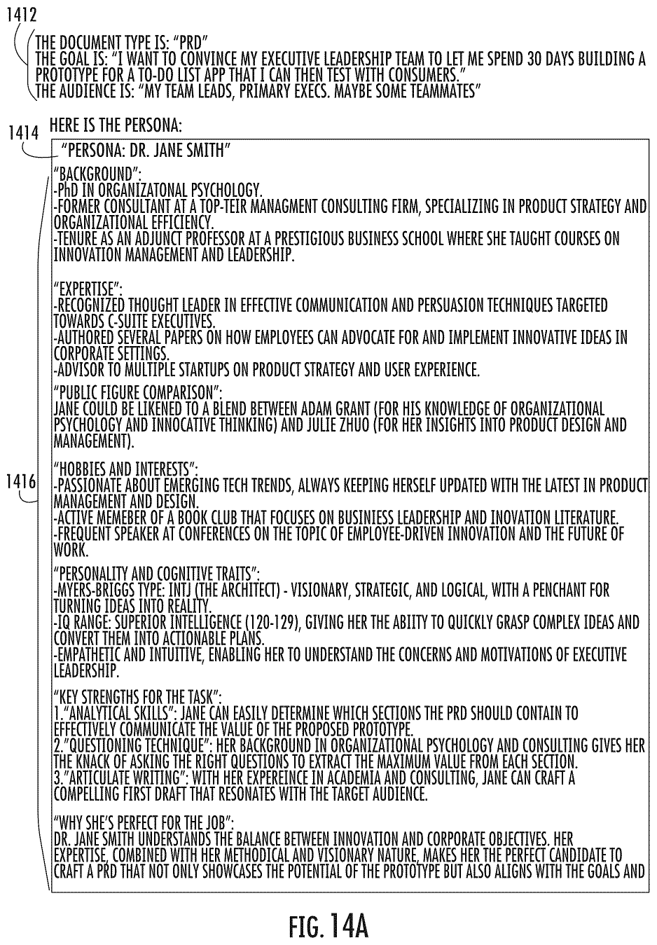

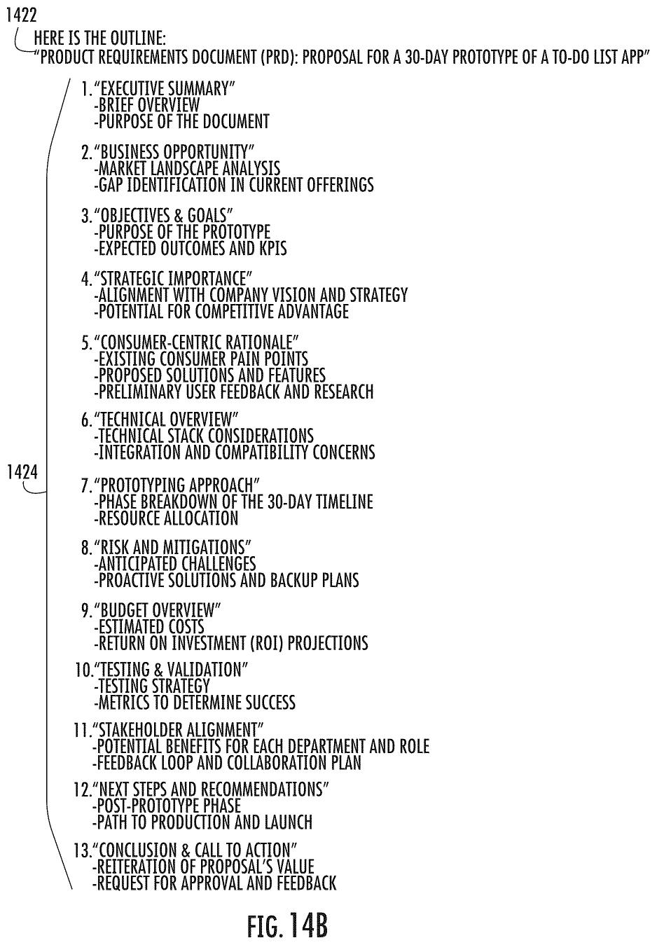

Examples of the disclosure are also directed to user-facing aspects by which a user can manage content, organize content, create content, etc., via a notebook application and/or persona generator application which can be configured to implement one or more machine-learned models with respect to an input provided by the user and/or content selected by the user. For example, FIGS. 13A through 14B illustrate examples of actions operations which can be implemented for a project in which a persona is generated via one or more first machine-learned models based an input provided by a user indicating at least a document type, and in which an output document is generated via one or more second machine-learned models by utilizing the persona and based on the document type, according to one or more example embodiments of the disclosure.

For example, FIG. 13A illustrates a first user interface screen (e.g., a persona generator user interface screen) of a persona generator application (which may be incorporated as part of a notebook application), according to one or more example embodiments of the disclosure.

In FIG. 13A, the first user interface screen 1310 depicts a user interface (e.g., a persona generator user interface screen) which provides information about the persona generator application 1200. In particular, persona generator application 1200 is configured to present for display the first user interface screen 131 which includes a visual depiction regarding how an output document can be generated.

As illustrated in FIG. 13A, the first user interface screen 1310 further includes a plurality of user interface elements which are selectable (or can be interacted with) by the user for generating an output document. For example, the first user interface screen 1310 may be part of the notebook application 3100 that can be used to generate notes which can be added to the notes section 1312 in the notebook application 3100. For example, a first portion 1314 of the first user interface screen 1310 includes a first user interface element 1316 and a second user interface element 1317 configured to be selectable for creating an output document. In FIG. 13A, the first user interface element 1316, when selected, may indicate to the persona generator application 1200 to generate a first draft of an output document according to a first method (e.g., without the user providing a source document), based on the example implementations as described with respect to FIGS. 11 and 12. The second user interface element 1317, when selected, may cause the persona generator application 1200 to generate a second draft of an output document according to a second method (e.g., based on a source document which corresponds to a first draft of the output document), based on the example implementations as described with respect to FIGS. 11 and 12.

For example, a second portion 1318 of the first user interface screen 1310 includes a third user interface element 1319 which is configured to cause the persona generator application 1200 to generate a particular output document according to a particular document type (e.g., a competitive analysis document as shown in FIG. 13A) and according to the selection of one of the first user interface element 1316 and the second user interface element 1317.

FIG. 13B illustrates a second user interface screen (e.g., a persona generator input user interface screen) of a persona generator application (which may be incorporated as part of a notebook application), according to one or more example embodiments of the disclosure.

In FIG. 13B, the second user interface screen 1320 depicts a user interface (e.g., a persona generator input user interface screen) which is associated with enabling a user to provide one or more inputs for generating the output document and which can be used to generate a persona in a manner that is hidden (e.g., in the background) from the user by the persona generator application 1200. In particular, the persona generator application 1200 is configured to present for display the second user interface screen 1320 which includes various portions and user interface elements by which the user can indicate attributes of the output document to be generated by the persona generator application 1200.

As illustrated in FIG. 13B, the second user interface screen 1320 includes a plurality of user interface elements which are selectable (or can be interacted with) by the user for generating an output document. For example, the second user interface screen 1320 may be part of the notebook application 3100 that can be used to generate notes which can be added to the notes section 1322 in the notebook application 3100. For example, a first portion 1324 of the second user interface screen 1320 includes a first user interface element 1325, a second user interface element 1326, and a third user interface element 1327 which are configured to be selectable (or can be interacted with) to provide information relating to the output document to be generated. In FIG. 13B, the first user interface element 1325, when selected or interacted with, may allow a user to provide an input indicating to the persona generator application 1200 a type of document to be generated. The second user interface element 1326, when selected or interacted with, may allow a user to provide an input indicating to the persona generator application 1200 a target audience for the output document to be generated. The third user interface element 1327, when selected or interacted with, may allow a user to provide an input indicating to the persona generator application 1200 an intent or goal for the output document to be generated. For example, the persona generator application 1200 may be configured to receive inputs via the first user interface element 1325, the second user interface element 1326, and the third user interface element 1327, via the input device 150, for example.

For example, the second user interface screen 1320 includes a second portion 1328 which includes a fourth user interface element 1329 which is configured to cause the persona generator application 1200 to generate a particular output document according to a particular document type (e.g., a competitive analysis document as shown in FIG. 13B) and according to the one or more inputs provided via the first user interface element 1325, the second user interface element 1326, and the third user interface element 1327.

FIG. 13C illustrates a third user interface screen (e.g., an outline generator user interface screen) of a persona generator application (which may be incorporated as part of a notebook application), according to one or more example embodiments of the disclosure.

In FIG. 13C, the third user interface screen 1330 depicts a user interface (e.g., an outline generator user interface screen) which is associated with an outline that can be used to generate an output document via the persona generator application 1200. In particular, the persona generator application 1200 may be configured to present for display the third user interface screen 1330 which includes various sections and user interface elements by which the user can provide inputs relating to content for one or more sections of the outline which is generated by the persona generator application 1200.

As illustrated in FIG. 13C, the third user interface screen 1330 depicts a plurality of sections for an outline generated that can be generated in a guided manner, as described with respect to FIGS. 11 and 12. For example, in FIG. 13C the persona generator application 1200 may be configured to implement a guided draft 1331 workflow by which the competitive analysis outline 1332 can be generated. The third user interface screen 1330 of FIG. 13C depicts the competitive analysis outline 1332 having a background section 1333, competitors section 1334, and a methodology section 1335, however other sections may also be included or displayed (e.g., by the user selecting a first user interface element 1336 which causes the persona generator application 1200 to display further sections of the outline). As illustrated in FIG. 13C, the persona generator application 1200 may be configured to display content associated with each section (e.g., background content 1333a, competitors content 1334a, methodology content 1335a, etc.). As described herein, in some implementations the one or more second machine-learned models may be configured to generate at least some of the content associated with one or more of the sections of the outline. As described herein, in some implementations the one or more second machine-learned models may be configured to generate at least some of the content associated with one or more of the sections of the outline based on input information provided by the user (e.g., via a dialogue operation, a chat operation, etc.).

In some implementations, the persona generator application 1200 may be configured to enable a user to edit content which is generated for a section of the outline by the one or more second machine-learned models. For example, the user may be enabled to provide an input (e.g., via the input device 150) to the third user interface screen 1330 to edit the content of a particular section (e.g., via a user interface element which, when selected or interacted with, enables the user to edit information provided with respect to a particular section). In some implementations, the persona generator application 1200 may be configured to enable a user to approve of (confirm) content which is generated for a section of the outline by the one or more second machine-learned models. For example, the user may be enabled to provide an input (e.g., via the input device 150) to the third user interface screen 1330 to confirm the content of a particular section (e.g., via a user interface element which, when selected or interacted with, confirms that information provided with respect to a particular section is correct). In some implementations, the persona generator application 1200 may be configured to enable a user to add content (e.g., add more sections) to the outline generated by the one or more second machine-learned models. For example, the user may be enabled to provide an input (e.g., via the input device 150) to the third user interface screen 1330 to add a section to the outline (e.g., via a user interface element which, when selected or interacted with, causes a section to be added to the outline). In some implementations, the persona generator application 1200 may be configured to enable a user to highlight content of the outline (e.g., highlight particular passages of a section) generated by the one or more second machine-learned models. For example, the user may be enabled to provide an input (e.g., via the input device 150) to the third user interface screen 1330 to select content from the outline which is highlighted (e.g., via a user interface element which, when selected or interacted with, causes a portion of a section to be highlighted). In response to the highlighting of the content from the outline, the persona generator application 1200 may be configured to regenerate (rewrite) the highlighted content, for example, via the one or more second machine-learned models. For example, this may allow the one or more second machine-learned models to correct or improve the highlighted content.

In some implementations, when the outline is complete and the one or more sections are filled out, the outline may be saved or stored, for example as a note and/or as another document type. For example, as illustrated in FIG. 13C, the outline may be stored or saved as a document associated with a particular document application 134 via selection of the second user interface element 1337.

Referring to FIG. 14A, background prompts or features related to generating a persona by the one or more first machine-learned models are illustrated, according to examples of the disclosure. For example, the one or more first machine-learned models may be configured to define a persona for the one or more second machine-learned models that can be used for generating the output document 1280. For example, the persona can be used by the one or more second machine-learned models to help a user determine what sections the particular document should include (e.g., a background section, a competitors section, a methodology section, an executive summary section, a business opportunity section, etc., for a competitive analysis document, a PRD, etc.). For example, the persona can be used by the one or more second machine-learned models to ask (query) the user questions about each section to ensure the output document has sufficient content and is effective and coherent (e.g., via a chat or dialogue exchange/operation). For example, the persona can be used by the one or more second machine-learned models to generate the output document (e.g., the competitive analysis document, the PRD, etc.) with content for each of the sections, based on the information provided by the user and, in some implementations, based on information from other sources (e.g., source documents, external content, etc.).

In some implementations, the persona may take on characteristics of an expert in a particular topic associated with the output document, may take on characteristics of an expert with respect to drafting documents for a particular document type, etc. For example, the persona may have certain characteristics including particular hobbies, interests, have a similar expertise as a particular public figure, have a certain IQ range, have a certain Myers-Briggs type, etc. The one or more first machine-learned models may be configured to generate the persona based on or in response to the requirements of the document. In some implementations, the requirements of the document may be provided by the user or may be obtained (e.g., from external content, from a database, etc.), in response to the user indicating the particular document type to be output. The one or more first machine-learned models may be configured to identify or determine the particular persona (or personas) which are appropriate for the task.

In FIG. 14A, the persona information 1410 may include persona input information 1412, persona identify information 1414, and persona characteristic information 1416. For example, the persona input information 1412 may include a document type (e.g., a PRD type), a goal or intent (e.g., “I want to convince my executive leadership team to let me spend 30 days building a prototype for a to-do list app that I can then test with consumers”), and a target audience (e.g., “My team leads, primarily execs. Maybe some teammates”).

In response to receiving the input information from the user (e.g., the persona input information 1412), the one or more first machine-learned models may be configured to generate the persona. As shown in FIG. 14A, the persona identity information 1414 indicates the identity of the persona is a persona having a doctorate degree (e.g., “Dr. Jane Smith”). As shown in FIG. 14A, the persona characteristic information 1416 indicates various features or attributes associated with the persona. identity of the persona is a persona having a doctorate degree (e.g., “Dr. Jane Smith”).

For example, the persona (e.g., Dr. Jane Smith) may have a particular background, including a particular degree, education, career experience, etc., that is appropriate for the task (e.g., a PhD in organizational psychology, consultant experience at a top-tier management consulting firm, professorship at a prestigious business school, etc.). Here, the task may be indicated by the document type, the goal, the target audience, etc. For example, the persona (e.g., Dr. Jane Smith) may have a particular expertise appropriate for the task, including particular accomplishments, awards, recognitions, etc., that is appropriate for the task (e.g., recognized in the particular field as a thought leader and recognized as being effective at persuading C-suite executives, an author of papers for how employees can advocate for implementing innovative ideas, advising in product strategy and user experience, etc.). For example, the persona (e.g., Dr. Jane Smith) may have a particular public stature appropriate for the task (e.g., compared to other known public figures), including being compared to experts (e.g., a description as a blend of a first public figure having knowledge of organizational psychology and innovating thinking accomplishments and a second public figure known for insights into product design and management). For example, the persona (e.g., Dr. Jane Smith) may have particular hobbies and/or interests appropriate for the task (e.g., having hobbies and/or interests related to technology, being a member of a book club or organization related to business leadership, speaking at conferences related to innovation, etc.). For example, the persona (e.g., Dr. Jane Smith) may have particular personality and/or cognitive traits appropriate for the task (e.g., a particular Myers-Briggs type of INTJ being related to visionary, strategic, etc., a particular IQ range indicating superior intelligence, particular traits of being empathetic, intuitive, etc.). For example, the persona (e.g., Dr. Jane Smith) may have particular key strengths appropriate for the task (e.g., analytical skills, questioning techniques, articulate writing, etc.). For example, the persona (e.g., Dr. Jane Smith) may be defined according to a summary of the qualifications of the persona appropriate for the task (e.g., why the persona is “perfect” for the task, summarizing the persona's ability to understand the balance between innovation and corporate objectives, expertise, and ability to craft the document type relevant to the task).

Referring to FIG. 14B, contents 1420 of an outline generated via the one or more second machine-learned models utilizing the generated persona is illustrated, according to examples of the disclosure. For example, the contents 1420 may include first information 1422 (e.g., corresponding to a title of the document and/or indicating a type of the document). For example, the contents 1420 may include second information 1424 (e.g., corresponding to a plurality of sections of the outline). For example, portions of each section may be identified according to one or more headings. For example, a first section may correspond to an “Executive Summary” and may include a first portion with a heading of “Brief Overview” and a second portion with a heading of “Purpose of the Document.” The one or more second machine-learned models may be configured to obtain information relating to each section and/or each portion of each section, for example, via a chat operation and/or dialogue operation, as described herein. Further, as described herein the persona generator application 1200 (e.g., the one or more second machine-learned models) may be configured to generate the output document based on the generated outline, utilizing the persona.

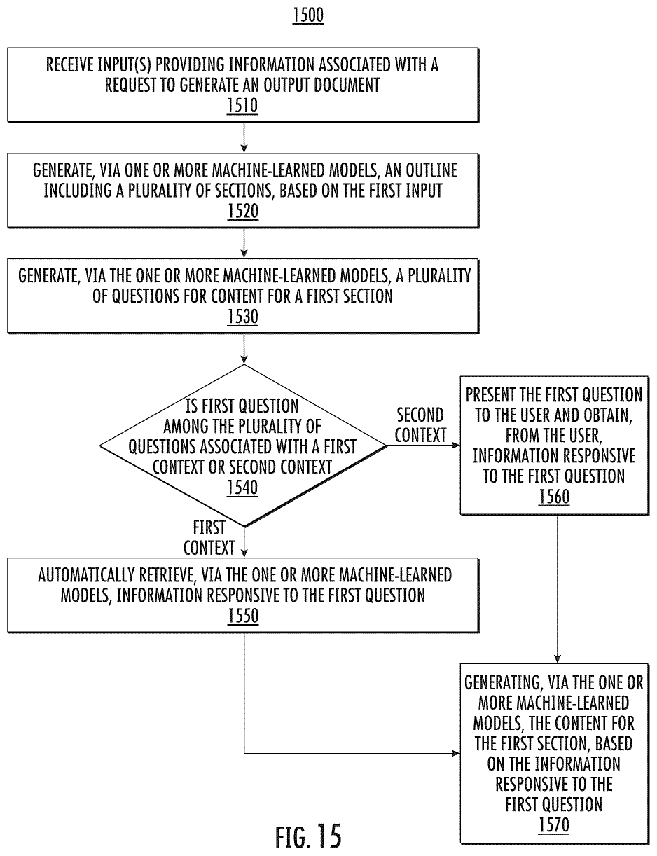

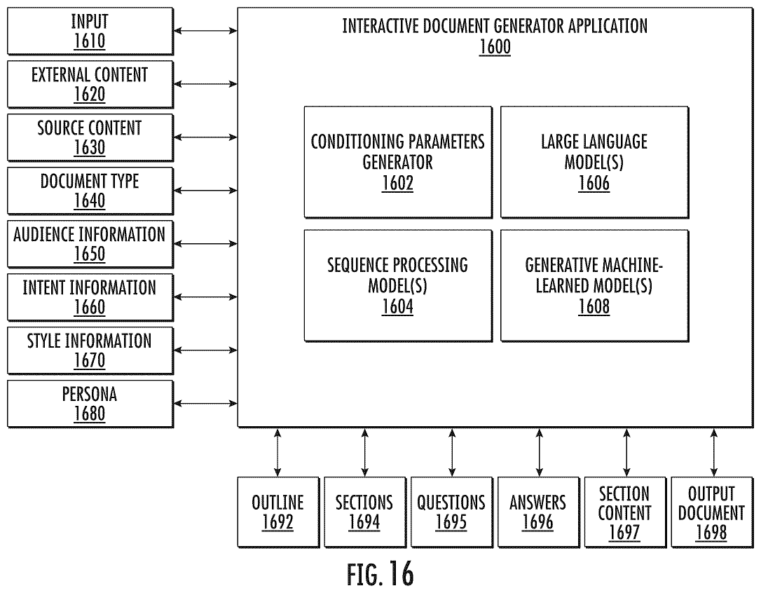

Examples of the disclosure are directed to computer implemented methods for generating an output document (e.g., a report, a resume, a research paper, a legal document, etc.), and for providing a user interface for organizing, managing, and creating content by implementing one or more machine-learned models with respect to source content selected by a user and the generated output document. FIG. 15 illustrates a flow diagram of an example, non-limiting computer-implemented method, according to one or more example embodiments of the disclosure. FIG. 16 illustrates a block diagram of an interactive document generator application, according to one or more example embodiments of the disclosure.

The flow diagram of FIG. 15 illustrates a method 1500 for generating an output document that can be used for organizing, managing, and creating content by implementing one or more machine-learned models with respect to source content (e.g., source documents) selected by a user. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 15, at operation 1510 the method 1500 includes a computing device receiving an input from a user providing information associated with a request to generate an output document. As described herein, the computing device may be embodied as computing device 100, server computing system 300, or combinations thereof. For example, the input may be provided by the user via input device 150. The input may be provided or input to interactive document generator application 139 or interactive document generator application 339, for example. For example, the input may be a first input which includes a prompt to be provided to one or more machine-learned models for generating the output document. The prompt may be provided via a textual input, a voice input, etc. As an example, the first input may include a request to generate or draft a report about a particular topic, to draft a legal document directed to a particular matter and from a particular viewpoint, to draft an analysis, etc. (e.g., “I want to write a report on the effects of generative AI in the workplace”). In some implementations, the computing device may receive further inputs from the user before generating content relating to the output document (e.g., an outline, the output document, etc.). For example, the user may provide a second input indicating a style to apply to the output document (e.g., draft the document in a casual style, an academic manner, a persuasive manner, a verbose manner, etc.). For example, the user may provide other inputs indicating a purpose or goal of the output document, an intended audience, restrictions on the length of the document, etc. In some implementations, the computing device (e.g., the interactive document generator application 139) may be configured to provide pre-configured options which are selectable by the user (e.g., via selectable user interface elements). For example, the computing device (e.g., the interactive document generator application 139) may be configured to provide a user interface with pre-configured prompts, pre-configured styles, pre-configured audience types, predetermined goals, etc. from which the user can select.

In some implementations, a response to receiving the input providing the information associated with the request to generate the output document (e.g., the prompt), may be processed at the computing device 100 without involving the server computing system 300. In some implementations, the input providing the information associated with the request to generate the output document may be transmitted from the computing device 100 to the server computing system 300 and at least part of the response to the input may be processed by the server computing system 300. For example, the input providing the information associated with the request to generate the output document may be provided at the computing device 100 and the server computing system 300 may be configured to perform one or more operations (e.g., one or more of operations 1520, 1530, 1540, 1550, 1560, 1570) in response to receiving an indication of the input.

At operation 1520 the method 1500 includes the computing device generating, via one or more machine-learned models, an outline based on the first input, the outline including a plurality of sections. For example, the first input may be provided by the user via input device 150. In some implementations, the computing device (e.g., interactive document generator application 139) may be configured to implement one or more machine-learned models with respect to the first input to generate an outline based on the first input. In some implementations, the outline generated by the one or more machine-learned models may include a plurality of sections (e.g., having a plurality of headings that indicate the different sections of the outline). In some implementations, the outline may further be associated with a particular type of document, a particular style, an intent, and/or a format that can be inferred or scraped from the content of one or more second inputs, from one or more source documents previously selected by the user, and/or from the original first prompt.

For example, the computing device can process the first input (and the one or more second inputs as applicable) with one or more machine-learned models (e.g., one or more large language models) to obtain a language output. The computing device can then use the one or more machine-learned models (e.g., one or more large language models, one or more generative machine-learned models, etc.) to generate a summarization output. In particular, a machine-learned large language model can be trained to process a variety of outputs to generate a language output. For example, the machine-learned large language model can process an embedding generated by a machine-learned embedding generation model, portions of the first input (and the one or more second inputs as applicable) identified using the embedding generation model, language outputs generated using the machine-learned large language model or some other model, etc.

In some implementations, the one or more machine-learned models may be configured to determine (learn) a document type, intent, style, and/or format associated with the first input (and the one or more second inputs as applicable), for example, via various natural language processing operations. For example, the first input (and the one or more second inputs as applicable) may be broken down into tokens (e.g., words, phrases, individual characters, etc.), and converted into an embedding (e.g., numerical vector representation) which can capture semantic information regarding the first input (and the one or more second inputs as applicable). In some implementations, the one or more machine-learned models may be configured to identify or classify an outline to be generated as being directed to a particular type of document (e.g., a resume, PRD, outline, legal document, etc.). The classification can be based on an aggregation of token embeddings to create a representation for the entire first input (and the one or more second inputs as applicable), for example, via an averaging of the embeddings, TF-IDF weighting, etc. The one or more machine-learned models may be configured to analyze the vocabulary in the first input (and the one or more second inputs as applicable), for example, based on the frequency of certain words, the presence of specific terms, use of domain-specific jargon, etc. The one or more machine-learned models may also be configured to determine a syntax of the first input (and the one or more second inputs as applicable), for example, based on sentence structure, sentence length, use of grammatical constructs, etc., which can provide information regarding a particular style and/or intent of an input. The one or more machine-learned models may be configured to analyze the first input (and the one or more second inputs as applicable) to determine semantic information based on the meaning of the content included in an input (e.g., the meaning of particular words or sentences), to identify a particular style and/or intent of the input, etc. Further, the one or more machine-learned models may be configured to determine a context of each word in relation to an entire input or combination of inputs. In addition, the one or more machine-learned models may be configured to consider the content of one or more source documents previously identified or selected by the user for generating the outline, sections, and/or output document.

To determine (learn) a format of the outline, (e.g., including the sections and section headings for the outline), the one or more machine-learned models may be configured to analyze a sequential structure of the source documents (which also may be referred to as training content) to identify recurring patterns (e.g., to recognize headers, subheadings, paragraphs, bullet points, numbered lists, and other common formatting elements). The one or more machine-learned models may also be configured to learn a document structure based on consistent patterns or layouts (e.g., tables, images, captions, etc.) to understand the spatial relationships between different elements. The one or more machine-learned models may also be configured to identify specific formatting conventions (e.g., the use of indentation, font styles, font sizes, etc.), to identify the document structure (typical sections utilized in the document) and perform pattern matching. The one or more machine-learned models may be configured to learn and recognize specific document formats such that when the user uploads a plurality of source documents an outline can be generated that conforms with the document structure of the source documents. In some implementations, the source documents may share common features (e.g., a common format, a common style, a common intent, etc.).

In some implementations, the one or more machine-learned models may be configured to receive information from a user which identifies information about the source documents (e.g., labeled data, such as an identification of the document type, the document style, the document intent, the document format, the sections which are to be utilized or not utilized, heading names, etc.). The one or more machine-learned models may be trained and/or refined based on the labeled data as well as by feedback provided via a user. The outline generated by the one or more machine-learned models (e.g., one or more large language models, one or more generative machine-learned models, etc.) at operation 1520 may be stored in the computing device and may be output for presentation on the display device 160 to the user.

As a non-limiting example, when the first input includes the prompt “write a paper summarizing American workers' concerns about AI”, the computing device (e.g., the interactive document generator application 139) may be configured to generate an outline having a plurality of sections including: (1) an introduction section, (2) a literature review section, (3) a findings section, (4) a recommendations section, and (5) a conclusion section.

In some implementations, the user can modify the generated outline. For example, the computing device (e.g., the interactive document generator application 139) may be configured to enable a user to modify the generated outline by providing one or more options (e.g., via one or more user interface elements) to add sections (section headings) to the outline, edit existing sections (section headings) in the generated outline, delete sections (section headings) from the generated outline, request the computing device (e.g., the interactive document generator application 139) to regenerate the outline, sections, section headings, etc. Modifications provided by the user to a generated outline may be provided as feedback information to the one or more machine-learned models. The computing device (e.g., the interactive document generator application 139) may be configured to receive an indication or input from the user (e.g., via a user interface element) which indicates that the user accepts the generated outline and associated sections (section headings).

At operation 1530 the method 1500 includes the computing device (e.g., the interactive document generator application 139) generating, via the one or more machine-learned models, a plurality of questions for generating content for one or more sections (e.g., a first section) among the plurality of sections, based on the first input. For example, the one or more machine-learned models may be configured to generate the plurality of questions for generating the content for one or more of sections (e.g., the first section), in response to the computing device receiving an input from the user indicating to accept the outline. For example, the one or more machine-learned models may be configured to generate the plurality of questions based on a title (heading) of the section. For example, the one or more machine-learned models may be configured to generate the plurality of questions based on the content included in the one or more source documents selected by the user previously which are to be relied upon by the one or more machine-learned models for generating content for the output document, outline, sections in the outline, etc. For example, for an introduction section described above for the non-limiting example, the one or more machine-learned models may be configured to generate a plurality of questions including: (1) What are the main concerns that American workers have about AI?, (2) What is the current state of research on this topic?, (3) What are the key terms and concepts that need to be defined?, (4) What is the purpose and scope of the paper?, and (5) What is the target audience for this paper?. For example, the questions which are generated by the one or more machine-learned models may be generated in real-time, for example, in response to the user accepting the form of the outline generated by the one or more machine-learned models. In some implementations, the number of questions may be limited to a predetermined number of questions (e.g., five questions, ten questions, etc.).

For example, the one or more machine-learned models may be trained to generate questions based on the content of the first input, the content of the one or more second inputs, the content of the source documents, the content of the outline, the content of the section titles (headings), etc. For example, an example internal prompt to the one or more machine-learned models for generating the plurality of questions may be in the form of: “Given the goal: “XXX” and a section titled “YYY”, what questions would you ask to the author or to the research materials (selected by the user) in order to write this section well?”. In the context of the non-limiting example, an example internal prompt may be “Given the goal:” Write a paper summarizing American workers' concerns about AI″ and a section titled “Introduction”, what questions would you ask to the author or to the five source documents selected by the user, in order to write this section well?”.

At operation 1540 the method 1500 includes the computing device (e.g., the interactive document generator application 139) determining, via the one or more machine-learned models, whether a first question among the plurality of questions is associated with a first context or a second context. For example, the first context may correspond to a query which can be answered via the one or more machine-learned models based on information contained in one or more source documents. For example, the second context may correspond to a query relating to at least one of a purpose, scope, or target (intended) audience associated with the output document. In some implementations, the one or more machine-learned models may include a classifier which is trained to classify each of the generated questions as corresponding to one of the first context or the second context. For example, the classifier may be trained to identify whether it is more appropriate for a question to be answered by the user or more appropriate for the question to be answered via the one or more machine-learned models based on content included in the one or more source documents. As an example, questions which may be more appropriate for the user to answer may include questions relating to a purpose of the output document or section, a scope of the output document or section, a target or intended audience of the output document or section, a desired length of the output document or section, an intent of the user, etc. As an example, questions which may be more appropriate for the one or more machine-learned models to (automatically) answer (based on the previously selected or identified source documents), may include questions that can be answered based on content included in the source documents (e.g., questions that can be researched via the one or more machine-learned models to determine an answer to the question).

As an example, in the context of the non-limiting example, the one or more machine-learned models may be configured to determine that the questions “What are the main concerns that Americans have about AI?” and “What are the key terms and concepts that need to be defined?” are research-type questions (e.g., questions having the first context that are better suited to be automatically researched and answered via the one or more machine-learned models). In this case the method would proceed to operation 1550. As another example, in the context of the non-limiting example, the one or more machine-learned models may be configured to determine that the questions “What is the purpose and scope of the paper?” and “What is the target audience for this paper?” are user-type questions (e.g., questions having the second context that are better suited for the user (author) to answer). In this case the method would proceed to operation 1560.

At operation 1550, the method 1500 includes the computing device (e.g., the interactive document generator application 139), when a question (e.g., the first question) is associated with the first context, automatically retrieving, via the one or more machine-learned models, information responsive to the question. For example, the one or more machine-learned models may be configured to automatically obtain an answer (content) which is responsive to the first question based on content included in one or more source documents that have been previously selected by the user. In some implementations, the content associated with a source document that is to be researched may correspond to a summary description of the source document rather than an entirety of the source document. Therefore, resource savings and increased speed may be achieved by the one or more machine-learned models researching data summarizing the source document which is less in size than data corresponding to the whole of the source document. In some implementations, the answer may be based on a plurality of source documents. In some implementations, the answer may include information identifying the source document(s) which were relied upon as a source for the answer.

As an example, in the context of the non-limiting example, the one or more machine-learned models may be configured to automatically respond to the question “What are the main concerns that Americans have about AI?” with information responsive to the question, including: “(1) Loss of jobs: Many Americans fear that AI will automate their jobs and lead to widespread unemployment. (sources 2, 4, 6); (2) Data privacy and surveillance: Americans are concerned that AI will be used to collect and track their personal information, which could be used for harmful purposes. (sources 1, 4, 6); and (3) Lack of human interaction: Some Americans worry that AI will replace human workers in customer service and other industries, leading to a loss of personal touch. (source 6).”

At operation 1560, the method 1500 includes the computing device (e.g., the interactive document generator application 139), when the question (e.g., first question) is associated with the second context, presenting the question to the user and obtaining, from the user, the information responsive to the question. In some implementations, the computing device (e.g., the interactive document generator application 139) may be configured to provide, for presentation to the user, one or more user interface elements by which the user can provide information responsive to the question. For example, the computing device (e.g., the interactive document generator application 139) may be configured to provide, for presentation to the user, pre-configured selectable user interface elements which correspond to possible or likely answers to the question. For example, if the first question is “What is the target audience for this paper?”, the one or more preconfigured user interface elements may correspond to “an academic or scientific audience”, “lay person audience”, “governmental audience,” “expert audience,” etc. In some implementations, the user can provide a text input to provide an answer to the question in the user's own words (e.g., the user may input via the input device 150 “The everyday person who is trying to get acquainted with AI and its implications for society” as information which is responsive to the question regarding the target audience).

At operation 1570, the method 1500 includes the computing device (e.g., the interactive document generator application 139) generating, via the one or more machine-learned models, the content for the first section, based on the information responsive to the first question. For example, the one or more machine-learned models may be configured to generate the content for a section of the outline based on a plurality of answers to a plurality of questions, which may include one or more questions of the first context and one or more questions of the second context. For example, the content for the first section may be in a particular format (e.g., a bullet-style format, a paragraph format, etc.).

Below is a first example output for a first section (e.g., introduction section) in the context of the non-limiting example:

Introduction
What are the main concerns that American workers have about AI?
American workers' main concerns about AI are:
Loss of jobs: Many Americans fear that AI will automate their jobs and lead to
widespread unemployment. (sources 2, 4, 6)
Data privacy and surveillance: Americans are concerned that AI will be used to
collect and track their personal information, which could be used for harmful
purposes. (sources 1, 4, 6)
Lack of human interaction: Some Americans worry that AI will replace human
workers in customer service and other industries, leading to a loss of personal
touch. (source 6)
Bias and discrimination: Americans are concerned that AI systems could be
biased against certain groups of people, such as minorities and women. (source 6)
Unintended consequences: Americans are worried that AI could have unintended
negative consequences, such as environmental damage or social unrest. They also
fear that AI could be used for malicious purposes, such as cyberattacks or
autonomous weapons. (source 6)
What is the current state of research on this topic?
The current state of research on public concern over AI is:
Growing public concern: A growing number of Americans are expressing concern
about the role of AI in daily life. (source 1)
Mixed opinions about specific uses: Public opinion about AI varies depending on
the specific use case. Some uses, such as AI-powered medical diagnosis, are seen
more positively than others, such as AI-powered surveillance. (source 4)
Lack of awareness and understanding: Many Americans are still not fully aware
of AI and its potential impact on their lives. (source 5)
Need for regulation: Americans are increasingly calling for government regulation
of AI to ensure its responsible development and use. (source 5)
Overall, the research suggests that the public is still grappling with the implications of AI
and that more research is needed to understand the full extent of public concerns and to
develop effective policies to address them. (source 6)
What are the key terms and concepts that need to be defined?
Key terms and concepts that need to be defined:
Artificial intelligence (AI): A field of computer science that focuses on
developing machines that can learn and perform tasks that would normally require
human intelligence. (source 1)
Emerging technology: Any new technology that has the potential to significantly
impact society. (source 1)
Public concern: The concerns that members of the public have about a particular
issue. (source 1)
AI-powered medical diagnosis: The use of AI to analyze medical data and make
diagnoses. (source 4)
AI-powered surveillance: The use of AI to monitor people or activities. (source
4)
Regulation: The process of setting rules and standards for the development and
use of AI. (source 5)
What is the purpose and scope of the paper?
Give the audience an overview of American workers' concerns about AI based on
evidence and research
What is the target audience for this paper?
The everyday person who is trying to get acquainted with AI and its implications for
society

Below is a second example output for a first section (e.g., introduction section) in the context of the non-limiting example:

Introduction
Artificial intelligence (AI), an emerging technology with the potential to revolutionize
various aspects of our lives, has sparked growing concerns among American workers.
This paper aims to provide a comprehensive summary of these concerns, grounded in
evidence and research.
American workers are primarily apprehensive about the potential impact of AI on their
livelihoods. They fear that AI-powered automation could displace them from their jobs,
leading to widespread unemployment. Additionally, they are concerned about the use of
AI for data privacy violations and surveillance, which could compromise their personal
information.
Furthermore, workers are worried about the loss of human interaction in industries where
AI takes over customer service and other roles. They also express concerns about bias
and discrimination within AI systems, which could perpetuate existing societal
inequalities. Moreover, they are apprehensive about the potential unintended
consequences of AI, such as environmental damage, social unrest, and malicious
applications.
Current research indicates a growing public concern about AI, with mixed opinions
depending on its specific use cases. While some applications, such as AI-powered
medical diagnosis, are viewed favorably, others, such as AI-powered surveillance, raise
significant concerns. The research also highlights a lack of awareness and understanding
about AI among the general public and the increasing demand for government regulation
to ensure its responsible development and use.
This paper will delve into these concerns in detail, providing an evidence-based overview
of American workers' apprehensions about AI and its implications for society.

In some implementations, the computing device (e.g., the interactive document generator application 139) may be configured to provide, for presentation to the user, a plurality of question and answer pairs which includes the plurality of questions and corresponding answers including information responsive to each of the plurality of questions. In some implementations, the computing device (e.g., the interactive document generator application 139) may be configured to receive an input (second input) with respect to the plurality of question and answer pairs (e.g., via a user interface). The input may indicate to remove one or more of the plurality of question and answer pairs, add one or more questions to generate one or more additional question and answer pairs, to add to the plurality of question and answer pairs, or accept the plurality of question and answer pairs. Therefore, the user may provide feedback regarding the plurality of question and answer pairs which can be used by the one or more machine-learned models to further refine information which is used for generating the content for the section.

In some implementations, the computing device (e.g., the interactive document generator application 139) may be configured to provide, for presentation to the user, a plurality of question and answer pairs which includes the plurality of questions and corresponding answers including information responsive to the plurality of questions. In some implementations, the computing device (e.g., the interactive document generator application 139) may be configured to receive an input (second input) selecting one or more of the plurality of question and answer pairs, and to generate, via the one or more machine-learned models, the content for the first section, based on information responsive to questions from the one or more of the plurality of question and answer pairs selected via the input. For example, the computing device (e.g., the interactive document generator application 139) may be configured to receive a selection of various question and answer pairs that the user indicates should be used for generating the content for the section. Therefore, the one or more machine-learned models may utilize selective information responsive to some of the questions for generating the content for the section while ignoring or omitting the information responsive to other questions. Accordingly, the one or more machine-learned models may operate more efficiently by generating the content for the section based on relevant answers rather than all answers to the questions. For example, the one or more machine-learned models may be configured to generate the content for the section based additionally on one or more of the original content of the first input (e.g., the prompt), the title (heading) of the section, and any other information the user may have provided (e.g., a style to be applied to the output document or outline, a persona to be applied to the output document or outline, an intent to be applied to the output document or outline, a desired length or format, etc.).

For example, operations 1530 through 1570 can be repeated by the computing device (e.g., the interactive document generator application 139) for one or more other sections in the outline to generate content for the one or more other sections in the outline. When content for all of the sections in the outline has been generated, the one or more machine-learned models may be configured to generate the output document based on the outline and the source documents. For example, the one or more machine-learned models may be configured to generate the content for the output document based additionally on one or more of the original content of the first input (e.g., the prompt), the title (heading) of the sections, and any other information the user may have provided (e.g., a style to be applied to the output document, a persona to be applied to the output document, an intent to be applied to the output document, a desired length or format, etc.).

For example, the computing device (e.g., the interactive document generator application 139) may be configured to receive an input from a user requesting that an output document be generated in relation to the selection of the source documents (e.g., source content) and the outline. For example, the inputs may be provided by the user via input device 150. In some implementations, the computing device (e.g., interactive document generator application 139) may be configured to provide, for presentation on a display device, a graphical user interface by which a user can request the output document be generated in association with a particular outline that can also be selected via a user input. For example, the inputs may be provided by selecting user interface elements that are associated with selecting a desired outline and generating the output document. For example, the computing device (e.g., the interactive document generator application 139) may be configured to implement the one or more machine-learned models (e.g., one or more large language models, one or more generative machine-learned models, etc.) with respect to the selected source documents (source content) and an identified outline, to generate the output document.

In some implementations, the one or more machine-learned models may be configured to receive information from a user which identifies information about the output document, outline, sections, and/or the source documents (e.g., labeled data, such as an identification of the document type, the document style, the document intent, the document format, the document length, etc.). The one or more machine-learned models for generating the output document, outline, and sections, may be trained and/or refined based on the labeled data as well as by feedback provided via the user. For example, the output document, outline, and/or sections generated via the one or more machine-learned models may be stored in the computing device and may be output for presentation on the display device 160 to the user.

Referring to FIG. 16, the interactive document generator application 1600 (which may correspond to interactive document generator application 139 and/or interactive document generator application 339) may include a conditioning parameters generator 1602, one or more sequence processing models 1604, one or more large language models 1606, and one or more generative machine-learned models 1608. The interactive document generator application 1600 may receive an input 1610 from a user as discussed above with respect to FIG. 15. Conditioning parameters generator 1602 may be configured to generate conditioning parameters based at least in part on the input, wherein the conditioning parameters provide values for one or more conditions associated with content to be generated which relates at least in part to the input 1610 and source content 1630 selected by the user.

For example, the source content 1630 can include any kind of document (e.g., in digital form) and may include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, the source content 1630 may be stored in the content data store 350 by the user selecting certain documents, images, or other content to store in the content data store 350. In some implementations, the source content 1630 may be stored at the computing device 100 and/or server computing system 300.

To generate the conditioning parameters, the conditioning parameters generator 1602 may be configured to retrieve values for the one or more conditions associated with the input. For example, to generate the conditioning parameters, the conditioning parameters generator 1602 may be configured to extract the values for the one or more conditions from the input. The input may include information indicative of the user's intent or requirements. In some implementations, the conditioning parameters generator 1602 (or the one or more sequence processing models 1604 or the one or more large language models 1606) may be configured to extract information from the input 1610 to identify values for the one or more conditions, and the conditioning parameters generator 1602 may be configured to generate the conditioning parameters based on the extracted values. For example, the input itself may include a goal of the user for generating the output document (e.g., “I want to write a paper about American workers' concerns about AI”, “I want to create a study guide from this transcript”, etc.) and may include other information to be applied for generating the output document (e.g., a style, target audience, document restrictions such as a length of the document, etc.) that can be used to generate the conditioning parameters for generating a section, outline, or output document related to the source content 1630.

To generate the conditioning parameters, the conditioning parameters generator 1602 may be configured to infer the values for the one or more conditions from the input. The input may include information indicative of the user's intent or requirements. In some implementations, the conditioning parameters generator 1602 (or the one or more sequence processing models 1604 or the one or more large language models 1606) may be configured to infer information from the input 1610 to identify values for the one or more conditions, and the conditioning parameters generator 1602 may be configured to generate the conditioning parameters based on the inferred values. For example, the input may include a reference to a length (“short,” “long,” etc.) of the output document to be generated based on the source content 9500, and the conditioning parameters generator 1602 (or the one or more sequence processing models 1604 or the one or more large language models 1606) may be configured to infer a value based on the input. For example, an input requesting the interactive document generator application 1600 to generate a “standard” resume may infer a value of about 1 page while a “long” resume may be associated with a value of about 2 to 3 pages. For example, the interactive document generator application 1600 may be configured to ascertain an inferred value based on information via external content 1620 (e.g., a website which describes lengths of resumes).

In some implementations, the conditioning parameters generator 1602 may be configured to infer the values for the one or more conditions from the input by providing the input to one or more sequence processing models 1604, wherein the one or more sequence processing models 1604 are configured to output the values for the one or more conditions in response to or based on the query. The one or more sequence processing models 1604 may include one or more machine-learned models which are configured to process and analyze sequential data and to handle data that occurs in a specific order or sequence, including time series data, natural language text, or any other data with a temporal or sequential structure.

The one or more sequence processing models 1604 may receive an input including text and tokenize the input by breaking down the sequence of text into small units (tokens) to provide a structured representation of the input sequence. The one or more sequence processing models 1604 may represent the tokens as vectors in a continuous vector space by mapping each token to a high-dimensional vector, where the relationships between tokens (words) are reflected in the geometric relationships between their corresponding vector. For example, the one or more sequence processing models 1604 may receive an input extracted from the source content 1630 including the text “American workers' concerns about AI” and tokenize the input by breaking down the sequence of text into small units (tokens) (e.g., “American,” “workers',” “concerns”, “about,” and “AI”), thereby providing a structured representation of the input sequence. In a word embedding, semantically similar words are closer together in the vector space. For example, the vectors for “concerns” and “worry” might be close to each other because of their semantic relationship, while the vectors for “concerns” and “apathy” may be far apart compared to the vectors for “concerns” and “worry”.

The one or more large language models 1606 can be, or otherwise include, a model that has been trained on a large corpus of language training data in a manner that provides the one or more large language models 1606 with the capability to perform multiple language tasks. For example, the one or more large language models 1606 can be trained to perform summarization tasks, conversational tasks, simplification tasks, oppositional viewpoint tasks, etc. In particular, the one or more large language models 1606 can be trained to process a variety of outputs to generate a language output. For example, the one or more large language models 1606 can process an embedding generated by a machine-learned embedding generation model, portions of source content or training content (e.g., document chunk(s)) identified using an embedding generation model, language outputs generated using the one or more large language models 1606 or some other model, etc.

The one or more generative machine-learned models 1608 may include a deep neural network or a generative adversarial network (GAN), variational autoencoders, stable diffusion machine-learned models, visual transformers, neural radiance fields (NeRFs), etc., to generate content (e.g., a resume, an outline, a PRD, a research paper, a legal document, etc.) with values for conditions associated with one or more features. For example, the computing device may include a database (e.g., machine-learned model data store 370) which is configured to store a plurality of generative machine-learned models respectively associated with a plurality of different types of content or a plurality of different types of documents (e.g., different genres or subjects, different kinds of content including imagery, videos, and text, different types of content including outlines, reports, spreadsheets, resumes, PRDs, etc.).

In some implementations, the computing device may be configured to retrieve, from among the one or more generative machine-learned models 1608, a generative machine-learned model associated with a particular type of content (document) and/or document outline, for generating the output document, outline, or section, relating to the input.

In some implementations, the one or more generative machine-learned models 1608 may be trained on a large dataset of content (e.g., a large corpus of language training data) with corresponding information about the conditions associated with the content. During training, the one or more generative machine-learned models 1608 may be configured to learn relationships between elements in an output (e.g., content) and conditions that influence them. This may involve the computing device adjusting each generative machine-learned model's internal parameters to generate realistic or accurate content (e.g., grammatically correct content, coherent content, etc.) based on the training data. The one or more generative machine-learned models 1608 may be trained on one or more training datasets including a plurality of reference document outlines, a plurality of reference sections from an outline, etc. The one or more generative machine-learned models 1608 may be trained on one or more training datasets including a plurality of reference output documents that are associated with one or more document outlines. The one or more training datasets may include values for the one or more conditions.

In some implementations, the one or more generative machine-learned models 1608 are configured to generate the outline 1692 in response to receiving the first input as described herein which can include a request to generate or draft a report about a particular topic, to draft a legal document directed to a particular matter and from a particular viewpoint, to draft an analysis, etc. (e.g., “I want to write a report on the effects of generative AI in the workplace”). In some implementations, the one or more generative machine-learned models 1608 are configured to generate the outline 1692 in response to receiving the first input and one or more second inputs which can indicate additional information (e.g., a document type 1640, audience information 1650, intent information 1660, style information 1670, etc.). The outline 1692 may include a plurality of sections 1694 (e.g., headings) that can also be generated based on the first input and the one or more second inputs.

In some implementations, the one or more generative machine-learned models 1608 are configured to generate the questions 1695 for generating the section content 1697, for example, in response to receiving an input from the user indicating that the outline 1692 and associated sections 1694 are acceptable. For example, the one or more generative machine-learned models 1608 may be configured to generate the questions 1695 based on the sections 1694 information (e.g., the headings of the sections). For example, the one or more generative machine-learned models 1608 may be configured to generate the questions 1695 based on or by utilizing a persona previously generated by the one or more generative machine-learned models 1608.

In some implementations, the one or more generative machine-learned models 1608 are configured to generate the answers 1696 which provide information responsive to the questions 1695 for generating the section content 1697. As described herein, in some implementations the answers 1696 may be automatically generated via the one or more generative machine-learned models 1608 when a question is associated with a first context, for example, based on the source content 1630. As described herein, in some implementations the answers 1696 may be generated via the input 1610 when a question is associated with a second context, for example, based on information provided by a user.

In some implementations, the one or more generative machine-learned models 1608 are configured to generate the section content 1697 for one or more sections of the outline 1692, for example, in response to receiving an input from the user indicating that the question and answer pairs (e.g., formed by questions 1695 and corresponding answers 1696) are acceptable. In some implementations, the one or more generative machine-learned models 1608 are configured to generate the section content 1697 based on the answers 1696 and the source content 1630. The one or more generative machine-learned models 1608 may also be configured to generate the section content 1697 based on the answers 1696, the source content 1630, and other information which may be provided by the user via the input 1610 or generated by the one or more machine-learned models (e.g., a document type 1640, audience information 1650, intent information 1660, style information 1670, persona 1680, etc.).

In some implementations, the one or more generative machine-learned models 1608 are configured to generate the output document 1698 based on the section content 1697 and the source content 1630. The one or more generative machine-learned models 1608 may also be configured to generate the output document 1698 based on the section content 1697, the source content 1630, and other information which may be provided by the user via the input 1610 or generated by the one or more machine-learned models (e.g., a document type 1640, audience information 1650, intent information 1660, style information 1670, persona 1680, etc.).

For example, the outline 1692, sections 1694, questions 1695, answers 1696, section content 1697, and output document 1698 may be generated based on the conditioning parameters (and corresponding values for the one or more conditions) to make decisions for generating the content of the outline 1692, sections 1694, questions 1695, answers 1696, section content 1697, and output document 1698.

In some implementations, the server computing system 300 may provide (transmit) content or a portion of the generated content to computing device 100, or the server computing system 300 may provide access to the generated content to the computing device 100. For example, the outline 1692 and/or the output document 1698 may be generated at the server computing system 300 and stored at one or more computing devices (e.g., one or more of computing device 100, external computing device 200, server computing system 300, external content 500, content data store 350, user data store 360, etc.).

In some implementations, after the outline 1692 is generated, the user can provide feedback or a further input relating to the outline 1692, and one or more of the operations 1510 through 1520 can be repeated. In some implementations, after the questions 1695 and answers 1696 are generated, the user can provide feedback or a further input relating to the questions 1695 and answers 1696, and one or more of the operations 1510 through 1560 can be repeated. In some implementations, after the output document 1698 is generated, the user can provide feedback or a further input relating to the output document 1698, and one or more of the operations 1510 through 1570 can be repeated.

For example, the computing device (e.g., the interactive document generator application 1600) may include a large machine-learned model configured to perform a document level analysis with respect to the section content 1697 and/or with respect to the output document 1698. For example, the computing device may be configured to provide a user interface by which the user can select a user interface element that, when selected, causes the large machine-learned model to be implemented to analyze (e.g., proofread) the section content 1697 (or output document 1698) to make revisions or edits as needed (e.g., to correct errors, to improve grammar, etc.). For example, the large machine-learned model may have a higher processing power (e.g., consume more computing resources) than other machine-learned models which are used to generate the outline 1692, to generate the sections 1694, to generate the questions 1695, to generate the answers 1696, to generate the section content 1697, or to generate the output document 1698. Therefore, resource savings may be achieved by implementing a more computationally expensive machine-learned model for a limited purpose (e.g., document level analysis, editing, etc.), while implementing other less computationally expensive machine-learned models to perform other operations (e.g., to generate the outline 1692, to generate the sections 1694, to generate the questions 1695, to generate the answers 1696, to generate the section content 1697, or to generate the output document 1698, etc.).

In some implementations, the computing device (e.g., the interactive document generator application 1600) may be configured to provide for presentation to the user the revised version of a section (e.g., updated version of section content 1697). For example, the computing device may be configured to provide for presentation to the user the original version of the section content 1697 together with the revised version of the section content 1697 so that the user can compare the versions, and the user can accept or reject the revised version of the section content 1697. In some implementations, the computing device may be configured to provide for presentation to the user the revised version of the output document 1698. For example, the computing device may be configured to provide for presentation to the user the original version of the output document 1698 together with the revised version of the output document 1698 so that the user can compare the versions, and the user can accept or reject the revised version of the output document 1698.

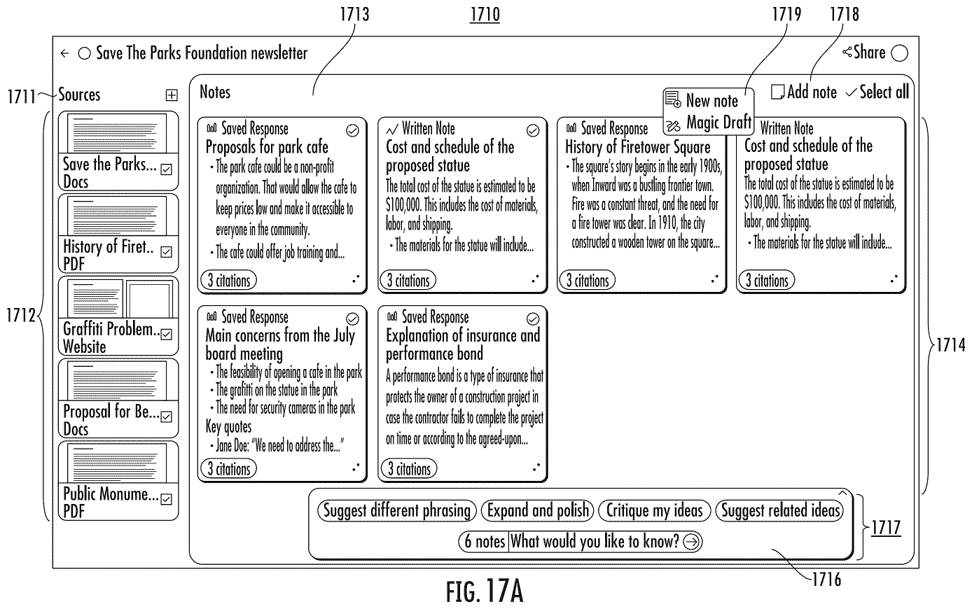

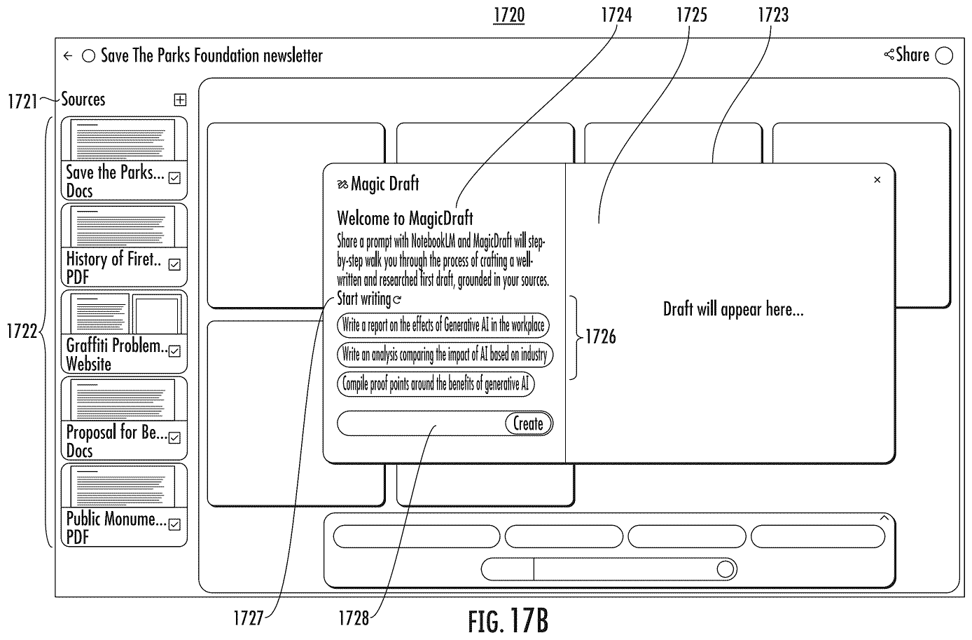

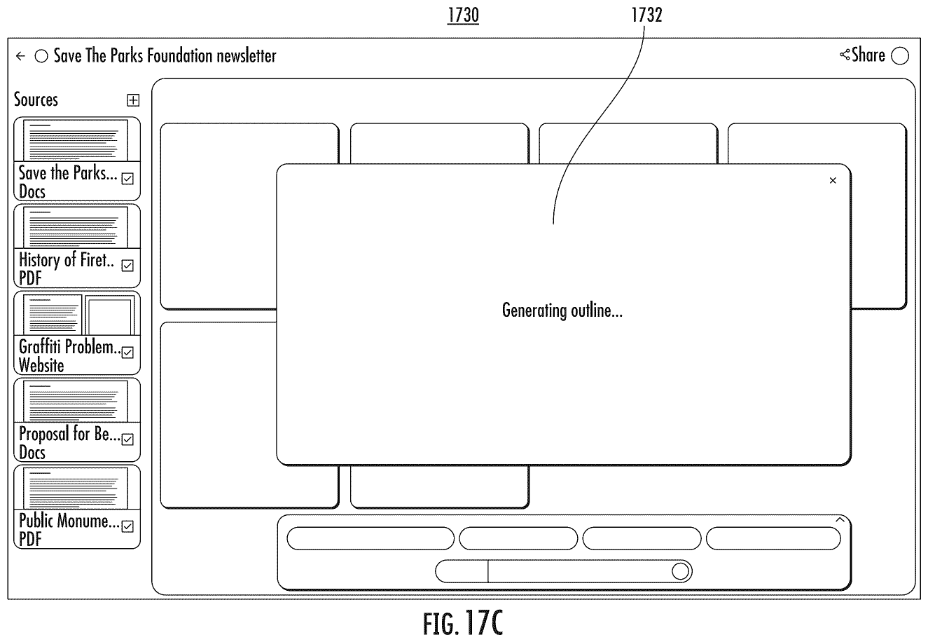

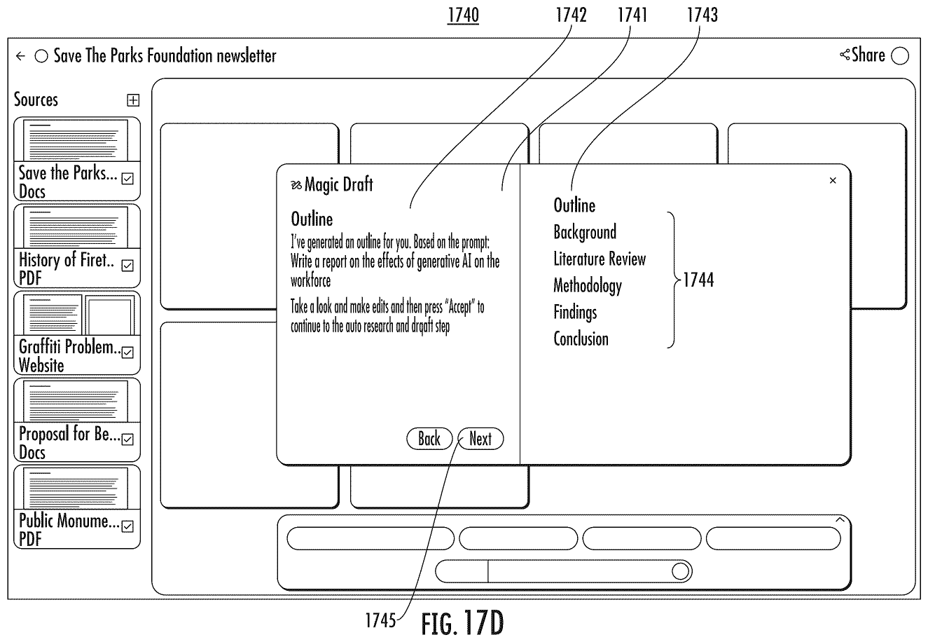

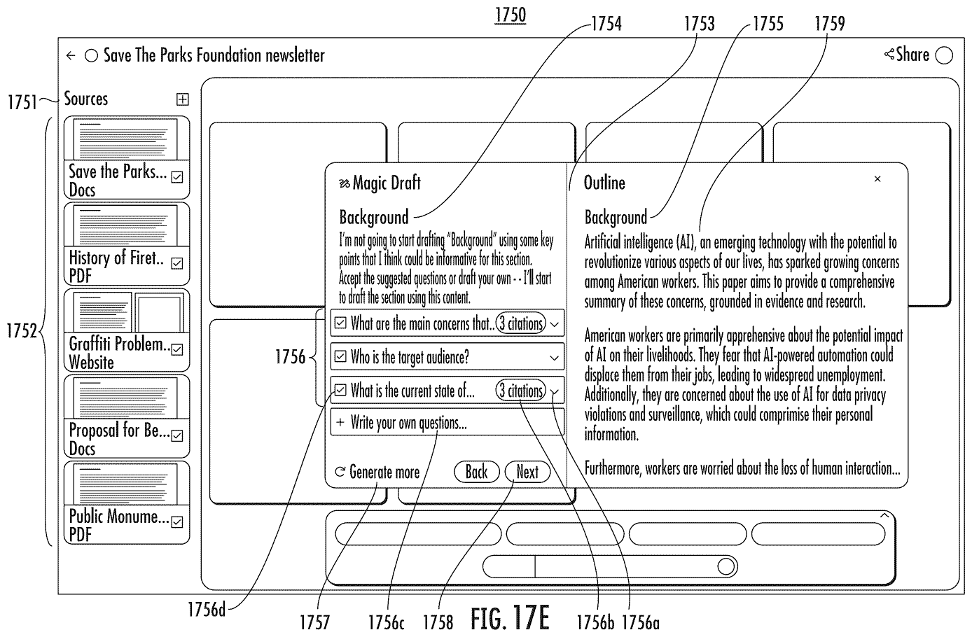

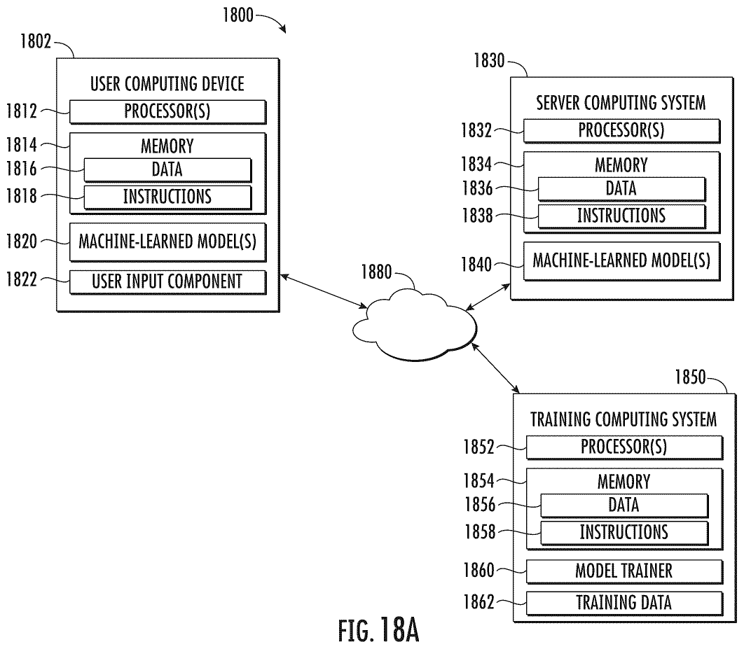

Examples of the disclosure are also directed to user-facing aspects by which a user can manage content, organize content, create content, etc., via a notebook application and/or interactive document generator application which are each configured to implement one or more machine-learned models with respect to content selected by the user. For example, FIGS. 17A through 17E illustrate examples of actions which can be implemented for a project in which an outline and output document are generated via one or more machine-learned models based on source content selected by a user, according to one or more example embodiments of the disclosure.

For example, FIG. 17A illustrates a first user interface screen (e.g., an interactive document generator user interface screen) of an interactive document generator application (which may be incorporated as part of a notebook application), according to one or more example embodiments of the disclosure.

In FIG. 17A, the first user interface screen 1710 depicts a user interface (e.g., an interactive document generator user interface screen) which provides information about the interactive document generator application 1600. In particular, interactive document generator application 1600 is configured to present for display the first user interface screen 1710 which includes a plurality of portions. The plurality of portions can include a first portion 1711 which corresponds to a sources section that includes a plurality of source documents 1712 that have been previously selected by the user according to methods described herein. The plurality of portions can include a second portion 1713 which corresponds to a notes section that includes a plurality of notes 1714 that have been previously generated or created by the user according to methods described herein. The plurality of portions can include a third portion 1716 which corresponds to an input section that includes a plurality of user interface elements 1717 that enable a user to provide a prompt or request certain actions to be formed (e.g., suggest related ideas, suggest different phrasing, etc.).

As illustrated in FIG. 17A, the first user interface screen 1710 further includes a plurality of user interface elements which are selectable (or can be interacted with) by the user for generating a note or output document. For example, first user interface element 1718 may be configured to, when selected, provide an option for a user to create a new note or to create an output document via the method as described herein (e.g., with respect to the method of FIG. 15) according to a “MagicDraft” feature visually indicated by second user interface element 1719 that be provided as part of the interactive document generator application (which may be incorporated as part of a notebook application). Selection of the second user interface element 1719 may cause the second user interface screen 1720 of FIG. 17B to be presented.

FIG. 17B illustrates a second user interface screen (e.g., an interactive document generator user interface screen) of an interactive document generator application (which may be incorporated as part of a notebook application), according to one or more example embodiments of the disclosure.

In FIG. 17B, the second user interface screen 1720 depicts a user interface (e.g., an interactive document generator user interface screen) which is associated with enabling a user to generate an output document in an interactive manner that can result in accurate, cohesive, content. In particular, interactive document generator application 1600 may be configured to present for display the second user interface screen 1720 which includes a plurality of portions and user interface elements by which the user can generate the output document via the interactive document generator application 1600.

For example, the second user interface screen 1720 includes a first portion 1721 which corresponds to a sources section that includes a plurality of source documents 1722 that have been previously selected by the user according to methods described herein.

For example, the second user interface screen 1020 includes a second portion 1723 which is associated with the “MagicDraft” feature of the interactive document generator application (which may be incorporated as part of a notebook application). For example, the second portion 1723 includes a first section 1724 by which a user can provide an input to begin a process to generate the output document and a second section 1725 which can depict the draft of the output document (e.g., a preview of the output document, a draft of the outline, a draft of a section of the outline, etc.).

For example, the first section 1724 may include a plurality of user interface elements by which a user can provide a first input (e.g., a prompt) to generate an output document. In FIG. 17B, a plurality of first user interface elements 1726 correspond to preconfigured or suggested prompts for generating an output document. Second user interface element 1727 may be configured to, when selected, cause the preconfigured or suggested prompts to be regenerated. For example, the suggested prompts may be generated based on the content of the plurality of source documents 1722. Third user interface element 1728 may be configured to enable a user to provide their own prompt, for example, in text form or via a voice input, etc.

FIG. 17C illustrates a third user interface screen (e.g., an interactive document generator user interface screen) of an interactive document generator application (which may be incorporated as part of a notebook application), according to one or more example embodiments of the disclosure.

In FIG. 17C, the third user interface screen 1730 depicts a user interface (e.g., an interactive document generator user interface screen) which is associated with enabling a user to generate an output document in an interactive manner that can result in accurate, cohesive, content. In particular, interactive document generator application 1600 may be configured to present for display the third user interface screen 1730 which includes a portion 1732 that indicates the interactive document generator application 1600 is in the process of generating an outline. For example, as described herein one or more machine-learned models (e.g., the one or more generative machine-learned models 1608) may be configured to generate the outline in response to receiving the first input as described herein which can include a request to generate or draft a report about a particular topic, to draft a legal document directed to a particular matter and from a particular viewpoint, to draft an analysis, etc. (e.g., “I want to write a report on the effects of generative AI in the workplace”). In some implementations, the one or more generative machine-learned models 1608 are configured to generate the outline 1692 in response to receiving the first input and one or more second inputs which can indicate additional information (e.g., a document type 1640, audience information 1650, intent information 1660, style information 1670, etc.).

FIG. 17D illustrates a fourth user interface screen (e.g., an interactive document generator user interface screen) of an interactive document generator application (which may be incorporated as part of a notebook application), according to one or more example embodiments of the disclosure.

In FIG. 17D, the fourth user interface screen 1740 depicts a user interface (e.g., an interactive document generator user interface screen) which is associated with enabling a user to generate an output document in an interactive manner that can result in accurate, cohesive, content. In particular, interactive document generator application 1600 may be configured to present for display the fourth user interface screen 1740 which includes a portion 1741 that includes a first section 1742 and a second section 1743. The first section 1742 may include information and one or more user interface elements to guide a user in generating an outline which can be used to generate the output document. For example, though not shown in FIG. 17D the first section 1742 may include one or more user interface elements to enable a user to modify sections presented in the second section 1743, to generate new sections, to regenerate the sections, to remove sections, etc. The second section 1743 may include a depiction of the outline including headings for the plurality of sections 1744. For example, each of the sections may have a heading identifier (e.g., “background,” “literature review,” etc.).

For example, a first input may be provided by the user via input device 150 as described with respect to FIG. 17B. In some implementations, the computing device (e.g., interactive document generator application 1600) may be configured to implement one or more machine-learned models with respect to the first input to generate the outline based on the first input. In some implementations, the one or more generative machine-learned models 1608 are configured to generate the outline 1692 in response to receiving the first input and one or more second inputs which can indicate additional information (e.g., a document type 1640, audience information 1650, intent information 1660, style information 1670, etc.). The outline may include the plurality of sections 1744 (e.g., headings) that can also be generated based on the first input and the one or more second inputs.

The first section 1742 may include a first user interface element 1745 that, when selected, indicates that the user accepts the outline and plurality of sections which have been generated. Selection of the first user interface element 1745 may cause the one or more generative machine-learned models 1608 to generate the questions 1695 for generating the section content 1697 for one or more of the sections. In some implementations, questions may be generated for one section at a time, in a step-wise manner. In some implementations, questions may be generated for all of the sections at the same time.

FIG. 17E illustrates a fifth user interface screen (e.g., an interactive document generator user interface screen) of an interactive document generator application (which may be incorporated as part of a notebook application), according to one or more example embodiments of the disclosure.

In FIG. 17E, the fifth user interface screen 1750 depicts a user interface (e.g., an interactive document generator user interface screen) which is associated with enabling a user to generate an output document in an interactive manner that can result in accurate, cohesive, content. In particular, interactive document generator application 1600 may be configured to present for display the fifth user interface screen 1750 which includes a plurality of portions and user interface elements by which the user can generate the output document via the interactive document generator application 1600.

For example, the fifth user interface screen 1750 includes a first portion 1751 which corresponds to a sources section that includes a plurality of source documents 1752 that have been previously selected by the user according to methods described herein.

For example, the fifth user interface screen 1750 includes a second portion 1753 which includes a first section 1754 and a second section 1755. As shown in FIG. 17E, the second portion 1753 relates to the generation of content for the background section of the outline from FIG. 17D.

For example, the first section 1754 may include a plurality of user interface elements by which a user can provide one or more inputs to generate content for the background section. In FIG. 17E, a plurality of first user interface elements 1756 correspond to a plurality of question and answer pairs that can be selected for generating the content for the background section of the outline. For example, the plurality of question and answer pairs can include one or more questions of the first context (e.g., “What are the main concerns that American . . . ” and “What is the current state of . . . ”) and one or more questions of the second context (e.g., “Who is the target audience”). As shown in FIG. 17E, the plurality of question and answer pairs may include a second user interface element 1756a that can be selected to cause additional information to be shown (e.g., the remainder of the question, the answer to the question, etc.). As shown in FIG. 17E, the plurality of question and answer pairs may include a third user interface element 1756b that can indicate the number of sources relied upon by the one or more machine-learned models to generate the answer to the question (e.g., in the case of a question which is associated with the first context). For example, selection of the third user interface element 1756b can cause the computing device (e.g., interactive document generator application 1600) to display the references and in some implementations, a summary description of each reference.

In some implementations, fourth user interface element 1756c may be provided for a user to write their own question. Based on the content of the question, the one or more machine-learned models may be configured to classify the question as being associated with the first context or the second context. If the question is classified as being associated with the first context, the one or more machine-learned models may be configured to automatically retrieve information responsive to the question (e.g., from the plurality of source documents 1752). If the question is classified as being associated with the second context, the computing device (e.g., the interactive document generator application 1600) may be configured to provide a user interface element by which a user can provide an answer to the question. In some implementations, the user may be enabled to modify answers which are first generated by the one or more machine-learned models.

In some implementations, fifth user interface element 1756d may be provided for a user to select particular question and answer pairs for inclusion by the one or more machine-learned models for generating the content of the background section. Therefore, the computing device (e.g., the interactive document generator application 1600) may be configured to provide user interface elements by which a user can indicate particular question and answer pairs for inclusion (or exclusion) by the one or more machine-learned models when generating the content of the background section.

In some implementations, sixth user interface element 1757 may be provided for a user to request that the question and answer pairs be regenerated and/or that questions and answer pairs be generated in addition to those already generated.

For example, the second section 1755 may include the generated content 1759 for the section (e.g., the background section). The one or more machine-learned models may be configured to generate the content 1759 based on the plurality of question and answer pairs. In some implementations, the content 1759 may change (e.g., in real-time), in response to changes or modifications to the plurality of question and answer pairs (e.g., in response to deselection of one of the question and answer pairs, in response to the addition of a question and answer pair, in response to the regeneration of the question and answer pairs, etc.).

In FIG. 17E, seventh user interface element 1758 may be provided for a user to indicate acceptance of the content generated for the section (e.g., the background section), and a next section can be displayed to the user for content to be generated. In some implementations, once all of the sections have been generated to complete the outline, the user may save the outline as a note. In some implementations, once the outline has been generated, the user can request that an output document be generated based on the outline. For example, the output document may correspond to or be included as a note for the notebook application 3100. The interactive document generator application 1600 may be configured to generate content for each section based on the content of the source documents, via one or more machine-learned models, as described according to the examples provided herein. For example, the outline and/or the output document may be stored in the computing device, may be transmitted to another computing device, may be saved as a particular document file type in another document application, may be shared with another user, etc.

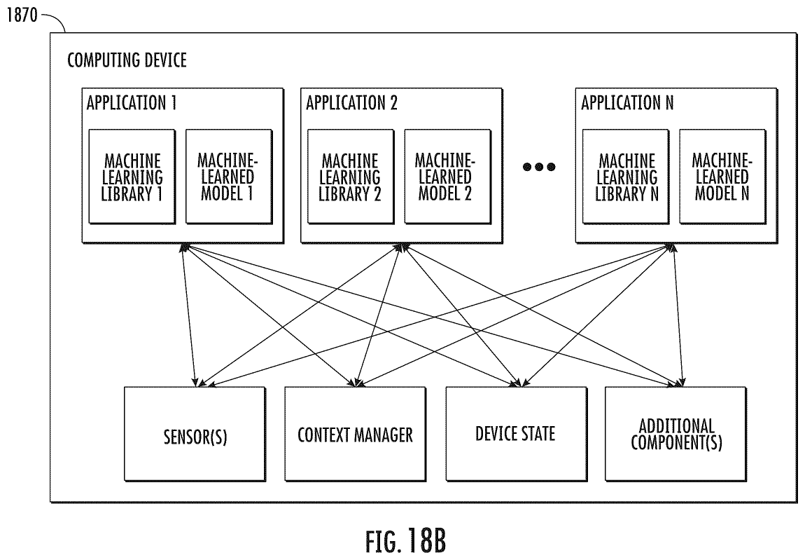

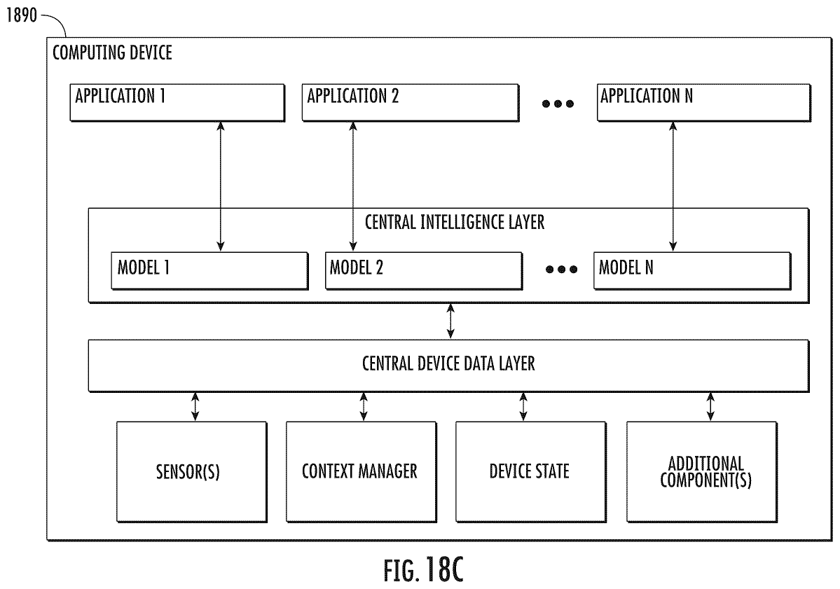

FIG. 18A depicts a block diagram of an example computing system for organizing, managing, and creating content by implementing one or more machine-learned models with respect to input information, according to one or more example embodiments of the disclosure. The system 1800 includes a user computing device 1802, a server computing system 1830, and a training computing system 1850 that are communicatively coupled over a network 1880.

FIG. 18B depicts a block diagram of an example computing device for organizing, managing, and creating content by implementing one or more machine-learned models with respect to input information, according to one or more example embodiments of the disclosure.

FIG. 18C depicts a block diagram of an example computing device for organizing, managing, and creating content by implementing one or more machine-learned models with respect to input information, according to one or more example embodiments of the disclosure.

The user computing device 1802 (which may correspond to computing device 100) can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 1802 includes one or more processors 1812 and a memory 1814. The one or more processors 1812 can be any suitable processing device (e.g., a processor core, a microprocessor, an ASIC, an FPGA, a controller, a microcontroller, etc.) and can be one processor or a plurality of processors that are operatively connected. The memory 1814 can include one or more non-transitory computer-readable storage media, such as RAM, ROM, EEPROM, EPROM, flash memory devices, magnetic disks, etc., and combinations thereof. The memory 1814 can store data 1816 and instructions 1818 which are executed by the processor 1812 to cause the user computing device 1802 to perform operations.

In some implementations, the user computing device 1802 can store or include one or more machine-learned models 1820 (e.g., large language models, sequence processing models, generative machine-learned models, etc.). For example, the one or more machine-learned models 1820 can be or can otherwise include various machine-learned models such as neural networks (e.g., deep neural networks) or other types of machine-learned models, including non-linear models and/or linear models. Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models (e.g., transformer models). Example machine-learned models were described herein with reference to FIGS. 1A through 17E.

In some implementations, the one or more machine-learned models 1820 can be received from the server computing system 1830 over network 1880, stored in the memory 1814, and then used or otherwise implemented by the one or more processors 1812. In some implementations, the user computing device 1802 can implement multiple parallel instances of a single machine-learned model (e.g., to perform parallel tasks across multiple instances of the machine-learned model). In some implementations, the task is a generative task and one or more machine-learned models may be implemented to output content (e.g., a document template, an output document, etc.) in view of various inputs (e.g., a query, training documents, source documents, conditioning parameters, etc.). More particularly, the machine-learned models disclosed herein (e.g., including large language models, sequence processing models, generative machine-learned models, etc.), may be implemented to perform various tasks related to an input query.

According to examples of the disclosure, a computing system may implement one or more sequence processing models 3120, 9120, 1204, 1604 as described herein to output values for the one or more conditions in response to or based on the query. The one or more sequence processing models 3120, 9120, 1204, 1604 may include one or more machine-learned models which are configured to process and analyze sequential data and to handle data that occurs in a specific order or sequence, including time series data, natural language text, or any other data with a temporal or sequential structure.

According to examples of the disclosure, a computing system may implement one or more large language models 3130, 9130, 1206, 1606 to determine a plurality of variables based on the query. For example, a large language model may include a Bidirectional Encoder Representations from Transformers (BERT) large language model. The large language model may be trained to understand and process natural language for example. The large language model may be configured to extract information from the input (e.g., a query, training documents, source documents, etc.) to identify keywords, intents, and context within the input to determine a plurality of variables for generating content. The variables may include latent variables that represent an underlying structure of the language.

According to examples of the disclosure, a computing system may implement one or more generative machine-learned models 3140, 9140, 1208, 1608 to generate various content (e.g., for generating a persona, an outline, sections of the outline, a summary, a response to a query, a document template, an output document generated based on the document template, an output document generated based on the persona, etc.) having values for one or more conditions. The one or more generative machine-learned models 3140, 9140, 1208, 1608 may include a deep neural network or a generative adversarial network (GAN) to generate the content with one or more features having values for one or more conditions associated with the features. For example, the one or more generative machine-learned models 3140, 9140, 1208, 1608 may include variational autoencoders, stable diffusion machine-learned models, visual transformers, neural radiance fields (NeRFs), etc., to generate the content.

Additionally, or alternatively, one or more machine-learned models 1840 can be included in or otherwise stored and implemented by the server computing system 1830 that communicates with the user computing device 1802 according to a client-server relationship. For example, the one or more machine-learned models 1840 can be implemented by the server computing system 1830 as a portion of a web service (e.g., a navigation service, a word processing service, an educational service, and the like). Thus, one or more machine-learned models 1820 can be stored and implemented at the user computing device 1802 and/or one or more machine-learned models 1840 can be stored and implemented at the server computing system 1830.

The user computing device 1802 can also include one or more user input components 1822 that receives user input. For example, the user input component 1822 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other devices and methods by which a user can provide a user input.

The server computing system 1830 (which may correspond to server computing system 300) includes one or more processors 1832 and a memory 1834. The one or more processors 1832 can be any suitable processing device (e.g., a processor core, a microprocessor, an ASIC, an FPGA, a controller, a microcontroller, etc.) and can be one processor or a plurality of processors that are operatively connected. The memory 1834 can include one or more non-transitory computer-readable storage media, such as RAM, ROM, EEPROM, EPROM, flash memory devices, magnetic disks, etc., and combinations thereof. The memory 1834 can store data 1836 and instructions 1838 which are executed by the processor 1832 to cause the server computing system 1830 to perform operations.

In some implementations, the server computing system 1830 includes or is otherwise implemented by one or more server computing devices. In instances in which the server computing system 1830 includes a plurality of server computing devices, such server computing devices can operate according to sequential computing architectures, parallel computing architectures, or some combination thereof.

As described above, the server computing system 1830 can store or otherwise include one or more machine-learned models 1840. For example, the one or more machine-learned models 1840 can be or can otherwise include various machine-learned models. Example machine-learned models include neural networks or other multi-layer non-linear models. Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models (e.g., transformer models). Example machine-learned models were described herein with reference to FIGS. 1A through 17E.

The user computing device 1802 and/or the server computing system 1830 can train the one or machine-learned models 1820 and/or 1840 via interaction with the training computing system 1850 that is communicatively coupled over the network 1880. The training computing system 1850 can be separate from the server computing system 1830 or can be a portion of the server computing system 1830.

The training computing system 1850 includes one or more processors 1852 and a memory 1854. The one or more processors 1852 can be any suitable processing device (e.g., a processor core, a microprocessor, an ASIC, an FPGA, a controller, a microcontroller, etc.) and can be one processor or a plurality of processors that are operatively connected. The memory 1854 can include one or more non-transitory computer-readable storage media, such as RAM, ROM, EEPROM, EPROM, flash memory devices, magnetic disks, etc., and combinations thereof. The memory 1854 can store data 1856 and instructions 1858 which are executed by the processor 1852 to cause the training computing system 1850 to perform operations. In some implementations, the training computing system 1850 includes or is otherwise implemented by one or more server computing devices.

The training computing system 1850 can include a model trainer 1860 that trains the one or more machine-learned models 1820 and/or 1840 stored at the user computing device 1802 and/or the server computing system 1830 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 1860 can perform a number of generalization techniques (e.g., weight decays, dropouts, etc.) to improve the generalization capability of the models being trained.

In particular, the model trainer 1860 can train the one or more machine-learned models 1820 and/or 1840 based on a set of training data 1862. The training data 1862 can include, for example, various datasets which may be stored remotely or at the training computing system 1850. For example, in some implementations an example dataset utilized for training includes a large corpus of language training data that provides one or more large language models with the capability to perform multiple language tasks. For example, the one or more large language models can be trained to perform summarization tasks, conversational tasks, simplification tasks, oppositional viewpoint tasks, etc. In particular, the one or more large language models can be trained to process a variety of outputs to generate a language output. However, other datasets (e.g., of images) may be utilized (e.g., images obtained from external websites). In some implementations, the dataset may be confined to a particular genre or subject, particular kinds of content including imagery, videos, and text, particular styles or types of content (e.g., outlines, reports, presentations, spreadsheets, resumes, PRDs, etc.), etc. In some implementations, the dataset may contain diverse subject matter.

In some implementations, if the user has provided consent, the training examples can be provided by the user computing device 1802. Thus, in such implementations, the one or more machine-learned models 1820 provided to the user computing device 1802 can be trained by the training computing system 1850 on user-specific data received from the user computing device 1802. In some instances, this process can be referred to as personalizing the model.

The model trainer 1860 includes computer logic utilized to provide desired functionality. The model trainer 1860 can be implemented in hardware, firmware, and/or software controlling a general purpose processor. For example, in some implementations, the model trainer 1860 includes program files stored on a storage device, loaded into a memory and executed by one or more processors. In other implementations, the model trainer 1860 includes one or more sets of computer-executable instructions that are stored in a tangible computer-readable storage medium such as RAM, hard disk, or optical or magnetic media.

The network 1880 can be any type of communications network, such as a local area network (e.g., intranet), wide area network (e.g., Internet), or some combination thereof and can include any number of wired or wireless links. In general, communication over the network 1880 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

FIG. 18A illustrates an example computing system that can be used to implement aspects of the disclosure. Other computing systems can be used as well. For example, in some implementations, the user computing device 1802 can include the model trainer 1860 and the training data 1862. In such implementations, the one or more machine-learned models 1820 can be both trained and used locally at the user computing device 1802. In some of such implementations, the user computing device 1802 can implement the model trainer 1860 to personalize the one or more machine-learned models 1820 based on user-specific data.

FIG. 18B depicts a block diagram of an example computing device for organizing, managing, and creating content by implementing one or more machine-learned models with respect to input information, according to one or more example embodiments of the disclosure. The computing device 1870 can be a user computing device or a server computing device, for example.

The computing device 1870 includes a number of applications (e.g., applications 1 through N). Each application contains its own machine learning library and machine-learned model(s). For example, each application can include a machine-learned model. Example applications include the notebook application as described herein, the document extractor application as described herein, the persona generator application as described herein, the interactive document generator application as described herein, a text messaging application, an email application, a dictation application, a virtual keyboard application, a browser application, a social media application, a map application, a navigation application, etc.

As illustrated in FIG. 18B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 18C depicts a block diagram of an example computing device for organizing, managing, and creating content by implementing one or more machine-learned models with respect to input information, according to one or more example embodiments of the disclosure. The computing device 1890 can be a user computing device or a server computing device, for example.

The computing device 1890 includes a number of applications (e.g., applications 1 through N). Each application is in communication with a central intelligence layer. Example applications include the notebook application as described herein, the document extractor application as described herein, the persona generator application as described herein, the interactive document generator application as described herein, a text messaging application, an email application, a dictation application, a virtual keyboard application, a browser application, a map application, a social media application, a navigation application, a social media application, etc. In some implementations, each application can communicate with the central intelligence layer (and model(s) stored therein) using an API (e.g., a common API across all applications).

The central intelligence layer includes a number of machine-learned models. For example, as illustrated in FIG. 18C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 1890.

The central intelligence layer can communicate with a central device data layer. The central device data layer can be a centralized repository of data for the computing device 1700. As illustrated in FIG. 18C, the central device data layer can communicate with a number of other components of the computing device, such as, for example, one or more sensors, a context manager, a device state component, and/or additional components. In some implementations, the central device data layer can communicate with each device component using an API (e.g., a private API).

To the extent alleged generic terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computing device, comprising:
one or more memories configured to store instructions; and
one or more processors configured to execute the instructions to perform operations, the operations comprising:
receiving a first input from a user providing information associated with a request to generate an output document,
generating, via one or more machine-learned models, an outline based on the first input, the outline including a plurality of sections,
generating, via the one or more machine-learned models, a plurality of questions for generating content for a first section among the plurality of sections, based on the first input,
determining, via the one or more machine-learned models, whether a first question among the plurality of questions is associated with a first context or a second context,
when the first question is associated with the first context, automatically retrieving, via the one or more machine-learned models, information responsive to the first question,
when the first question is associated with the second context, presenting the first question to the user and obtaining, from the user, the information responsive to the first question, and
generating, via the one or more machine-learned models, the content for the first section, based on the information responsive to the first question.

2. The computing device of claim 1, wherein the operations further comprise:
receiving a second input from the user indicating a style to be applied by the one or more machine-learned models for generating the output document, and
wherein generating, via the one or more machine-learned models, the outline is further based on the second input.

3. The computing device of claim 1, wherein the operations further comprise:
receiving a second input from the user indicating a style to be applied by the one or more machine-learned models for generating the output document, and
wherein generating, via the one or more machine-learned models, the content for the first section is further based on the second input.

4. The computing device of claim 1, wherein the operations further comprise:
providing, for presentation to the user, the outline including the plurality of sections; and
receiving a second input from the user indicating to modify one or more of the sections of the outline or to accept the outline.

5. The computing device of claim 4, wherein the one or more machine-learned models generate the plurality of questions for generating the content for the first section among the plurality of sections, in response to the computing device receiving the second input from the user indicating to accept the outline.

6. The computing device of claim 1, wherein generating, via the one or more machine-learned models, the plurality of questions is further based on a title of the first section.

7. The computing device of claim 1, wherein
the first context corresponds to a query which can be answered via the one or more machine-learned models based on information contained in one or more source documents, and
the second context corresponds to a query relating to at least one of a purpose, scope, or target audience associated with the output document.

8. The computing device of claim 7, wherein the operations further comprise receiving a selection, from the user, of the one or more source documents, for generating the output document.

9. The computing device of claim 1, wherein the operations further comprise:
providing, for presentation to the user, a plurality of question and answer pairs which includes the plurality of questions and corresponding answers including information responsive to the plurality of questions;
receiving a second input from the user indicating to:
remove one or more of the plurality of question and answer pairs,
add one or more questions to generate one or more additional question and answer pairs, to add to the plurality of question and answer pairs, or
accept the plurality of question and answer pairs; and
in response to the second input indicating to accept the plurality of question and answer pairs, generating, via the one or more machine-learned models, the content for the first section, based on the information responsive to the plurality of questions.

10. The computing device of claim 1, wherein the operations further comprise:
providing, for presentation to the user, a plurality of question and answer pairs which includes the plurality of questions and corresponding answers including information responsive to the plurality of questions;
receiving a second input from the user selecting one or more of the plurality of question and answer pairs; and
generating, via the one or more machine-learned models, the content for the first section, is based on information responsive to questions from the one or more of the plurality of question and answer pairs selected via the second input.

11. The computing device of claim 1, wherein the operations further comprise:
applying one or more further machine-learned models to edit the first section,
wherein the one or more further machine-learned models have a higher processing power than the one or more machine-learned models.

12. The computing device of claim 1, wherein the operations further comprise:
generating, via the one or more machine-learned models, a persona, based on the first input; and
generating, via the one or more machine-learned models, the content for the first section, by utilizing the persona and based on the information responsive to the first question.

13. A computer-implemented method, comprising:
receiving, by a computing system comprising one or more processors, a first input from a user providing information associated with a request to generate an output document;
generating, via one or more machine-learned models of the computing system, an outline based on the first input, the outline including a plurality of sections;
generating, via the one or more machine-learned models, a plurality of questions for generating content for a first section among the plurality of sections, based on the first input;
determining, via the one or more machine-learned models, whether a first question among the plurality of questions is associated with a first context or a second context;
when the first question is associated with the first context, automatically retrieving, via the one or more machine-learned models, information responsive to the first question;
when the first question is associated with the second context, presenting the first question to the user and obtaining, from the user, the information responsive to the first question; and
generating, via the one or more machine-learned models, the content for the first section, based on the information responsive to the first question.

14. The computer-implemented method of claim 13, further comprising:
receiving a second input from the user indicating a style to be applied by the one or more machine-learned models for generating the output document, and
wherein generating, via the one or more machine-learned models, the outline is further based on the second input.

15. The computer-implemented method of claim 13, further comprising:
receiving a second input from the user indicating a style to be applied by the one or more machine-learned models for generating the output document, and
wherein generating, via the one or more machine-learned models, the content for the first section is further based on the second input.

16. The computer-implemented method of claim 13, further comprising:
providing, for presentation to the user, the outline including the plurality of sections;
receiving a second input from the user indicating to modify one or more of the sections of the outline or to accept the outline; and
in response to the computing system receiving the second input from the user indicating to accept the outline, generating, via the one or more machine-learned models, the plurality of questions.

17. The computer-implemented method of claim 13, wherein
the first context corresponds to a query which can be answered via the one or more machine-learned models based on information contained in one or more source documents, and
the second context corresponds to a query relating to at least one of a purpose, scope, or target audience associated with the output document.

18. The computer-implemented method of claim 17, further comprising receiving a selection, from the user, of the one or more source documents, for generating the content of the first section.

19. The computer-implemented method of claim 13, further comprising:
providing, for presentation to the user, a plurality of question and answer pairs which includes the plurality of questions and corresponding answers including information responsive to the plurality of questions;
receiving a second input from the user indicating to:
remove one or more of the plurality of question and answer pairs,
add one or more questions to generate one or more additional question and answer pairs, to add to the plurality of question and answer pairs, or
accept the plurality of question and answer pairs; and
in response to the second input indicating to accept the plurality of question and answer pairs, generating, via the one or more machine-learned models, the content for the first section, based on the information responsive to the plurality of questions.

20. A non-transitory computer readable medium storing instructions which, when executed by a processor, cause the processor to perform operations for generating an output document, the operations comprising:
receiving a first input from a user providing information associated with a request to generate an output document;
generating, via one or more machine-learned models, an outline based on the first input, the outline including a plurality of sections;
generating, via the one or more machine-learned models, a plurality of questions for generating content for a first section among the plurality of sections, based on the first input;
determining, via the one or more machine-learned models, whether a first question among the plurality of questions is associated with a first context or a second context;
when the first question is associated with the first context, automatically retrieving, via the one or more machine-learned models, information responsive to the first question;
when the first question is associated with the second context, presenting the first question to the user and obtaining, from the user, the information responsive to the first question; and
generating, via the one or more machine-learned models, the content for the first section, based on the information responsive to the first question.
